(19) United States
(12) Patent Application Publication
(10) Pub. No.: US 2016/0217371 A1
(43) Pub. Date: Jul. 28, 2016

(54) Method and System for Universal Problem Resolution with Continuous Improvement

(71) Applicant: Robert Leithiser, Corona, CA (US)

(72) Inventor: Robert Leithiser, Corona, CA (US)

(21) Appl. No.: 15/004,868

(22) Filed: Jan. 22, 2016

Related U.S. Application Data
(60) Provisional application No. 62/106,533, filed on Jan. 22, 2015.

(51) Int. Cl. G06N 3/12; G06N 99/00

(52) U.S. Cl. CPC G06N 3/126; G06N 99/005

(57) ABSTRACT

A universal problem resolution method and system implementing continuous improvement for problem solving that utilizes simulative processing of relational data sets associated with initial states, allowed transition states, and goal states for a problem. The framework autonomously generates and solves higher order problems to find sequences of operations necessary to transform state sequences derived from the lower-order transformation simulations recursively. The solutions yield increasingly higher-order abstractions that converge to generalization such that the unwinding of the higher order sequences back down to the original problem yields the exact sequence of steps for unsolved instances of the problem in linear time without the need for re-simulation. Cooperating agents analyze solution path determinations for problems including those concerning their own optimization. This spawns state transition rules generalizable to higher layers of abstraction resulting in new knowledge enabling self-optimization.

### CROSS REFERENCE TO RELATED APPLICATIONS

The subject application claims priority to U.S. provisional patent application Ser. No. 62/106,533 filed Jan. 22, 2015, which application is incorporated herein in its entirety by this reference thereto.

### FIELD OF THE DISCLOSURE

The present invention relates to computer problem solving systems. More specifically, the invention relates to a software framework that provides extensible components and can autonomously improve its capabilities and performance over time.

### RELATED ART AND CONCEPTS

### Universality of Computational Frameworks

Modern computer hardware and operating system software platforms are able to run applications encompassing multiple domains without any pre-knowledge of the specific domain. The same computational device using the same operating system that can run an accounting package can also run word processing software, engineering simulations and data mining software. Programming languages provide support for creating application software that runs the full gamut of computational requirements and represents a universality class in the overall computer system framework.

Relational database management systems using Structured Query Language (SQL) provide a generic capability to represent a wide variety of data. Any information that can be understood in terms of values related to other values, including those related through functions, can be represented in a relational schema. Relational databases have evolved to support object-oriented storage, another class of universality in the area of information representation.

More recently, data mining software supporting business intelligence and predictive analytics such as MicroStrategy™ and ‘R’ have emerged with increasingly considerable capabilities that are further enhanced by hardware developments such as solid-state storage, parallel processing and by evolution of distributed computing networks. Similar to programming languages and operating systems, data mining has become increasingly generic with the same data mining software supporting analysis of different domains.

### The Universality Gap Pertaining to Problem Solving

Despite the universality of operating systems, programming languages, databases, and data mining software, domain-specific limitations persist when endeavoring to discover solutions to computational problems. For example, data mining software may provide a generic platform for analyzing pattern data, but, for many scenarios, subject matter expertise is heavily needed in not only the problem definition aspect, but also in evaluating results and formulating actions from those results.

It is natural that problem solving tends to be domain-specific since problems are by their very nature varied across the entire sphere of existence. For example, the solution for calculating a flight trajectory is vastly different from the solution for determining customer preferences based on prior purchases. Another example of domain-specificity is the Deep Blue system for playing chess. While this system was able to defeat the best grandmaster in the world, it was not able to play any other games—even a game as simple as tic-tac-toe—without extensive re-programming.

The domain specificity not only concerns algebra, and correlative analysis, but also entails the algorithmic aspect for determining optimal solutions. Typically software designed to find the optimal solution for a problem focuses on the use of a specific algorithmic approach or a combination of approaches whether it be neural networks, dynamic programming, heuristic-based, genetic algorithms, simulation-based, approximation-oriented, or some other method. Without a doubt, certain types of problems benefit more from specific algorithmic approaches. Therefore, feedback mechanisms commonly found in problem optimization research are typically limited to merely evaluating the success of the algorithm and parameters rather than a holistic approach that encompasses any algorithm and endeavors to determine the most optimal set of algorithms or the most optimal patterns for applying the algorithms.

### The Case for Universal Problem Solving

Cognitive machines that utilize varying technologies with the ability to learn new information and improve themselves are yet another example supporting the concept of universal problem resolution. Such machines function in their environments for a particular purpose but integrate with the environment and receive feedback to improve in their operations. Cognitive machines are often used for surveillance and sensing of events in the environment and share the following similarities:
They have embedded (i.e., software-defined) signal processing for flexibility.
They perform learning in real-time through continuous interactions with the outside environment.
They utilize closed-loop feedback.

A limiting aspect of this approach is that the feedback only includes results from the cognitive processing from the targeted environment rather than feedback from the overall system performance. This limits such a system from generating higher level of abstractions for new insights to autonomically optimize its own performance.

### What is Problem Solving?

For the purposes of the present disclosure, problem solving is considered a process for achieving a goal state, given an initial state, including a set of rules providing constraints on how the state may be changed in transitioning from the initial state to the goal state. This definition provides a universal basis for pursuing problem solving in any context that supports state definition and state testing. Within the realm of computational problem solving, a state transition system representable by a Kripke structure provides support for pursuing a solution for a problem. Since states in finite state automata represent values of objects relative to a point in time without specifying the types of objects, this provides unlimited flexibility for defining a state system.

This definition provides the basis for a state machine that can support any arrangement of items in terms of their semantic values related to other objects. Such a definition provides for a state machine that, for example, could represent a particular equation relative to the variables of the equation or even more significantly the arrangement of a particular problem state relative to other problem states in terms of solution paths. For purpose of this invention, solution paths indicate a sequence of state changes representing the truth of a conditional state for a problem at each state transition in the transition from the initial state of a problem to its goal state. Another term utilized in the undertaking of solving problem systems in terms of state is relational state tracking. Relational state tracking allows a complete history of all state changes within a system. This enables reversibility to a prior state and also supports reproducible reversibility so long as the underlying functions that change state are deterministic and the functional relations projecting the values associated to the states are stored along with the overall data state.

### Recursion

Recursion solves problems that are either too large or too complex to solve through traditional methods. Recursive algorithms work by deconstructing problems into manageable fragments, solving these smaller or less complex problems, and then combining the results in order to solve the overall problem. Recursion involves the use of a function that calls itself in a step having a termination condition so that repetitions are processed up to the point where the condition is met with remaining repetitions from the last one to the first.

Mathematical induction proves recursion. The definition of primitive recursion is:
I-algebra (X, in) admits simple primitive recursion if far any B [symbol] B and morphisms d: F;(X×B)−+B, there exists a S: X−+B such that the f. d. c. for i [symbol] I.

Corecursion then is the dual form of structural recursion. While recursion defines functions that utilize lists, corecursion defines functions that produce new lists. Thus, with corecursion, output rather than input propels analysis and is able to express functions that involve co-inductive types. Corecursion originally came from the theoretic notion of co-algebra with practical implications for higher order problem solving needed in a continuous learning framework.

Four primary methods prove corecursion: These are fixpoint induction, approximation lemma, co-induction, and fusion. Fixpoint induction is the lowest-level method, primarily meant to be a foundation tool. Approximation lemma allows the use of induction on natural numbers. Co-induction looks directly at the structure of the programs. Fusion is the highest-level of these four methods and allows for purely equational proofs rather than relying on induction or coinduction.

### The Tower of Hanoi as a Typical Problem

The Tower of Hanoi meets the requirements for a recursion problem, although it can be solved through iteration as well. The Tower of Hanoi represents a simple problem that contains a definitive solution pattern for the optimal number of steps. As the number of discs increase, the same solution approach applies in a recursive fashion. While it is trivial to implement an algorithm to solve the Tower of Hanoi, it is not so trivial to discover the algorithm in a generic fashion using simulation alone without pre-knowledge of the algorithm. As a typical recursion problem, the patterns that emerge from the solution model for discovering an algorithm relates similarly to any other recursive problem. Thus, the Tower of Hanoi provides a useful example for an exercise in algorithm discovery. The complexity of Tower of Hanoi also provides an example for incremental domain learning by means of increasing the complexity through adding another peg or by making the number of pegs a variable.

### The Role of Feedback in Problem Solving

It is becoming increasingly more common for computing systems to incorporate feedback in order to provide improvement to software. A simple example that Microsoft Windows™ users are familiar with is the feature that prompts the user if they wish to communicate information about an event causing an error back to Microsoft. By gathering, the information related to the error, Microsoft is then able to try to diagnose a root cause and potentially provide an improvement to resolve the issue back into the software through a service pack. Feedback is a fundamental tenant of evolutionary theory in that it provides a means to incentivize an organism to change its behavior if the feedback is adverse to the organism's survival. Software evolution based on a feedback loop is a key aspect for continuous improvement within a software process.

### Relational Models and Neural Networks

Relational state sequencing is a key enabler for representing Bayesian networks in both probabilistic and deterministic problems. State sequencing involves the capture of state changes occurring to an object or the attributes of an object. Through the capture of all object and attributes related to other objects and attributes in a system, relational state descriptions are obtained that represent the state changes and their relationships to changes of other attributes within the system. Capturing these relational state sequences allows a complete representation of a functioning system including the ability to replay the model and analyze sequences derived from execution of one model to that of another model. Storing these sequences into a repository and correlating them back to the source endeavors foster both unsupervised and supervised learning for intelligent analytic systems. Functional programming supports lambda calculus and pattern matching to integrate relational state descriptions in an evolutionary manner to solve problems.

Neural networks and relational models have different approaches, but are compatible for information representation. A neural network can be represented relationally and a relational model represented in a network model. This allows the use of a relational model to store the concepts associated with a network learning exercise. Integration of functional programming outputs into relational state sequences that represent the complete behavior of a system allow convergence to recursive relations to generalize behavior of systems.

Through relational state tracking, the capture of complete information about a system behavior occurs which then enables the complete analysis of the correlations within the system. Through a recursive framework, actions used to analyze the relational sequences become enablers for higher and higher order problem transformations that optimize not only the base problem but the higher order problems of how the framework itself can achieve new capabilities through its own introspection. These new capabilities form the basis for the generation of new algorithms that provide further improvement within a software framework.

### Self-Organizing and Diminishing Returns

The concept of searching for solutions to problems in a symbiotic fashion that benefits the overall system manifests in the principle of self-organization. Self-organization enables a system to improve itself without external modification. To be effective, self-organizing systems must possess the following attributes:
Autonomy: The system needs no external controls.
Emergence: Local interactions induce creation of globally coherent patterns.
Adaptability: Changes in the environment have only a small influence on the behavior of the system.
Decentralization: The control of the system not done by a single entity or by just a small group of entities but by all entities of the system.

### The Recursion Exit Dilemma

For recursion problems that involve potentially infinite recursion, a constant or type of expression serves as an exit condition to cause the unwinding of the recursion. This technique has application to a recursive problem solving framework. To ensuring exiting from recursion, an optimization problem that concerns the exit condition for the recursion itself must be presentable to the system, ideally presented in the same manner as any other problem presented to the framework.

### The Equilibrium Paradigm

Equilibrium within a system manifests when the system reaches a steady state or ranged state such that a balance between different functions exists. This result is typical of systems that act upon themselves; the reactions in the system arise from actions and have a counter effect on the initiating actions over a sequence of states. Financial markets to a certain degree exhibit equilibrium since money inflows, money supply expansion, and money redistribution act upon the overall system (Pareto Principle). Equilibrium generally indicates that a system has reached a level of optimization whereby alterations do not provide benefit if the system is achieving the desired goal state.

Multi-agent reinforcement learning can facilitate equilibrium in machine learning systems. These systems utilize cooperating agents to converge to a desired equilibrium that spawns actions that contribute in actions that optimize reaching of the goal. Equilibrium naturally arises from a recursive problem resolution framework through the use of a “learning problem” that pursues solution in the framework as a continuous operational problem with constraints provided for meeting goals in terms of success and diminishing returns. A system that implements a recursive approach for problem resolution is thus able to leverage the same infrastructure for the optimization problem as that used for other problems and reap the benefits of cross-domain learning and continuous improvement.

### Using Simulation to Solve Problems

Simulation can be utilized to solve any problem that involves a sequence of steps. Simulation implies a starting state, transition states, and goal states to pursue. Therefore any problem that can be solved with simulation lends itself to modelling. A problem that can be modelled implies it has a schematic representation lending itself to a framework that works with problem states relationally. A solution for any problem that involves a sequence of steps or a solution path incorporating decision-making can be targeted through simulation. Simulation approaches for problems spanning across virtually all sectors and industries are well-established. The below list are just some of the examples:

Energy
Combining simulation and optimization for improved decision support on energy efficiency in industry
Applying computer-based simulation to energy auditing

Materials
Software products for modelling and simulation in materials science

Industrials
Capital Goods
   Computer-aided production management issues in the engineer-to-order production of complex capital goods explored using a simulation approach
Transportation
   Toward increased use of simulation in transportation

Consumer Discretionary
Automobiles & Components
   An integrated simulation framework for cognitive automobiles
   Modeling signal strength range of TPMS in automobiles
Consumer Durables & Apparel
   A consumer-driven model for mass customization in the apparel market
   A simulation model of quick response replenishment of seasonal clothing
Consumer Services
   Multi-agent based simulation of consumer behavior: Towards a new marketing approach
   Agent-based simulation of consumer purchase decision-making and the decoy effect
Media
   System and method for consumer-selected advertising and branding in interactive media
Retailing
   Queuing theory
   Evaluation of Traditional and Quick-response Retailing Procedures by Using a Stochastic Simulation Model

Consumer Staples
Food & Staples Retailing
   Customized supply chain design: Problems and alternatives for a production company in the food industry.
   Simulation of the performance of single jet air curtains for vertical refrigerated display cabinets
Food, Beverage & Tobacco
   Modeling beverage processing using discrete event simulation
   Using Tobacco-Industry Marketing Research to Design More Effective Tobacco-Control Campaigns
Household & Personal Products
   Methods and systems involving simulated application of beauty products
   Simulation of Particle Adhesion: Implications in Chemical Mechanical Polishing and Post Chemical Mechanical Polishing Cleaning

Health Care
Health Care Equipment & Services
   A Survey of Surgical Simulation: Applications, Technology, and Education
   The T-SCAN™ technology: electrical impedance as a diagnostic tool for breast cancer detection
   The future vision of simulation in health care
Pharmaceuticals, Biotechnology & Life Sciences
   A simulation-based approach for inventory modeling of perishable pharmaceuticals
   Selection of bioprocess simulation software for industrial applications
   Modelling composting as a microbial ecosystem: a simulation approach
   Modeling and Simulation in Medicine and the Life Sciences

Financials
Banks
   Accounting for Financial Instruments in the Banking Industry: Conclusions from a Simulation Model
   Market Power and Merger Simulation in Retail Banking
Diversified Financials
   Simulation of Diversified Portfolios in a Continuous Financial Market
   Optimal Versus Naive Diversification: How Inefficient is the 1/N Portfolio Strategy?
Insurance
   Simulation in Insurance
   A general for the efficient simulation of portfolios of life insurance policies
Real Estate
   A Computer Simulation Model to Measure the Risk in Real Estate Investment
   Quantitative Evaluation of Real Estate's Risk based on AHP and Simulation

Information Technology
Software & Services
Technology Hardware & Equipment
Semiconductors & Semiconductor Equipment
Telecommunication Services

Utilities
A Hybrid Agent-Based Model for Estimating Residential Water Demand
Modeling and simulation for PIG flow control in natural gas Pipeline
Agent-based simulation of electricity markets: a survey of tools

### Towards a Generic Schema for Simulation Problems

For a problem solving system to function generically across different problem types, the system must be able to interact generically with all types of problems. This implies the need for a general-purpose schema for representing information about any problem. Historically, problem domains rely on semantics and schemas specifically targeting the domain rather than on generic constructs. Various models have been put forth to try to make schemas for problems generic, but without a unified model from that can represent knowledge from all problems, integration of knowledge across problem space requires custom agents that can interpret the information specific to a problem domain. Case-based reasoning (CBR) systems provide a model for such a generic database for general purpose problem solving. CBR functionality is dependent on a path and pattern database that stores the all problem and solution states.

Relational algebra provides finitary relations that allow objects to be organized relative to other objects in terms of existence dependencies as well as enabling object values to be associated to the parent object containers. This allows a relational database schema to represent semantically how collections of objects relate in terms of dependencies as well as values. Such a schema provides utility for a problem solving framework since full state representation is dependent on object values relative to each other at each sequence in a problem solving exercise. Since the values are able to provide the linkage between the objects and this information is part of the information schema of the model, this effectively supports neural-network constructs of associating an object to another object. Metrics regarding the relative strength of a connection can be determined in terms of the number of intervening nodes as well as in terms of numbers of physical connections based on cardinality between the nodes.

Value change state relative to other values in the model over a sequence of states yield binary strings indicating truth or falsity between every object in the system for every state. Through application of transform operators successfully predicting the outcome of one instance from other instances, a progression of transformation operator sequences results. Since the relational model provides for information about itself within the same model containing the information, it supports self-representation and a recursive data structure, which are both foundational to provide generic semantics to agents interacting with the structure.

### Extensibility of a Framework

Many have attempted at distilling problem solving into software frameworks. Among these attempts include the use of cognitive primitives, evolutionary multi-agent systems, and algorithm pools. Utilizing any of these approaches limits the effectiveness of such problem solving frameworks to the targeted domain unless a recursive feedback system is implemented on top of the solution that can transform prior learning exercises into transformation problems that can assert solution paths to new problem instances.

### Attributes of Intelligent Systems

Understanding a problem, discovering solutions, and profiting from solving exercises to enable improvement of the overall problem solving framework so that additional problems incrementally benefit from the problem solving experiences are enabled by the following four attributes:
1. Problem Representation: A system cannot endeavor to solve a problem unless the problem can be schematically represented such that a solving agent can understand the starting state, desired state, and allow intermediate states that are traversable in order to find solution discovery paths.
2. Solution Space Probing: A solution to a problem is undiscoverable unless there is a simulation process for exploring possible solutions to determine the sequence of steps to achieve the solution.
3. Performance Metric Collection: For a system to be able to improve it must have a mechanism to collect metrics about how well it is performing so that these metrics can be analyzed to determine the relative effectiveness of actions carried out by the system for problem solving.
4. Performance Analysis: There must exist a process that correlate the effectiveness of a system to meet its goals with the steps taken to obtain the goals.

### Problem Schematization Approaches

U.S. Pat. No. 8,321,478 B2 outlines one method to convert from relational to XML or from XML back to relational. For purposes of a universal problem resolution framework, a conversion and the method itself is inconsequential so long as the system is able to preserve the fidelity of the original representation in the conversion process to convey the resultant states from the model to the framework. Mapping objects from one type of representation such as XML to a relational representation is a common capability provided in many different software products, indicating that such a framework capability could be implemented directly or indirectly through a third-party component.

### Other Computational Problem Solving Approaches

U.S. Pat. No. 8,291,319 B2, entitled, “Intelligent Self-Enabled Solution Discovery,” discusses solutions for solving a problem experienced by a user. In response to receiving a query from the user describing the problem, relevant candidate solutions to the problem are sent to the user. In response to receiving a selection of one relevant candidate solution from the relevant candidate solutions, instructions steps within the one relevant candidate solution selected by the user are analyzed. An instruction step similarity is calculated between the instruction steps within the one relevant candidate solution selected and other instructions steps within other solutions stored in a storage device. Then, similar solutions are sent to the user containing similar instruction steps to the instruction steps contained within the one relevant candidate solution selected based on the calculated instruction step similarity. The cited approach is limited in regard to continuous improvement of the underlying solving system because it is dependent on user interaction, rather than allowing for autonomous improvement based on the system learning intrinsically from its own solving experiences.

U.S. Pat. No. 7,072,723 B2, entitled, “Method and System for Optimization of General Problems,” discusses optimization methods and systems that receive a mathematical description of a system, in symbolic form, that includes decision variables of various types, including real-number-valued, integer-valued, and Boolean-valued decision variables, and that may also include a variety of constraints on the values of the decision variables, including inequality and equality constraints. The objective function and constraints are incorporated into a global objective function. The global objective function is transformed into a system of differential equations in terms of continuous variables and parameters, so that polynomial-time methods for solving differential equations can be applied to calculate near-optimal solutions for the global objective function. This approach concerns mathematical problems and does not cover decision problems, nor does it monitor its own algorithm selection process which is needed for autonomous improvement.

U.S. Pat. No. 7,194,445 B2, entitled, “Adaptive Problem Determination and Recovery in a Computer System,” discusses a method, computer program product, and data processing system for recognizing, tracing, diagnosing, and repairing problems in an autonomic computing system. Rules and courses of actions to follow in logging data, in diagnosing faults (or threats of faults), and in treating faults (or threats of faults) are formulated using an adaptive inference and action system. The adaptive inference and action system includes techniques for conflict resolution that generate, prioritize, modify, and remove rules based on environment-specific information, accumulated time-sensitive data, actions taken, and the effectiveness of those actions. This enables a dynamic, autonomic computing system to formulate its own strategy for self-administration, even in the face of changes in the configuration of the system. In this patented system, the historical problem solving data is not formalized to a higher order problem that is solved within the self-same framework. Additionally, the higher level abstraction is not continuous but only one level higher than the base system, oriented toward system configuration strategies rather than application to calculate solution paths for new problem instances.

Accordingly, there is a need for a problem solving system that supports not only general representation to support simulative solving, but provides discovery and application of solution patterns as the system encounters problems in an autonomous fashion that results in continuous improvement of the system without the need for ongoing human intervention.

### BRIEF SUMMARY OF THE INVENTION

The present invention is directed to a method, system and apparatus that satisfies the need for a problem solving system that supports not only general representation to support simulative solving, but provides discovery and application of solution patterns as the system encounters problems in an autonomous fashion that results in continuous improvement of the system without the need for ongoing human intervention. Various embodiments of the invention are directed to the methods, apparatus and system that provide a universal problem resolution framework (UPRF). UPRF constitutes a system and method for universal problem resolution with continuous improvement. The UPRF is a collection of constraints, processes and requirements for a design that fully supports generic representation of problems, generic pursuit of problem solutions and continuous improvement utilizing an overarching set of processing components without the need for modifications of the actual components for the solving system. These solving systems prescribe a set of constructs for relational problem representation that support simulation and solution discovery including higher order problem transformation. The UPRF described herein can be implemented on any sufficiently powerful processor, processors or computing system, as described herein in order to improve the overall ability of the processor to solve problems.

Rather than take the focus of artificial intelligence, which has traditionally been on the development of specific algorithms or targeting specific domains, an apparatus, methods, and further embodiments are provided for the holistic process of learning and problem solving. A holistic process can function across all domains and is not limited to particular algorithms or applications.

Many have attempted at distilling problem solving into software frameworks but a limitation of such approaches to date is the lack of a recursive feedback system that adequately tracks all operations carried out such that the sequences of such operations can be transformed into higher level problems in a continuous fashion. The present invention is novel in this regard since rather than choosing a particular machine learning strategy, it resides at a layer above the A/I realm to act as a holistic consumer and benefactor from an extensible library of underlying algorithms. From this, the system can dynamically select its own sequences of decision-making continually transform into higher-order problems that target predicting solutions to unsolved problem instances using prior learning experiences. As such, the disclosed invention is a new system, method and apparatus that improves the ability of any processor, set of processors or computing system to carry out computer problem solving, but is agnostic as to the particular processor, language or machine learning strategy used.

UPRF lends itself to solving virtually any problem whose solution can be pursued through a simulation approach. This includes any problem that involves a sequence of steps to determine a solution. Practically any computational problem can be modelled as a simulation problem. Examples of problems that support modelling in a simulation fashion span across virtually all sectors, industries, and applications, some of which are listed below:

| | |
|---|---|
| Risk Mitigation | Strategy |
| Credit Risk | Strategy Games and Puzzles |
| Cybersecurity | MMO Games |
| Cost/Benefit Scenarios | Disease Control |
| Industrial Quality Control | Planning |
| Market Basket Analysis | Warfare Mission Planning |
| Automation | Research |
| Self-driving cars | Drug Development |
| Robotics | Synthetic Materials |
| Optimization and Throughput | Prediction |
| Freight Delivery | Investing Outcomes |
| Flow Control | |

An apparatus, methods, and further embodiments are provided for the UPRF to address the following requirements:
1. A generic representation of a problem including the queries that associate functions and data attributes to generate objects that map to its initial, goal, and allowed transition states;
2. A system that can probe the solution space based on the problem states in a general fashion without knowledge of the problem domain; and
3. A mechanism to learn from the solving of related instances in order to create higher and higher level abstraction problems that yield higher level instances, which generate higher order assertions that can ultimately generate solution paths without simulation.

### BRIEF DESCRIPTION OF DRAWINGS

These and other features, aspects and advantages of the present invention will become better understood with reference to the following description, claims and accompanying drawings where:

FIG. 1 is a process view of the continuous improvement cycle of the present invention;

FIG. 2 is an entity relationship diagram of the states of a problem instance of the present invention;

FIG. 3 is an entity relationship diagram used to describe an expression within the problem instance of the present invention;

FIG. 4 is an entity relationship diagram used to describe a problem instance's relationship between entities of the present invention;

FIG. 5 is an entity relationship diagram used to describe an expression operator within the problem instance of the present invention;

FIG. 6 is an entity relationship diagram used to describe an expression's return values within the problem instance of the present invention;

FIG. 7 is an entity relationship diagram used to describe a state evaluation operator within the problem instance of the present invention;

FIG. 8 is an entity relationship diagram used to describe an expression operator and its components within the problem instance of the present invention;

FIG. 9 is an entity relationship diagram used to describe an expression operator's query execution within the problem instance of the present invention;

FIG. 10 is an entity relationship diagram used to describe the details of an expression operator's compare operator within the problem instance of the present invention;

FIG. 11 is an entity relationship diagram of the depicts the overall flow in constructing a problem definition within the Universal Problem Resolution Framework for this invention;

FIG. 12 illustrates how data items flow out of a problem to represent solution paths through a problem solving exercise;

FIG. 13 shows an implementation of the system utilizing agents to perform the various functions for the present invention;

FIG. 14 illustrates instance expansion that occurs as a result of searching out solution paths for a problem;

FIG. 15 shows the problem-instance state flow for execution by processes within the invention;

FIG. 16 is a detailed process flow diagram of an embodiment that includes query extraction processing to derive states;

FIGS. 17-18 combined provide an instance of UPDL used for the example of FIGS. 19-21 of this invention;

FIG. 19 is a process view of an example simulation process of the present invention that illustrates generation of new instances and path termination;

FIG. 20 is a general graph diagram instance of flow including reversibility for transforming simulations into higher order problems defined by the UPDL of an example simulation process of this invention;

FIG. 21 is a detailed graph diagram instance of flow showing the reversibility for transforming simulations into higher order problems defined by the UPDL of an example simulation process of this invention;

FIG. 22 provides an example XML schema definition for representing a relational structure with function mapping to support the generic probing of a problem for a solution that outputs the necessary state sequences for the invention;

FIG. 23 provides sample outputs that arise from the Tower of Hanoi example through instances generated from the problem definition;

FIG. 24 depicts the sample Tower of Hanoi sample problem graphically;

FIG. 25 provides sequence patterns derived from the entities, attribute, and attribute value combinations for multiple instances using the Tower of Hanoi example;

FIG. 26 depicts the distinct state sequences for discs selections from solved instances for the Tower of Hanoi example;

FIG. 27 depicts the distinct state sequences for peg values from solved instances for the Tower of Hanoi example;

FIGS. 28-29 depict a schema for the transformation problem that searches for sequences of operations on relational state sequences from an underlying problem that successfully predict relational state sequences for another instance of an underlying problem;

FIG. 30 is a set of state sequences associated with the different entity keys and attribute values arising from solving the Tower Of Hanoi example where the number of discs employed are 2 and 3;

FIG. 31 is a set of state sequences created by a first-order transformation problem against a solved instance (2 discs) of the Tower of Hanoi example that targets solving another instance (3 discs);

FIG. 32 is a set of state sequences associated with the different entity keys and attribute values arising from solving the Tower Of Hanoi example where the number of discs employed are 3 and 4;

FIG. 33 is a set of state sequences created by a first-order transformation problem against a solved instance (3 discs) of the Tower of Hanoi example that targets solving another instance (4 discs);

FIG. 34 is a comparison of the state sequences associated with the transformation solving instances for 2 to 3 discs and 3 to 4 discs for the Tower of Hanoi example;

FIG. 35 is a set of state sequences created by a second-order transformation problem instance for the Tower of Hanoi example to transform the sequence of operations needed to transform the transformation solution for 2 to 3 discs to output the transformation solution sequences that transform the transformation solution for 3 to 4 discs;

FIG. 36 is a set of state sequences associated with the different entity keys and attribute values arising from solving the Tower Of Hanoi example where the number of discs employed are 4 and 5;

FIG. 37 is a set of state sequences created by a first-order transformation problem against a solved instance (4 discs) of the Tower of Hanoi example that targets solving another instance (5 discs);

FIG. 38 compares the second-order transformation sequences from two second order transformation problems instances for the Tower of Hanoi example;

FIG. 39 is a set of state sequences created by a second-order transformation problem instance for the Tower of Hanoi example to transform the sequence of operations needed to transform the transformation solution for 3 to 4 discs to output the transformation solution sequences that transform the transformation solution for 4 to 5 discs;

FIG. 40 is a set of state sequences created by a third-order transformation problem instance to transform the first second-order transformation sequence to generate the second second-order transformation sequence for the Tower of Hanoi example;

FIG. 41 is a set of state sequences from a solved instance for the Tower of Hanoi example for 2 discs;

FIG. 42 shows reversal of a state sequence to output solution steps for the Tower of Hanoi example with 2 discs;

FIG. 43 shows reversal of a state sequence for a first-order transformation problem instance to output the solution steps to generate the transform steps to solve a problem instance for the Tower of Hanoi sample without using simulation;

FIG. 44 shows reversal of a state sequence for a second-order transformation problem instance to output the solution steps to generate the transform steps to solve a first-order transformation problem instance for the Tower of Hanoi sample without using simulation;

FIG. 45 illustrates a schema for an N-Peg Tower of Hanoi variation;

FIG. 46 provides a sample embodiment of a relational view to represent the N-Peg Tower of Hanoi;

FIG. 47 provides a sample embodiment of a function that generates the next candidate state for the N-Peg Tower of Hanoi example;

FIG. 48 shows sample solution sequences for N-Peg Tower of Hanoi;

FIG. 49 shows sample disc solution sequences for N-Peg Tower of Hanoi;

FIG. 50 shows sample peg sequences for N-Peg Tower of Hanoi;

FIG. 51 shows total sequence values for pegs or discs for N-Peg Tower of Hanoi;

FIGS. 52-53 shows a schema for searching the optimal sequence of moves for either player for Tic-Tac-Toe;

FIG. 54 illustrates symmetries for solution paths for the Tic-Tac-Toe example;

FIG. 55 shows the Tic-Tac-Toe square numbering;

FIG. 56 shows the transform hierarchy for arriving to the general purpose higher transformation solution for Tic-Tac-Toe;

FIG. 57 provides 3 simulation use cases for the Tic-Tax-Toe example;

FIG. 58 depicts the state sequences associated with optimal Tic-Tac-Toe play;

FIG. 59 is a schema for the zero-subset problem utilizing a different problem schema than the prior examples;

FIG. 60 shows another embodiment of the problem representation schema;

FIG. 61 are sample zero-subset problem solutions;

FIG. 62 are sample solve sequences derivable from the present invention for the zero-subset problem;

FIG. 63 provides an embodiment for loading problems from XML files for the invention to solve.

### DETAILED DESCRIPTION OF THE INVENTION

### Overview of the Simulation Process and Continuous Improvement Cycle

The Universal Problem Resolution Framework (UPRF) of the present invention provides a transformation paradigm in which the state sequence associated with each distinct value from problem instances solved using simulation become sources and targets for a higher order transformation problem that records operation sequences that correctly predict target sequences for the lower level problem from other sequences without the need for re-simulation. The solution exploration is based on simulation whereby UPRF searches for solutions utilizing the transition queries until a goal state or failure state is reached or until a generalization from a higher order transform is realized that successfully calculates the relational state sequences associated with an unsolved instance. When a generalization is realized, it is applied back to the original problem for instances that are targeted for solution by prediction rather than through simulation. Relational State sequences also described as simply State Sequences are reversible back to the problem solving steps so that the sequence of steps associated with the sequence is reconstitutable.

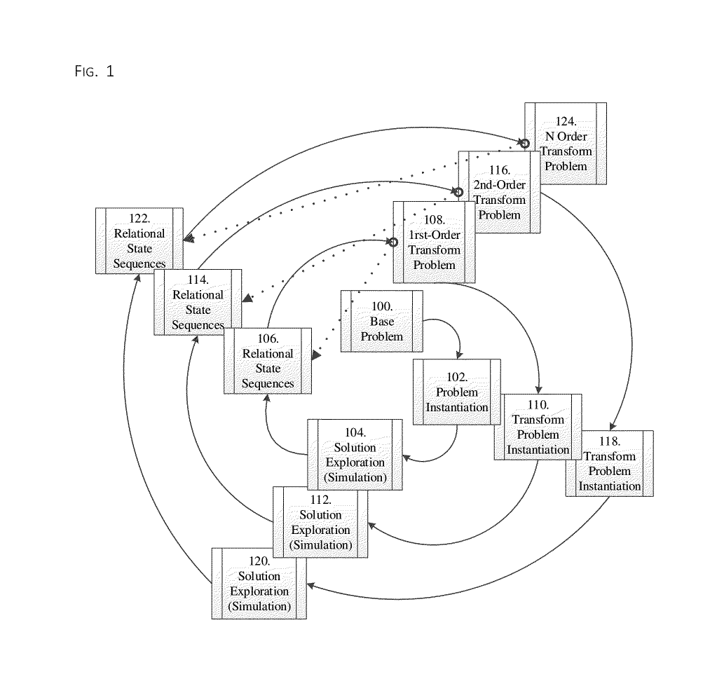

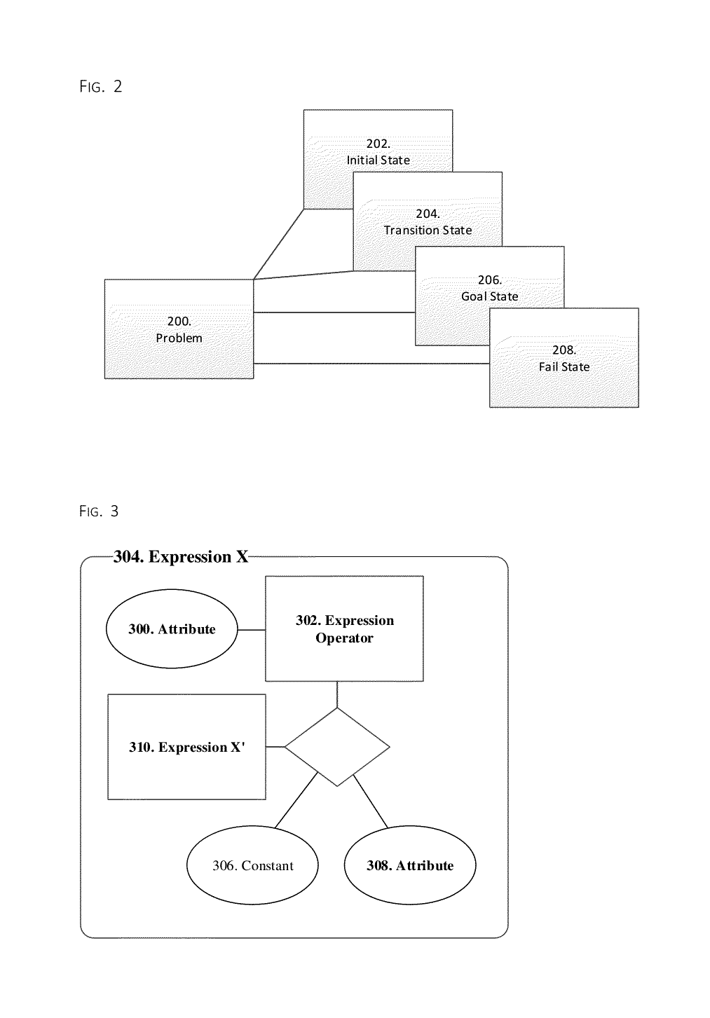

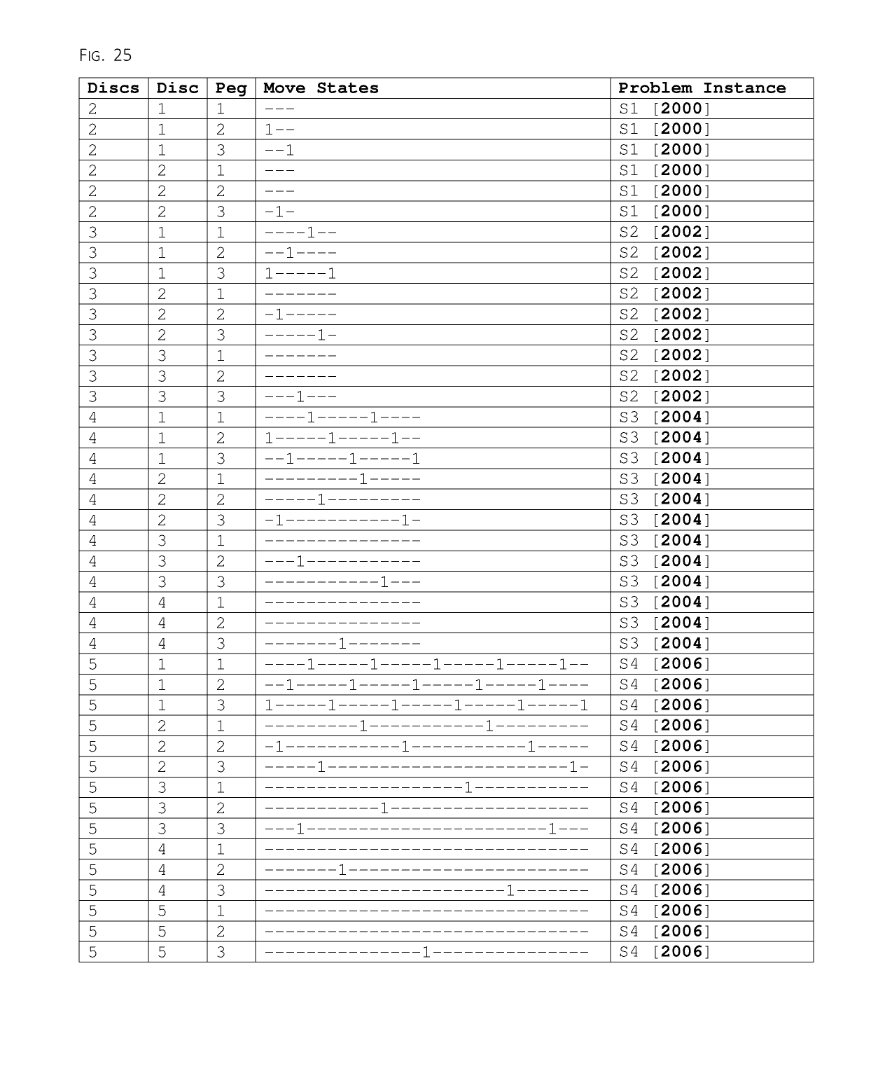

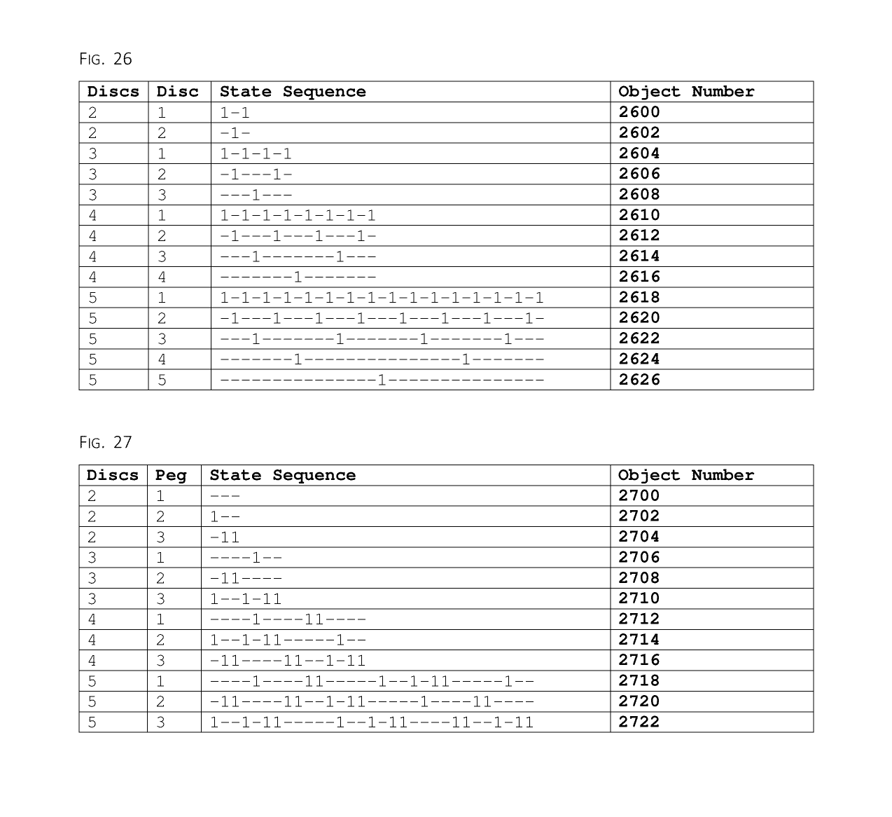

FIG. 1 illustrates the overall concept. A base problem 100 such as the Tower of Hanoi (wherein the goal is to move discs from an initial peg to a target peg in the shortest number of steps while ensuring that the a larger disc is always under a smaller disc as in FIG. 24) is defined to the system in such a manner that the problem decomposes to multiple instances based on queries that generate initial states representing problem instances (a sample embodiment for state generation is provided in FIGS. 2-11). The initial states result in multiple instances 102 associated with the solution exploration 104 of the problem. In the case of the Hanoi example, the multiple instances could be defined as different variations of the problem such as the number of discs. Another example could be an n-peg Tower of Hanoi whereby both the number of discs and number of pegs are variable to generate multiple instances. The base problem does not need to be deterministic with a definitive algorithm and could be based on converging such as the minimization of steps as in finding the quickest number of steps for a traveling salesman problem or the maximization of profitability for an investment strategy. The base problem may also be defined in terms of multiple agents in cooperative and/or collaborative fashion such as a massively multiplayer online game (MMO) game.

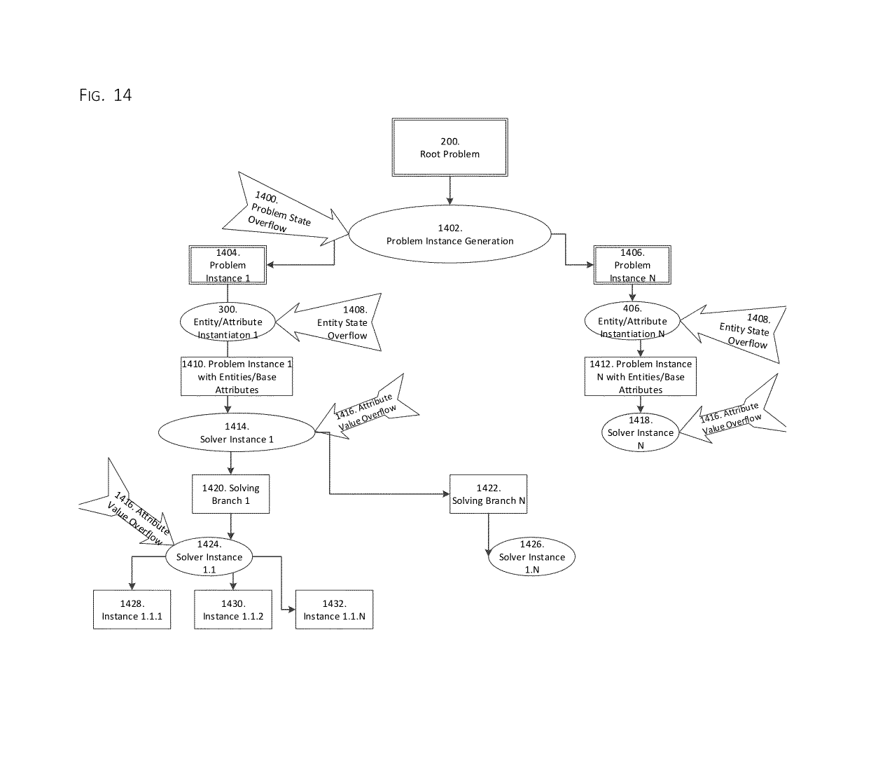

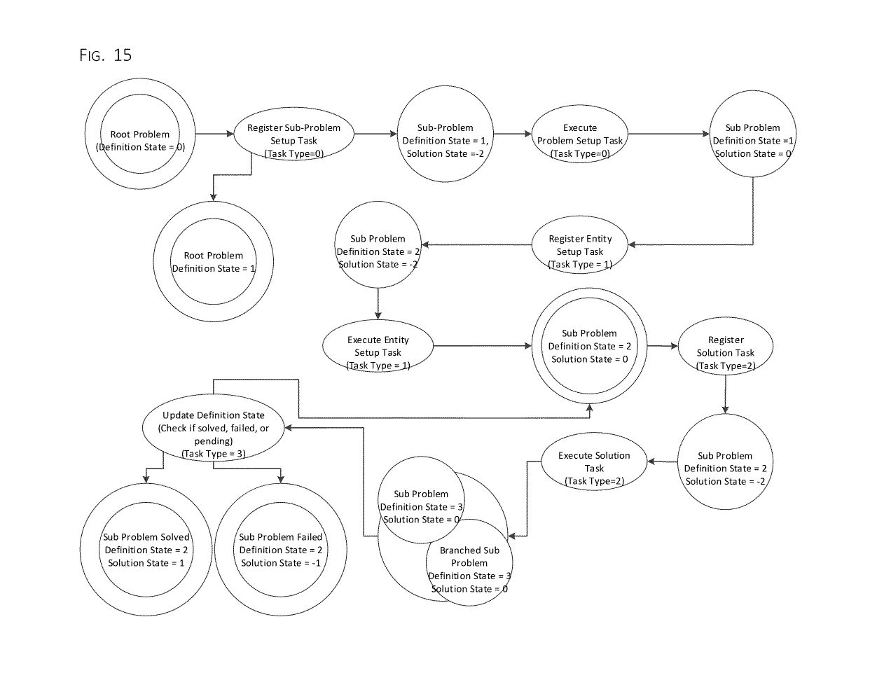

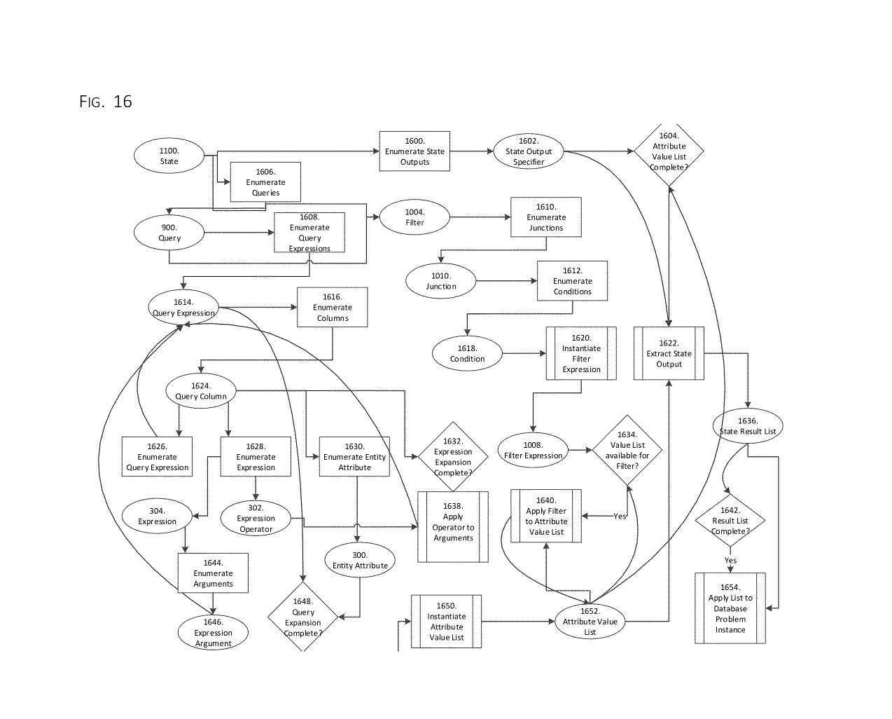

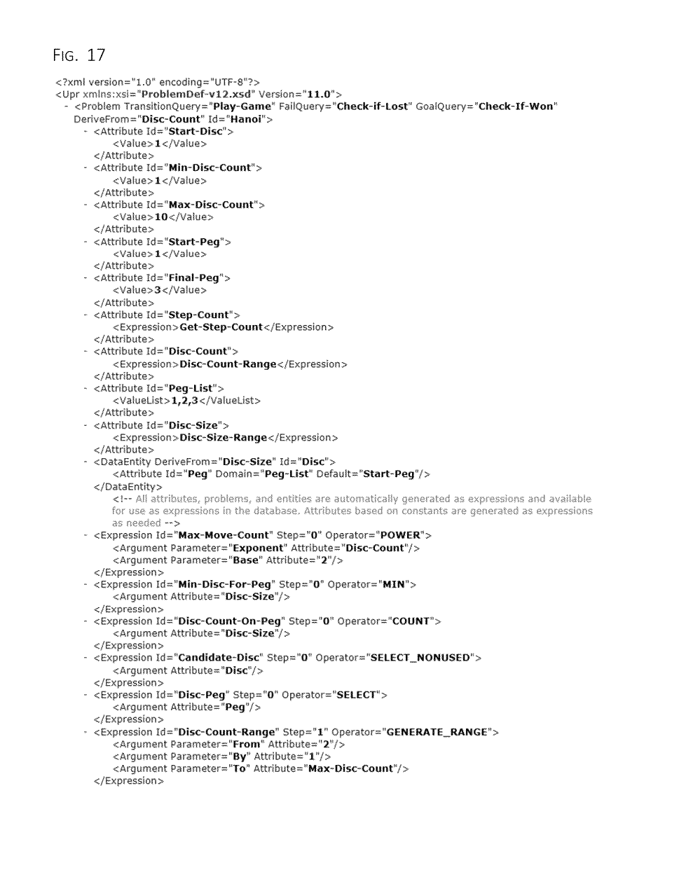

In the Solution Exploration phase 104, additional instances may be generated for the problem based on multiple pathways. For example in the Tower of Hanoi case, there may be more than one choice for a starting instance resulting in branching to a different solution path. The generation of multiple instances while solving a problem is explained later in the discussion of FIG. 14. In the Tower of Hanoi example, there is only one correct path for any given instance, but this is not a requirement of the invention with an example being the N-Peg Tower of Hanoi. The invention functions for the case where multiple successful paths mark a solution to an initial problem instance.

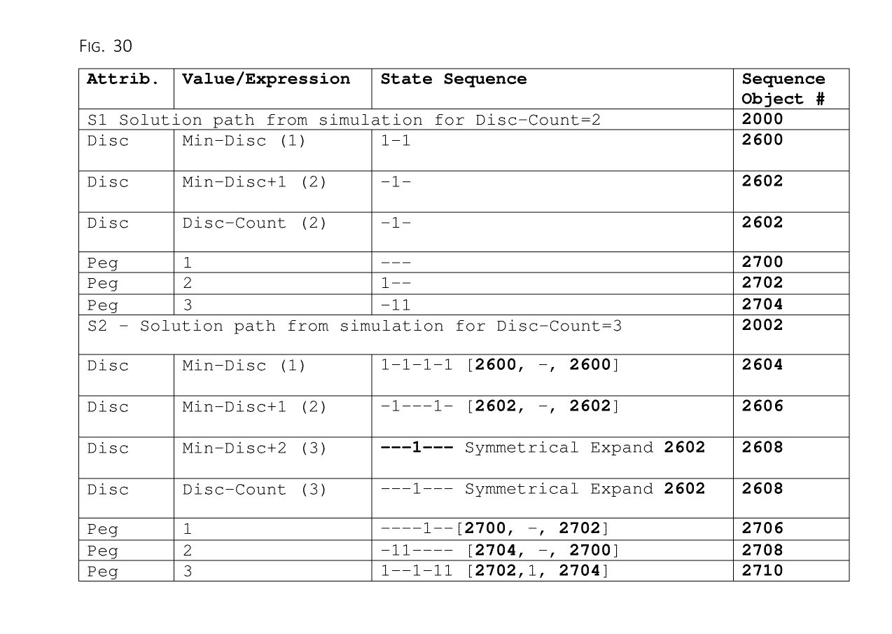

Relational State Sequences 106 are derived from tracking the distinct entity and attribute values for each step. For example in the Tower of Hanoi case, the relational state sequence for the smallest disc indicates visiting at every other step for each solution that meets the goal of the minimum moves. This is represented by a binary string linked to the entity and its key as in Hanoi.Instance.2Discs.Branch1.Disc.1:101 in the case of a 2 disc Hanoi where 1 is the smallest disc, 2Discs identify the original instance with 2 discs, and Branch1 is the first branch of the instance. In the Tower of Hanoi case for a disc count of 3, the representation for the optimal solution instance could be Hanoi.Instance.3Discs.Branch2.Disc.1:1010101 in the case of a 3 disc Hanoi where 1 is the smallest disc, 3Discs identify the original instance with 3 discs, and Branch2 is the second branch of the instance. Additional sequences would be generated for the distinct peg values used. For example in the peg sequences related to the prior-mentioned disc sequences, Peg 3 is visited on the second and third steps generating a sequence of Hanoi.Instance.2Discs.Branch1.Peg.3:011 while for disc count of 3, the Peg state sequence would be Hanoi.Instance.3Discs.Branch2.Peg.3:1001011. The details of the sequence results are described in more detail later in the discussion of FIGS. 30-32.

First-order transformation problem 108 which derives from the Learning Problem, a generic solving problem for calculating state sequences to transform a set of state sequences from a lower-level problem instance to solve another problem instance. This problem is defined such that multiple instances are generated from lower level instances that seek for transformation operators, which will successfully map lower level problem instances to predict lower level problem instances successfully. An example in the Tower of Hanoi case would be the sequence of operations needed to transform the peg 3 sequence of 011 for a count of 2 discs to 1001011, the peg 3 sequence associated with a 3-disc solution.

Transformation problem 110 represents the instantiations of the transformation problem. For the Hanoi example, each permutation of relational state sequences that provide one or more sources on which to transform to generate a target sequence represents a transformation problem instance. The exact same process involved with solution exploration for the base problem is repeated for the transformation problem wherein the problem definition of the transformation problem exposes the candidate functions which is based on an extensible library queried dynamically that perform transformation upon sequences or steps in a sequence to generate another sequence. This solution exploration is represented in 112 conjoined to 104 and 120, which also represent solution exploration to emphasize that this processing is simply another instance of the identical process used to explore the base problem as well as for higher-order transformation problem instances. Relational State Sequences 114 track the sequence of specific operators utilized to transform from one or more source sequences to a target sequence. These sequences constitute references to the operators utilized to transform a sequence or part of a sequence. For example, a binary expansion operator transform the 101 disc 1 sequence for a 2-disc instance to a 1010101 sequence for a 3-disc instance. In that case, sequences identify the distinct sources, targets, and operators over a solution sequence. In the case of the a transformation to solve peg 3 for an instance involving 3 discs using a 2 disc instance, a step-by-step transform sequence is required to generate 1001011 from 011. In that case, the relational state sequences associated to peg 3 would first represent a copy operation of the Peg 1 sequence for a count of 2 discs (100), then an insertion of a binary 1 followed by copying the state sequence of peg 3 (011) from the 2 disc instance. Each of these constitutes separate relational sequences reconstitutable to generate the exact sequence of steps as explained later in the discussion of FIGS. 30-40.

The Relational State Sequences 114 arising from multiple instances of transformation sequence solutions provide the problem instances for a second order transformation problem 116 that seeks to find the sequence of operations along with the specific sequences to utilize in order to transform the transformation sequences of lower level transform instances to predict transformation sequences for other transform instances. For example in the Tower of Hanoi scenario, additional transformation instances are generated for transforming the solution for 3 discs to 4 discs and the sequences associated with that transformation become the target for using the source transformation sequences associated with the sequences to transform from 2 to 3 discs. The higher-level transform thus creates instances 118 for the generation of transformation sequences for selecting the operators to perform the lower level transform sequences. These sequences are explored 120 using the identical framework for the first order transformation problem solution exploration 112 leading to a set of relational state sequences with the same structure as those of the first order transform, but linked to the first order 114 transform sequences rather than the base problem sequences 106. This yields the relational state sequences depicted by 122.

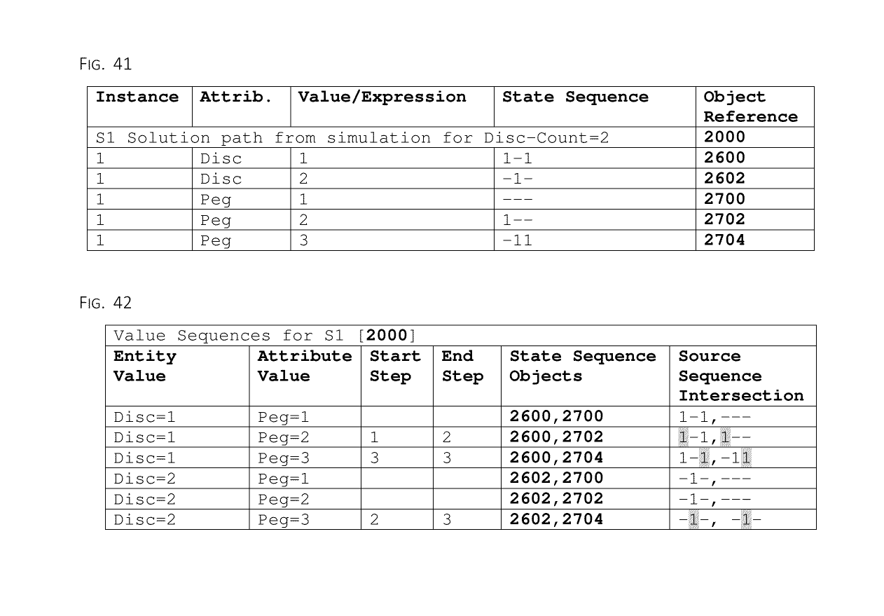

As the transformation proceeds to higher and higher levels 124 through this recursive process, the sequences converge to generalization such that when the solution is found the higher order transforms result in the identical transformation sequences. When this occurs, reversal of the sequences referred to as co-recursion is possible explained later in the discussion of FIGS. 41-44 such that relational state sequences for additional problem instances from the base problem are derived directly from application of the transformation sequence to generate relational state sequences that are reversible to specify the exact steps performed to each entity and attribute from the lower level problem, ultimately reversing down to the base problem.

State sequence generation involves capturing the steps used to solve the problem and transforming them into higher—level sequences recursively by monitoring all of the objects that change state over a solving sequence. Once these have been decomposed into distinct value sequences, the sequences needed to convert one sequence instances to other sequence instances are solved, ultimately leading to generalizations. The generalizations can be reversed to generate sequences for lower and lower transformation problems ultimately leading to reversible sequences that solve problem instances from the original base problem without the need for simulation. This reversal process is part of the co-recursion paradigm for unwinding from the recursive transformation problem generation. The Hanoi example demonstrates how this reversal ultimately decomposes to specific steps to solve problem instances not yet simulated in the framework prescribing which disc to move and to what peg on each step for an instance containing more discs that had been solved with simulation.

### Foundational Assertions for UPRF Capabilities

This section establishes the capability for UPRF to solve different problems generically including the learning problem of finding optimal problem solutions (transformation problem generation) based on a proof derived from properties of problem solving using self-evident postulates:

### Postulates

1. Based on the dynamicity of the expression operators and the ability of the expressions to operate against any set of attributes, defining the appropriate functions can derive any set of values associated with a problem.
2. Any problem state where state is the result of a query that relate behaviors of objects within a problem is feasible through expressions that operate against the underlying data schema. This derivation is context sensitive, related to other states using the state sequence qualifier for expressions or when referencing expressions.
3. This definition supports the ability to generically define any problem using the same schema and utilize a generic simulation approach to apply the functions to generate states in the pursuit of a goal query defined for the problem.

### Reflexive Property of Problem Solving

The reflexive property of problem solving allows the solution to a problem to be query-able within the constructs of the same schema that defined the problem. This provides the foundation for transforming a problem that has associated solution instances into a higher order problem that attempts to augment the base problem with a prediction (transform) operator. The prediction operator then generates additional expressions and queries to reduce the number of simulations and predict the solution path for additional instances of the problem. The property conforms to the following two constructs:
1. Any problem P that the framework presents for solution by the system generates one or more attribute value outputs per entity key along a state sequence. The state sequences representing the distinct entities and attribute keys for each step in a solution endeavor can be stored generically through the same entity/attribute structure as that used to represent the problem. This means that the entire solution endeavor is visible to a higher order problem using the same schema.
2. All problems are solved using a generic process such that the output actions taken in regard to each problem are stored generically within the same entity/attribute structure which is represented by:

a. Problem Instance
1) Problem-Identifier
2) Instance-Identifier
3) Result-State
4) Instance-Step

b. Entity Instance
1) Instance-Identifier
2) Instance-Step
3) Entity-Key
4) Entity-Attribute
5) Value

Based on these constructs, UPRF captures all of the states of each entity instance associated with a problem for each entity attribute. This provides foundations for a predictive solving framework based on learning the sequence of operations involved with transforming a relational states sequence from one instance to predict another sequence:

### Postulates of the Predictive Solving Framework

1. Let VS be a set of values over a series of steps that represent the truth or falsity for an activation of a particular value for the entity at a given state. The simulation system that operates against the schema from FIG. 11 for every entity instance value generates the VS utilized in a problem.
2. Let PTO be a prediction transform operator defined as a function that receives parameters from a problem P, an entity-instance attribute-value sequence (PVS) to predict. The PVS is the last value of the prediction for this operator for the target VS (TVS) and a source entity-instance-attribute-value sequence (SVS) to use as a source. Let the output of the PTO be a value sequence and let each instantiation operate upon the prior value of the PVS.
3. Let PTO reference only the information passed to it by the problem definition, that is, source instances containing entity-attribute-value sequences for earlier instances of the problem. Require that PTO record all sources and targets utilized to derive a VS.
4. Let the application of each PTO result in a new step to be accomplished in the same way as any problem simulation and the combination of values based on the selection of values be captured as another value sequence.

### Assertions Based on the Postulates

1. The higher order problem is representable in the same problem schema that represented the lower level problem without loss of any fidelity since it uses the same entities as those of the lower order problem. The prediction operator belongs to a type of expression operator, but the particular operator selection materializes as an attribute value in a standard entity-attribute structure. This allows for the correlation of one operator sequence from one solving instance to operator sequences from another solving instance enabling creation of a transformation problem for detecting a higher-order sequence for transforming the lower level instances.
2. The higher order solution requires the same solving approach as the lower level instance meaning the process is recursive and allows continually higher-order use of the same techniques that the system found successful in pursuit of a lower order problem.

### Transformative Property of a Problem Solution

Based on the preceding, there is a transformation available to generate a higher order problem from any lower order problem. This includes generating higher order problems from the lower-level higher order problems without limit. This means that the problem solver is able to use simulation to optimize the solution discovery phase for not only a base problem but also for the process of optimizing solution discovery. Scaling of this recursive model to higher and higher levels is only limited by the processing power of the hosting computers or set of computers. The transformative property concerns the transposition for utilizing the known solution states of a problem and transforming this to a higher order problem with the goal of testing the prediction operator's success at predicting the outcome based on prior instances. If the transformation process works for a lower order problem using the same simulation model for solution discovery then it must also be transformative to a higher order problem. This section provides proof that the second-order transformative problem is identical to the third-order problem and all higher order problems. The proof accomplishes this outcome by pivoting of the problem upon the steps involved for finding the optimal application of prediction operators against combinations of input sequences over a sequence of application. This application generates sequences for each higher and higher order problem that follow the same simulation model and use the exact same schema definition. From this:
The information about the solution path for each instance thus presents as a higher order problem with the goal of learning from the solution pattern for prior instances in order to predict the solution pattern to apply to additional instances. The higher order problem for any lower order problem incorporates the entity/attribute structure representing information about the problem instance and adds the following for each entity instance (defined by instance-identifier, instance-step, entity-key, and entity-attribute):
   Entity-Instance-Prediction
      Predicted Instance-Entity-Attribute
      Predicted Value
      Instance-Step
      Prediction Operator from the domain of possible predictors
   Entity-Instance-Prediction-Sources
      Source Instance-Entity-Identifier-Attribute from the domain of all instances earlier than the targeted instance.
      Source-Step from the domain of steps
   Predictor-Operator-Query-Addition—Incorporates additional filtering to reduce the size of possible solutions
   Predictor-Operator-Expression-Additions—Additional expressions to support the updated query.
The above then provides for a higher order simulation that generates branches for each prediction-operator and the combinations of source instances associated with source steps. The predictor operator itself is an entity-attribute and generates a value sequence. The goal of the higher order problem then becomes selecting from the same set of prediction operators from the lower order problem that accurately predict the value sequences that reflect the optimal sequencing of the prediction operators against the source instances.
The solution goal for the higher order problem is to identify the prediction (transformation) operator that most effectively predicted the values. This is modeled as a goal of the higher order problem in terms of the following query constructs:
   Find the sequence of prediction operators that generated the query additions that filtered the solution path and resulted in the fewest steps to achieve the goal state of the underlying problem.
   Map this sequence of prediction operators as the higher level goal for the higher order problem such that prediction of lower instances derive by the solution sequence of the higher order problem. Once again, the selected sequence of prediction operators that resulted in the selection of the lower order prediction operators can generate the correct solution path.

Based on this, the following steps emerge for an example embodiment of problem resolution:
1. Identify a problem P that has multiple instances each increasing in size, such as the Tower of Hanoi with more and more discs added.
2. Represent the overall problem using relational algebra to define unique entities with their attributes that define the problem.
3. Define expressional functions to return possible domains of values including aggregates and queries that follow a relational model that joins the expressions and filters the results with Boolean and/or conjunctions to represent the valid states for entities/attributes which create an instance, define the valid transitions, and attain a goal state.
4. Solve the instances of increasing size in order using a generic simulator. Generate a relational state sequence corresponding to each attribute within the problem instance and all possible values and the sequence at the activated value.
5. Within each simulation instance, generate instances of a prediction problem based on the same schema as that for the base problem. Reference as entities the state sequences from within the instances and transform operators for application of each state sequence to predict future values of the state sequence. For example, given Hanoi simulation instance S1 2000 with two discs, select operators for each branch of the instance in a prediction problem that predicts the next value in the state sequence for each state sequence change within the instance. Allow the prediction operators (also known as transform operators) to be visible not only to the sequences associated with the current instance but also to the sequences from prior solved instances. This means that while framework solves simulation instance S2 2002 with three discs, the prediction operators can reference solved sequences from S1 2000 and apply the prediction operators against the earlier sequence to generate the expected sequence values for S2 2002. Allow each subsequent instance to reference the solved sequences of the prediction problem associated with each instance. Further, allow prediction operators that may generate portions or the entire section of the state sequences rather than just one value at a time. Set the goal for each of these prediction instances to generate the solution instance in the fewest number of steps.
6. Once there are two solved instances of the first-order prediction problem, generate a prediction problem that references the lower-level prediction problem-state sequences as entities in the same way as process five above. Continue to generate more high-level prediction problems while creating the lower-level generation instances. Expand the scope of the higher level prediction to include instances from other problems since at this point the focus is on improving the higher order solution selection process.
7. Continue processes five through seven with higher and higher transformations until reaching a point of diminishing returns in terms of effort and success that represents an equilibrium problem. This equilibrium problem can also be defined to the system using the same method that any other problem is presented to the framework.

### Sample Embodiment for Problem State Representation

The present invention does not require any particular underlying database or schema as long as a the schema and data are queryable such that a data set in the format of entity name, entity key, attribute name, attribute value, and grouping level can be returned to fill out the values for the various states. The grouping level identifies the case where multiple attribute values are to be set on the same sequence or whether each represents a distinct case. In the sample case of the Tower of Hanoi, this is not applicable, but other problems may require the grouping functionality. For example, a chess game simulation may utilize castling that involves 2 object state changes at the same time. Another of many examples addressable by UPRF may be MMO scenarios where multiple players perform simultaneous actions.

FIGS. 2-11 provide a walkthrough of how a relational set may be returned based on a schema, data values, and functions. This is provided as a preferred embodiment, but is not a requirement for the present invention. In FIG. 2, 200 is simply the problem. A problem has an initial state 202, which is defined by queries that generate the starting point for one or more instances. The initial state can be thought of in terms of plurality leading to multiple initial states and is based on queries derived from functions. For example, in Hanoi, if the discs were varied from two to three, there would be two initial states generated—one with disc count equal to 2 and one with disc count equal to 3. This query would return the values between two and three. In the zero-subset embodiment, an example is a number of integers, for example, between 1 or 2 and four numbers between −2 and +2. In that case, the initial states would be all the different instances of this problem that would meet the criteria defined by this query. Thus, there could be between two and four distinct numbers, an example being −2, 0, 1, 2. Whatever the combinations are, these would be the initial states 202 for the instances. The initial state 202 aspect of the problem defines all of the starting states before beginning problem solution. On 204, the transition state is defined by the query that generates states after the initial state 202. If given a disc equal to 2 in the initial state, the initial state 202 would assign a disc with the value of 1 and a disc with the value of 2. The initial state 202 would specify a peg equal to 1 for all discs. The combined values from this data set define the initial state 202. Although the embodiments and examples discussed herein deal with an input problem goal state that is set by a user due to the probabalistic nature of the problems discussed, because the goal state is determined by a query based on functions provided by the definer of the problem, the goal state of the input problem could be dynamic and therefore changeable during the course of processing from queries that generate the states since these queries have visibility into the overall problem state including the composite of all initial states, transition states, and goal states executed.

The transition state 204 defines how the system can move to the next state, after the initial state 202, for the rest of the problem. The transition state 204 is context aware concerning the problem and the Queries are defined in terms of what has been accomplished in the problem, as well as in the initial state. From the two-disc initial state mentioned in the last paragraph, the transition state 204 provides some rules for what can be done to these discs next. For the Tower of Hanoi example, one rule is that only the topmost disc can be moved. This means that the transition state 204 would only define disc 1 for selection on the second move. After that first transition, the rules will change. The main goal of the transition state query is to not only define how to move from the initial state to the first possible transition, but also how to perform all subsequent transitions that ultimately lead to reaching a goal state 206. As is true with initial states, transition states are driven by queries based on expressions that utilize user-defined functions to project candidate values. As such the transition states are dynamic and therefore changeable during the course of processing from queries that generate the states since these queries have visibility into the overall problem state including the composite of all initial states, transition states, and goal states executed.

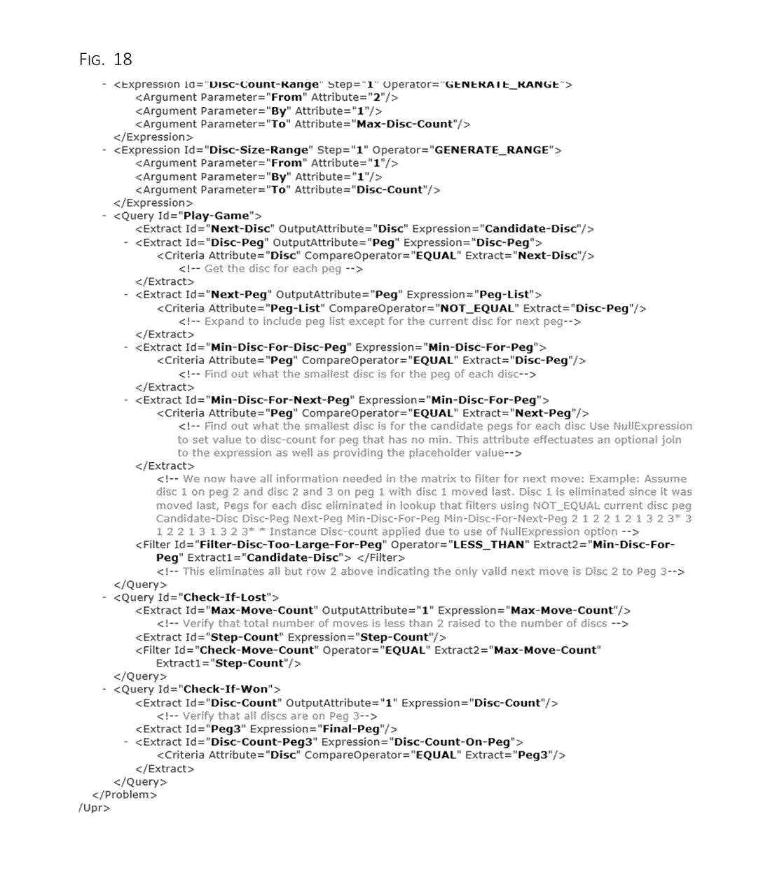

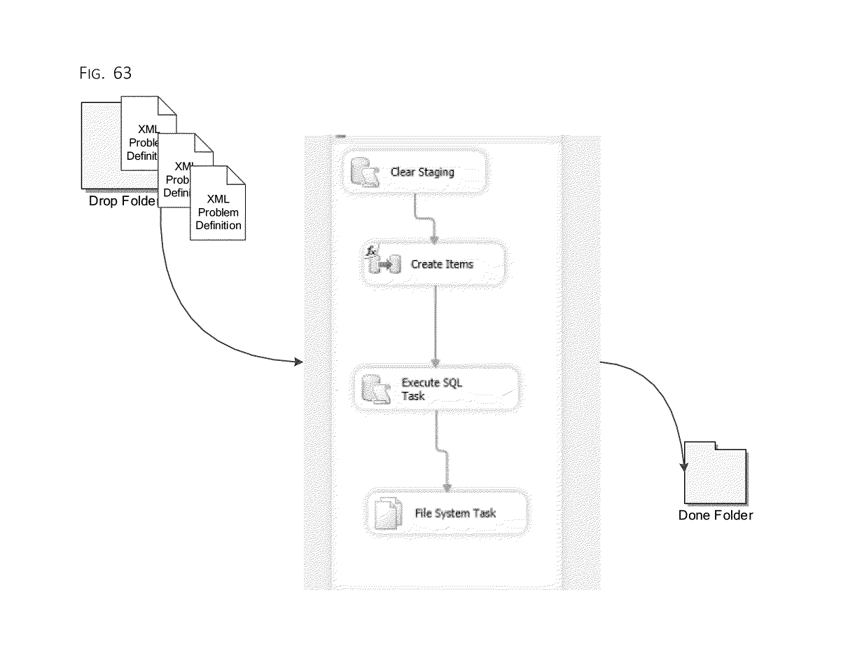

The goal state 206 defines the criteria for establishing that the solution has been met. For Hanoi, this would be that all discs are on peg 3. In the schema for the problem, a rule needs to be established that requires the peg be equal to 3 for all discs. This can be expressed through the schema language, an embodiment identified as the Universal Problem Definition Language (UPDL), which is a facility the invention can utilize to facilitate loading XML-based problem schemas (FIG. 63) but which is not required. UPDL (FIGS. 17 and 18) provides an example for how to define the goal state 206. Once this is defined, the system can check to see if the goal state 206 has been met. This is known as a goal state, but there is also an optional state known as a fail state 208. The fail state 208 indicates the system has gotten to a point where success is impossible. This would be represented by criteria that eliminate the instance from being further solved due to reasons including but not limited to a shortage of resources, no successful possibilities returnable from the next transition state 204, or reaching some conditional threshold that indicates a failure state 208. As is true with initial states and transition states, goals states are driven by queries based on expressions that utilize user-defined functions to project candidate values. As such the goal states are dynamic and therefore changeable during the course of processing from queries that generate the states since these queries have visibility into the overall problem state including the composite of all initial states, transition states, and goal states. One example may be the result of an equilibrium problem that forces a constraint upon the simulation based on diminishing returns, which may be associated with resource limitations or other factors.

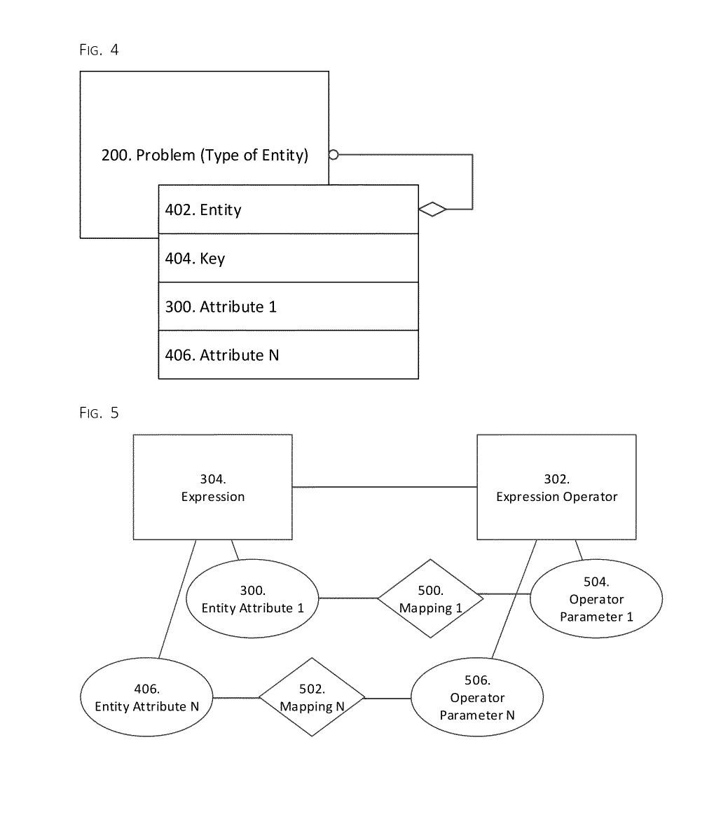

In FIG. 3, the expression 304 is defined. An expression 304 will contain an attribute 300, an expression operator 302, and can optionally reference another expression 310 utilizing constants 306 and/or attributes 308. The lowest level expressions cannot reference other expressions. In those cases, the attribute is defined either by a constant 306 or in terms of another attribute 308. This convention allows the expressions to evolve continually in complexity. For example, if there is a starting expression that indicates that start peg equals 1 and maximum peg equals 3, another expression can be defined. Each expression 304 can have multiple arguments associated with it. The expression 304 combines attributes together in order to define a function. For example, this function could return 1, 2, and 3. An expression 304 is defined here with the possible peg values and another expression 310 might be defined that indicates the peg uses the Peg-Range Expression for the next move. This way the next move will return back the Peg-Range Expression and an attribute 308 could be specified that references a disc equal to 1 and could have these values associated with it. Once there is an expression 304 that returns these values, this can be taken and used in another expression 310. Another expression may be to find the minimum peg value. For example, an expression might use another expression for extracting the minimum disc value and comparing it to another expression containing the last used disc value. In this case, the expression operator 302 was the range and the operation could be the minimum. The minimum disc could be taken for the peg range and would be returned back for each peg. If peg 1 is specified as the input peg, it may turn out that disc 1 is the minimum. For each different peg, the minimum value associated with it would be returned. The return result of the expression is a relational set that includes metadata identifying the entity, attribute, grouping level, entity key, and attribute values that UPRF can interact with relationally. If this expression was to be used further in another context, the outputs of it are actually the input for the next expression.

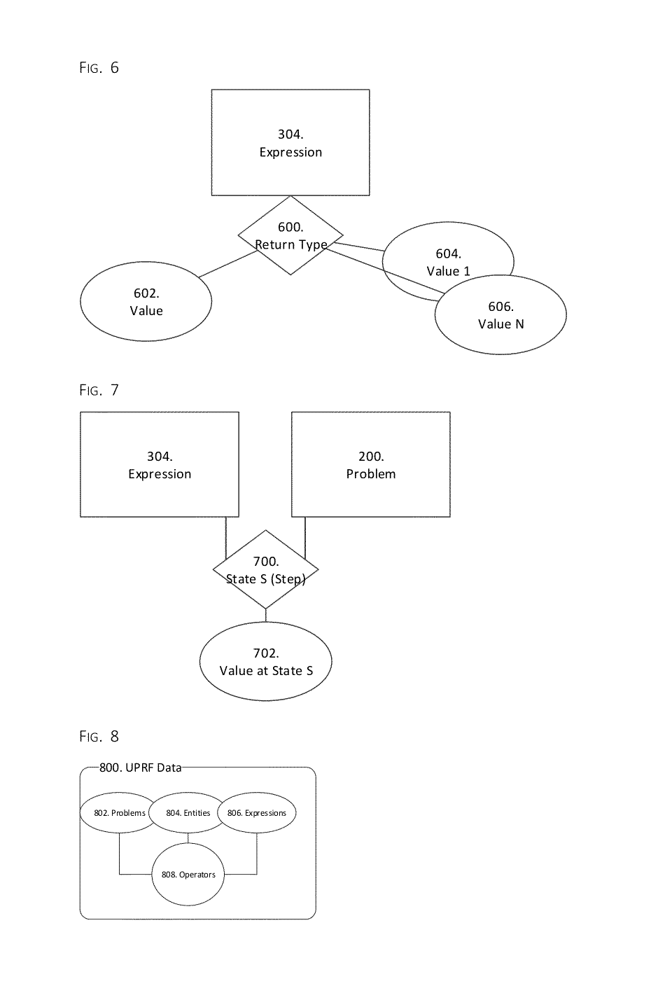

FIG. 4 defines the problem structure 200. All problems contain one or more entities 402, which have a distinct value key 404 and one or more attributes 300, 406 associated with them. In all problems, the problem itself is an entity with a value that defines each instance of the problem. For example, in the Hanoi problem, the problem instance is defined by the number of discs, which is stored as the instance problem key value. If the disc count were 2, this would be 2. In addition, the instance key value determines the initial entity configuration. Within Hanoi, there is the disc that has a key which is the size of the disc, associated with it and within that there is an attribute, which is the peg.

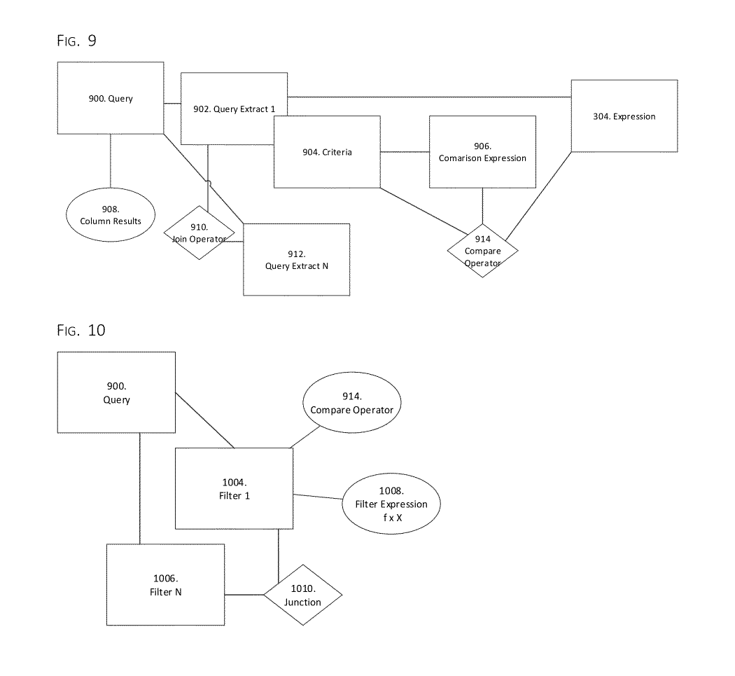

FIG. 5 addresses expression 304 with an entity attribute 300 and expression operators 302 and how they link to entity attributes 406 through mapping constructs 502. If there is a problem key (e.g., Hanoi), an entity E (e.g., the disc), and an attribute A (e.g., the peg), then these all are related together to expression operators 302 through an expression 304 that does a mapping 502 through an expression operator 302 that defines a list of parameters 504, 506. For instance, if there is an expression operator to find the minimum within a set, then there is a parameter 504, 506 associated with the set S and the minimum. An expression operator 302 may define a set of parameters 5045, 506 that are then mapped to actual problems—to the entities and attributes of the actual problem or to some sort of constant that is defined by an attribute. Thus, the expression 304 can be executed against the actual problem data.

FIG. 6 refers to an expression 304 and the return types 600. For each expression, a return type is defined. The return type is defined in terms of what will actually come back from the Expression. For instance, the return type as shown by 604 and 606 may be a set of values or a specific value or a single value 602. The return type could be multiple values in a single column, it could be multiple values in multiple columns, or it could be single values in a single column. These are all the possible return types that may be returned from an expression.

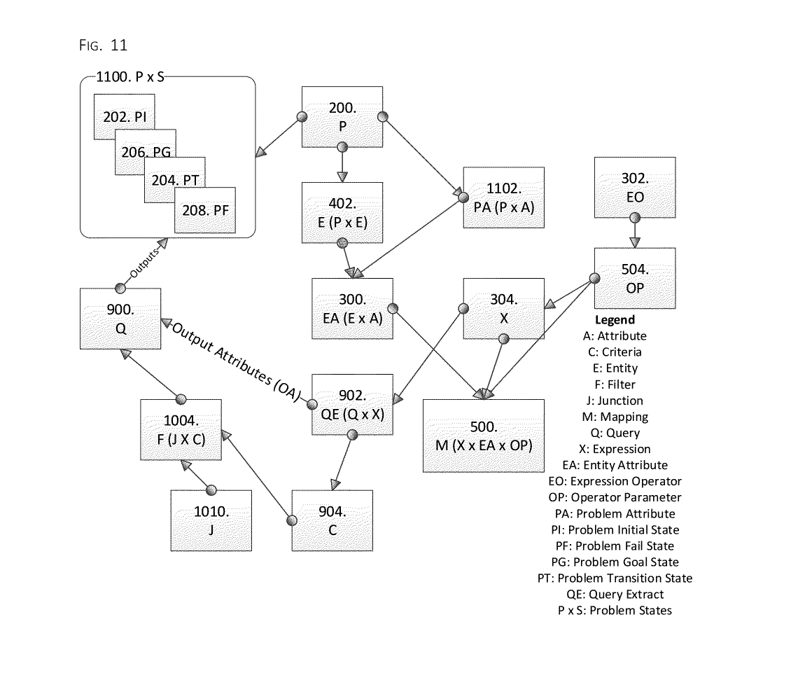

FIG. 7 shows an expression 304 and how the expression links to the problem 200. This allows more than one expression to be utilized to generate a state associated to a particular step 700 as part of solution exploration. That state step value 700 then may be based on an expression 304 or a specific value 702.

FIG. 8 illustrates the relationships 800 between problems 802, entities 804, and expressions 806 and shows that they are all interrelated through expression operators 808. An expression operator may operate against a problem 200 or against an entity 402, which could include attributes 300, 406 or against an expression 304. Operator 808 may be of various types including expressional 302, comparison 914, join 910 and junction 1010.

FIG. 9 illustrates design for the query 900. A query uses expressions 304 and comparison expressions 906 that have comparison operators 914 that evaluate criteria 904 and that link to query extract 902, 912 which are consolidated into the query 900. FIG. 10 illustrates how one or more filters 1004, 1006 can be applied to a query using a filter expression 1008 with a compare operator 914 to further reduce rows and columns associated to a query 900. For example in the Tower of Hanoi, a peg range function and the key may be used to look up the disc-peg meeting the criteria of the comparison expression. Based on that, an expression 304 is returned for the minimum disc for each peg as the key value. Another example is that, given the second move and the smallest disc on the second peg, then either the 1 disc or 2 disc meets the criteria for the smallest disc on the peg. The value for peg 3 in this example is null because there is no disc on peg 3 yet. The query extract 902,912, in association with the comparison expression 906, provides a way to add another expression 304. This expression could be the last entity used that operates against the operator, and the attribute would be the entity disc in this example. Then, on the second move where the last disc moved was number 1, this would return back 1 as the column results 908. A subsequent comparison expression 906 could check to see that number 1 was not used in the operation.

FIG. 10 shows a filter 1008 arising from a comparison operator 1002 affecting another expression known as a filter 1004, 1006. Filters can be joined together such that, when one expression results in filtering another expression 1008, there can be another set of expressions. For instance, on the second move disc number 1 cannot be moved because of the filter that checks to see that the last disc used is not referenced twice in a row. Now the system needs to look for the possible pegs where each disc can go. This results in another function that may ask in the Tower of Hanoi example, “What is the minimum disc for a peg not equal current?” If this is move number 2 and there is one peg 1, the system knows it cannot move to peg 1, it can only move to peg 2 or 3. Using the peg range as the domain and the qualifier for this expression, only pegs 2 and 3 for disc 2 are available. That is, the only possible moves for the next move are to pegs 2 and 3. That is not adequate information, however, because there is another rule requiring that the disc not be larger than the disc already on the peg. In order to comply with this, a junction 1010 joins the filters (1004, 1006) so that another comparison operator 1002 checks the minimum disc on the peg again as a filter expression 1008 and applies that to the disc from the query 900. It is then evident that the only peg that can be used is peg 3 because peg 2 is occupied by a smaller disc.

FIG. 11 shows the relationship between the components outlined in FIGS. 2-11. Element 1100 constitutes problem instantiation, goal, transition, and failure states (202, 204, 206, and 208) for exploring solutions to an instance of a problem 202. Element 1004 combines junction 1010 with conditions 904 in order to affect the output of the query 900 based on the underlying query expressions 902. Element 500 is the mapping of the expressions 304 to entity attributes 300, and operator parameter 504. When a problem is defined in Element 200, it generates a definition for the problem states. The problem 200 itself may have associated attributes 1102. Entity 402 maps to the problem 200. The expression operators shown in 302 utilize operator parameters in 504 and map to expressions in 304. Those expressions are built out using mapping that maps the expressions with the entity attributes 300 and the operators 302 in order to form the query expressions in 902. The query extracts in 902 then have conditions 904 applied to them through a filter 1004 that combines the conditions with the junction 1010 (a “junction” being “AND” or “OR” or some kind logical conjunction that ultimately satisfies the state query in 900 for 1100).

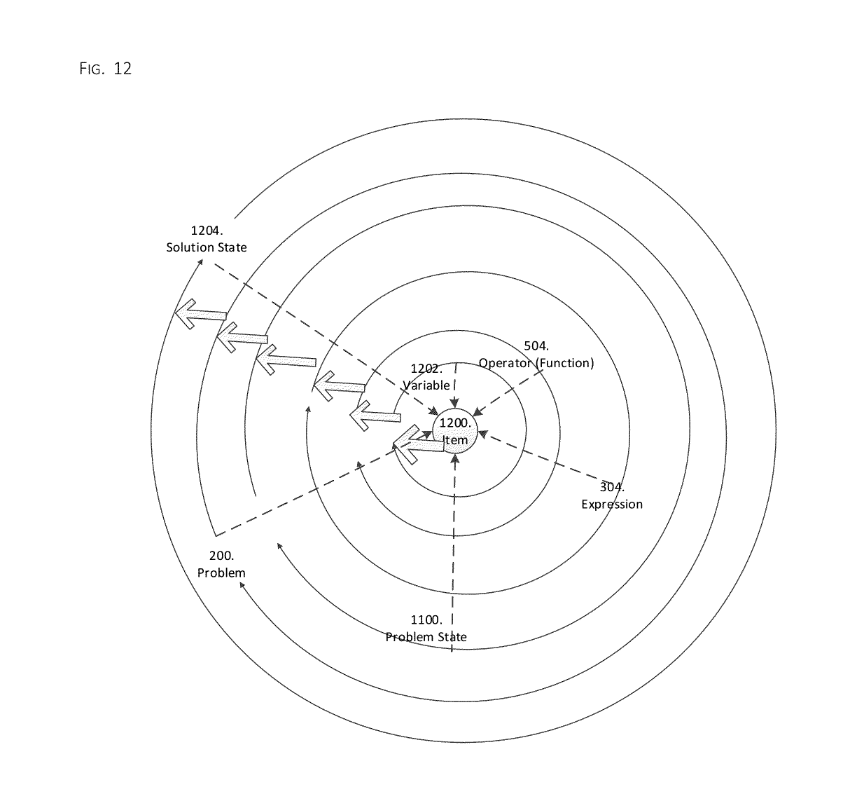

FIG. 12 is shows how the data evolves to the solution state from the initial definition. Data units known as items 1200 represent the lowest level of information and manifest as variables 1202 that are manipulated by operators 504 that yield expressions 304 which lead to problem states 1100. Problems 200 are constituted in terms of these problem states 1100 which are explored to realize solution states 1204. This allows the system to generate problem states based on the expression until the solution state is realized or some threshold is exceeded based on some predefined resource constraints.

### System Execution Architecture

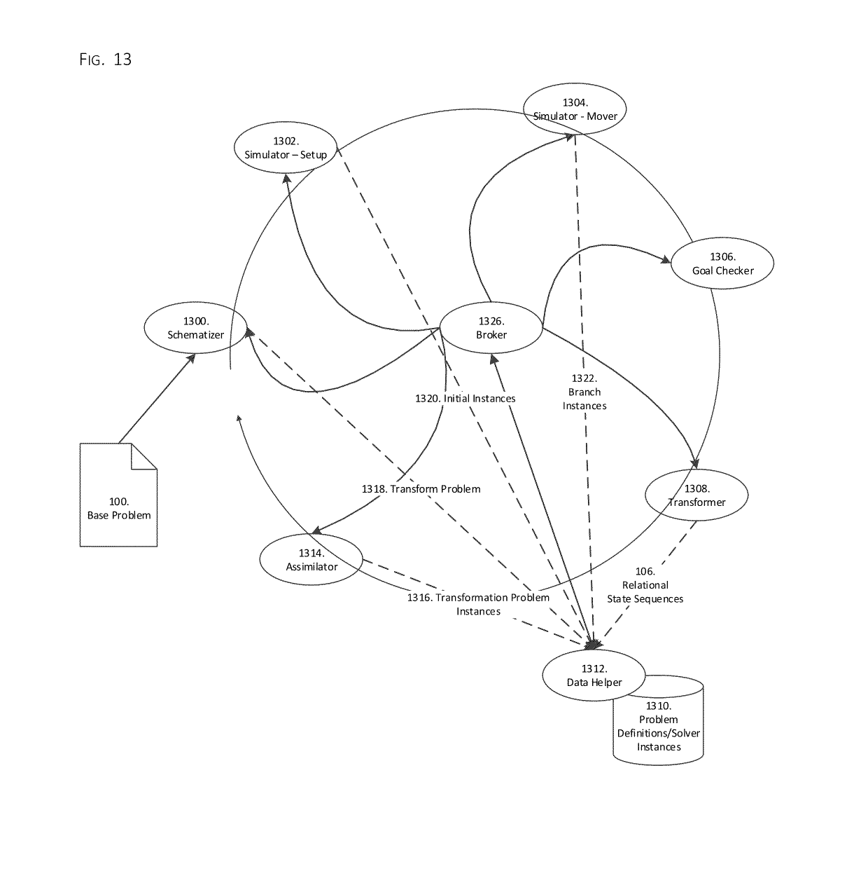

FIG. 13 provides the preferred embodiment for a system of agents to implement functionality described herein. Each agent is depicted as an elliptical shape in the diagram. The Schematizer 1300 receives a problem definition for a base problem 100 and interfaces with a Data Helper agent 1312 to store the definition in a database 1310. The Schematizer 1300 may receive the problem definition in various ways including directly from the Problem Database 1310 via the 1312 Data Helper and in another embodiment (FIG. 63) using an XML-based Universal Problem Definition Language (UPDL) file. Simulator setup 1302 creates the initial instances 1320 along with the related entities and their attribute values. The simulator mover 1304 explores solution paths and interfaces with the Data Helper 1312 to access problem instances updating and creating branch instances 1322 based on the states encountered with the problem instances. As problem instances resolve to transition states, a Goal Checker agent 1306 checks to see if new states represented by the different entity and attribute values constitute meeting a target state outlined in FIG. 11 including a goal state 206 or failure state 208. A Transformer agent 1308 examines states sequences constructed by the problem instance solving steps from 1304 to project Relational State Sequences 106. The Transformer agent inspects each attribute, all the possible values, and what values occurred on all steps to consolidate these into the sequences. The Assimilator agent 1314 generates new Transformation Problem Instances 1316 using a Transform Problem definition 1318 which accommodates any level of the Transform Problem 108, 116, 124. Transformation Problem Instances 1316 are schematized in 1300, setup in 1302 and proceed through the cycle recursively following the same approach as the base problem 100. The Broker agent 1326 examines problem instances in the manner depicted in FIG. 15 to dispatch tasks to the appropriate agents. This architecture utilizes a task-oriented approach whereby tasks related to problem solving instances are distributable to multiple instances of the agents. The tasking mechanism is explained in more detail in the discussion of FIG. 15.

### Instantiation Creation and Branching Via Overflow

FIG. 14 illustrates the concept of overflow at various levels in problem instance creation and branching utilized for simulative problem solving to explore possible solutions. Value overflow in problem initialization or encountered in transition steps generate or branch new problem solving instances. Starting with a Root Problem 200, Problem Instance Generation 1402 occurs to create one or more initial instances 1404 and 1406 based on a Problem State Overflow 1400 condition that results from multiple values for one or more variables associated with an initial problem state 202. Each of these problem instances instantiate entities and attributes 300, 406 contained within their respective instance spaces 1410 and 1412 as a result of Entity State Overflow 1408 caused by more than one value assigned to the problem instance entities. As each solver instance is pursued in 1414 and 1418 in parallel, Attribute Value Overflow 1416 may occur in the transition state 204 associated to the base problem. The figure illustrates an example that results in new solving branches such as 1420 and 1422 which constitute new problem instances to support the different value selections. Attribute Overflow 1416 may occur throughout the duration of the solution exploration resulting in further branching of 1424 on additional steps to instances 1428, 1430, and 1432 along with a parallel branched instance 1426 stemming from 1422. In the Hanoi example, the number of discs is the problem instance key value, which is overflowed for the various disc counts to solve and generates multiple initial instances following the manner of 1400. In addition, within each problem instance, there are multiple entity instances that result in the 1408 overflow condition. As solutions are explored in the Hanoi example embodiment, different moves manifest as different attribute values such as a first move of the first disc to peg one or to peg 3 for various instances which then constitutes the Attribute Overflow condition 1416.

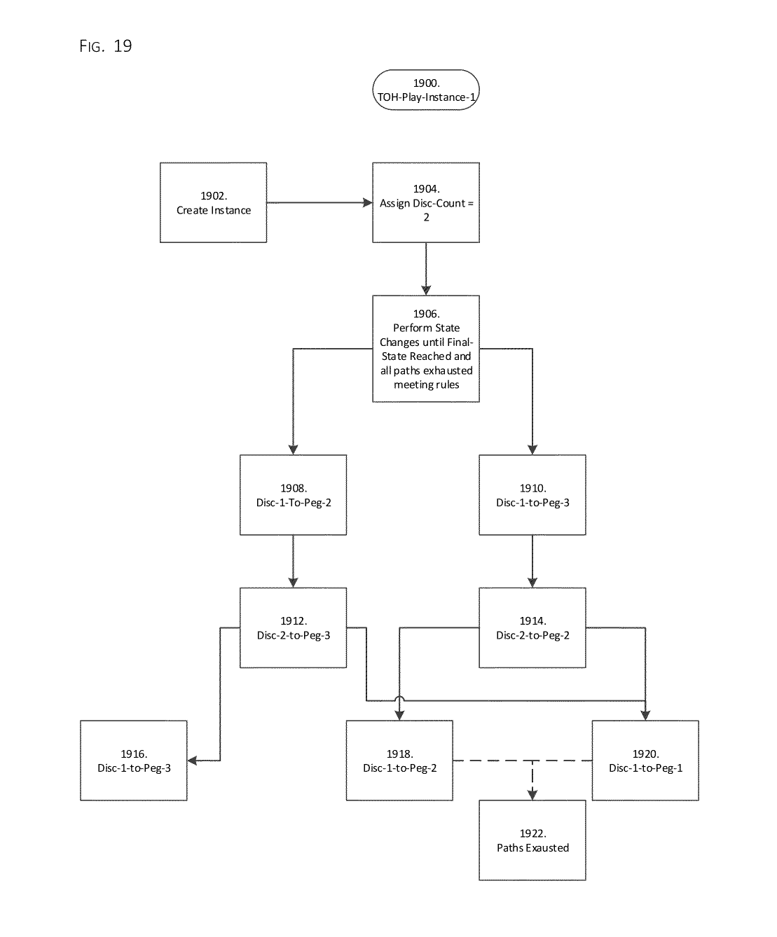

FIG. 19 illustrates the overflow principle utilized for simulation from FIG. 14 for seeking the solution path for the Tower of Hanoi example embodiment starting at 1900. The Tower of Hanoi instance 1902 generates two different initial instances 1908, 1910 in this example as it proceeds through the solving process 1906. One instance is based on moving disc one to peg two in 1908 and the other is based on moving disc one to peg three in 1910. These are based on the Attribute Overflow concept 1416. In 1912, after the first move, there are different choices that can be selected for both of the two initial instances—one would be move 1912 to move disc two to peg three for 1908 instance and the other move 1914 to move disc two to peg two for instance 1914. After these initial moves, multiple choices present once again that represent the Attribute Overflow concept shown in choices 1916, 1918, and 1920. In addition, instances may collide with prior instances meeting the same set of combinations at a certain point. At some point, all paths are exhausted in 1922 leading to a failure state for the instance unless the goal state is realized first.

### Task Processing Mechanism

FIG. 15 illustrates the various states that occur when resolving problem instances and the actions required based on the states. These states determine which agents execute against a problem instance at any given time. For example, if the problem is in an undefined state, then the setup agent operates on the problem to generate problem instances. As each agent completes its work for the problem or problem instance, the problem/instance state is updated so that the appropriate agent can then operate against the problem/instance. For example, once the problem instances are generated, the simulator can then endeavor to discover the solution state. Tasking is based on the status of each specific problem instance which allows such processing to be distributed to the agents described in FIG. 13 in a parallel and distributed fashion that is scalable across one or more processors or computers.

### Extensible Transformation Operator Library

The library for transformation operators utilized to solve the higher order transformation problems that emerge is a standard function hosting system attuned to the operational platform for UPRF whereby developers facilitate problem solving by contributing algorithms that work within functions executable by UPRF. Such functions can be registered for use against any problem or target a specific problem domain and is explained in more detail throughout the progression of the Hanoi example. UPRF does not inherently provide functions to perform transformations but rather a framework to host functions that may include machine learning algorithms and pattern recognitions oriented to the operational environment in which UPRF executes. UPRF provides the same simulation problem solving approach for finding the learning operations as that for playing out a simulation through brute force. The framework also ensures that each algorithm executes with traceability back to the parameters used by the algorithm to make the prediction. This way the execution of all algorithms is tracked within a measurement framework so that the operation of the algorithms themselves make themselves visible for higher-order transformation. This provides the potential to analyze algorithms for correlation to rank the selection processes which the process thereof continually improves as the system solves more problems. The framework can register any function that may include any logic supported by the operating platform including a machine learning framework. The function is registered for use as a transform operator within the framework. The framework records all information related to the function's invocation including its parameters and the specific problem instance targeted over the sequence of steps involved in the overall problem solving instance. This provides a complete state sequence for the transformation operator usage in the problem solving context. The Hanoi example embodiment provides example operators such as the Insert-Bit 3100, Copy-Segment 3102, and Binary-Expand 3104.

### State Output Resolution

FIG. 16 provides an example of how states 1100 may be resolved using a state generation mechanism that follows the sample pattern of FIGS. 2-11. FIG. 16 represents a sample embodiment and not a requirement of the invention to function. So long as datasets that meet the criteria to project states relevant to UPRF can be associated to an interface, the mechanism whereby those results are returned is not a critical aspect of the invention. The example is the preferred embodiment since it supports task-oriented processing outlined in FIG. 15 and distribution to agents for ensuring maximum scalability. The diagram flows from left to right for the major processes and top to bottom for the underlying processes. Each circular-shaped object (1100, 900, 1602, 1004, 1614, 1010, 1624, 1618, 1008, 1636, 304, 302, 1624, 300, 1646, 1652) represents the system objects that require resolution through processing steps depicted in the square-shaped objects (1600, 1606, 1608, 1610, 1612, 1616, 1620, 1622, 1626, 1628, 1630, 1638, 1640, 1644, 1650, 1654). Decision points are represented as diamond-shaped objects (1604, 1632, 1634, 1642, 1648) where different paths may be chosen depending on the outcome of the prior steps. Each object may have multiple instances.

For example, for state 1100, queries must be enumerated 1606 which then yield the associated query objects 900. For each query object, a state output specifier 1602 defines the extraction state output, which merges with extraction state output values emanating out of underlying query value generation 1624-1652 also associated with the state 1100. Extraction state output 1622 contains the extracted state outputs resulting from the application of the specification 1602 onto the attribute value list 1652. The attribute value list 1652 is the result of the application of the query expressions upon the values associated with the current problem instance state 1100. The state result list 1636 is finalized upon completion of all the associated expression results generated from execution of the underlying queries with their associated filtered expressions 1008. The associated filtered expressions utilize junctions and conditions to refine the outputs coming into the final state result list 1636.

In the Hanoi example embodiment, the state 1100 would be the current configuration of discs with peg values; the queries 900 would constitute the expressions 304 for generating the next set of possible states; and the state output specifier 1622 would be the candidate discs with associated candidate peg values valid for the next state. Filtered expressions 1008 operate within this process to ensure outputs adhere to the constraints defined by the query expressions valid for the Hanoi problem. The results for each state enumeration are outputs consisting of the next set of disc/peg combinations for the next solution step in the problem instance. This results in the updating of the current state 1100 for an instance as well as generation of a new state 1100 based on the overflow principle (FIG. 14).

FIGS. 17 and 18 illustrate a Universal Problem Definition Language (UPDL) by which a problem, its entity attributes, and expressions, along with resulting states can be defined. In the Tower of Hanoi example embodiment shown, the range of problem instances is defined in terms of a minimum and maximum number of discs. The disc count associated with each problem instance is the output field from the disc count range expression. The data entity is then derived from the disc size, which is computed from the disc size range expression. The disc size range expression utilizes the overflow principle (FIG. 14) to generate the necessary disc entities associated to each instance. For example, if the disc count of an instance is 4, then 4 disc entities are generated for that instance. The query for playing the game is based on extracting the values from the underlying queries. In this case, it extracts from the candidate discs and the disc peg and then uses a comparison operator, ultimately ending up returning the values using a filter that can be utilized for the simulation to define the candidate states. There are also queries to check if the failure state has been reached (for example, because of too many steps in the sequence) or if the success state is met reaching the goal criteria.

Example for Tower of Hanoi Simulation with Equilibrium Via Sequence Reversal

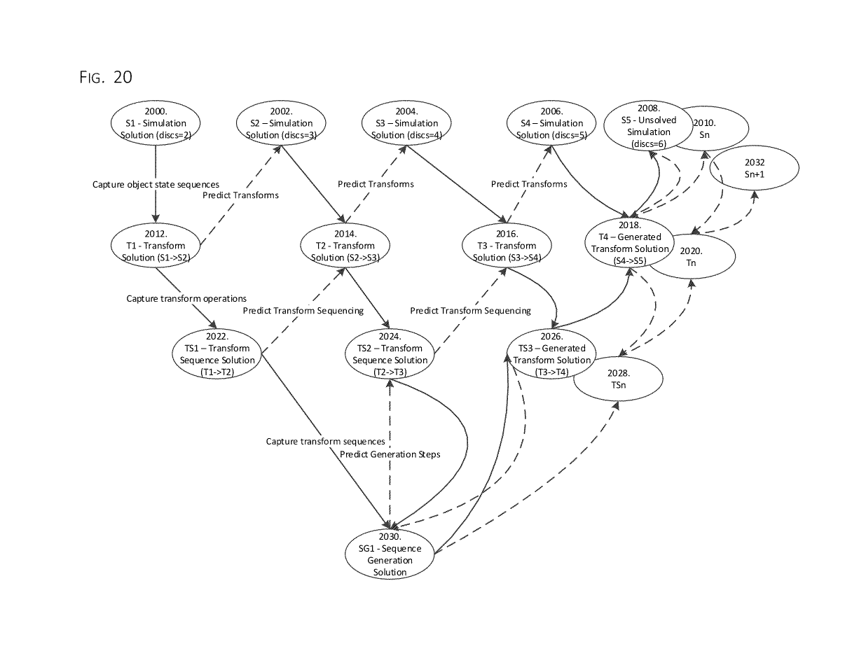

FIG. 20 depicts a simulation process for the Hanoi example. In each simulation, the results are recorded that track the transformations that become data for the higher order problem. The lower order problems are in 2000, 2002, 2004, and 2006. These all evolve to solve the problem, by brute force, determining the pattern for the number of discs. In 2012, there is a transformation problem that involves determining the problem for 2002 from the instance, i.e., looking at what needs to be done in order to predict 2002 from 2000. The transformation problem generates a higher order transformation problem instance (second order) 2022 when more than one first-order transformation problem instance is resolved. Another transformation problem is 2014 where the number of discs equals three and the number of discs equals four and the system predicts the operators that will transform the solution for number of discs equals three. This results in two different transform solutions, 2012 and 2014. These become the input for the higher order transformation problem 2022 where 2012 is used to predict 2014. This constitutes a transforming problem of the sequences themselves. While it is another transformation problem, it is also related to the sequence of operators that can be used to generate the sequence of operators that can be used to generate the initial instances. The sequences in 2012 and 2014 are concerned with operators that will generate the correct state flags for the sequence of each different value that is associated with each different attribute—e.g., what sequence discs one, two, or three move on. The higher-level transform is not associated to those problems, but rather the problem of the operators used to predict the lower level instances. The operators that are used to predict the lower-level instances could include tasks such as copying the sequence or injecting a one or zero in the sequence. Examining the sequence of operations that were performed in 2012 and 2014 becomes the transformation problem in 2022 to predict what operators are applied to select the actual operators. This continues iterating the sequences by application of sequence transformation operators for all of the different possibilities. Finally, there is even a higher order transformation problem SG1 2030, which is the problem of how to transform the operators that were used to transform the operators that generate at the base level solutions. At this point in the Tower of Hanoi example, an equilibrium point is reached that generates the reversal process. This equilibrium point allows the system to reverse back the sequences to determine the solution to other problems of different instances automatically through mapping rather than brute force simulation.

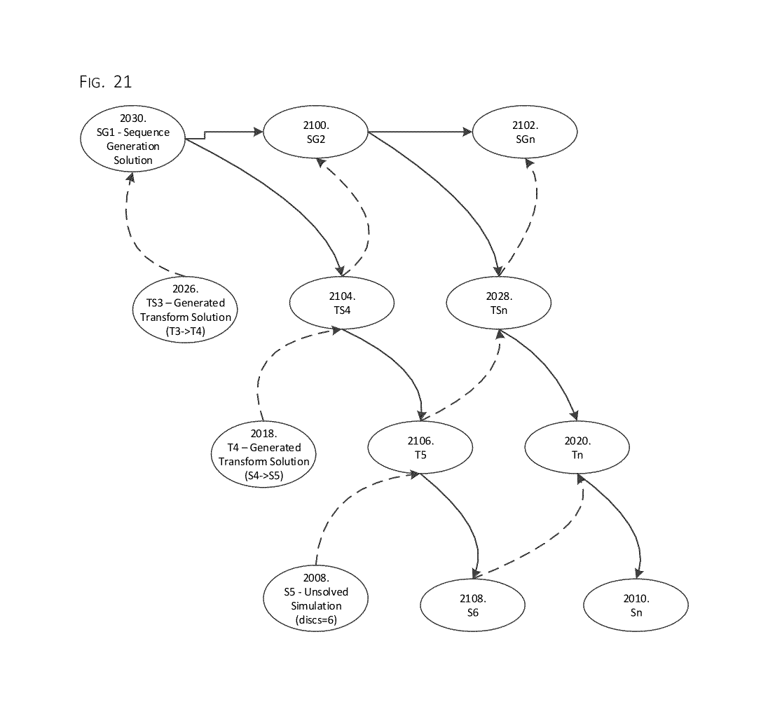

In FIG. 21, the process is then reversed such that sequence generation is able to generate the set of steps associated to a lower level problem. Thus, for example, the set of steps to predict the operators used by 2030 to solve 2026 from 2100 can be applied to solve the problem of 2104. Those then can be used to generate the transformation sequences to solve 2018 resulting in the output of 2106. The unsolved problem instance 2108 where the number of discs equals six can then be resolved through the transformations operators that are created by 2106. This same approach for the Hanoi example is relevant to any other embodiment of the system for solving other problems.

### Detailed Example for Tower of Hanoi Simulation and Transformation Processing Tower of Hanoi Schema Implementation and Operation

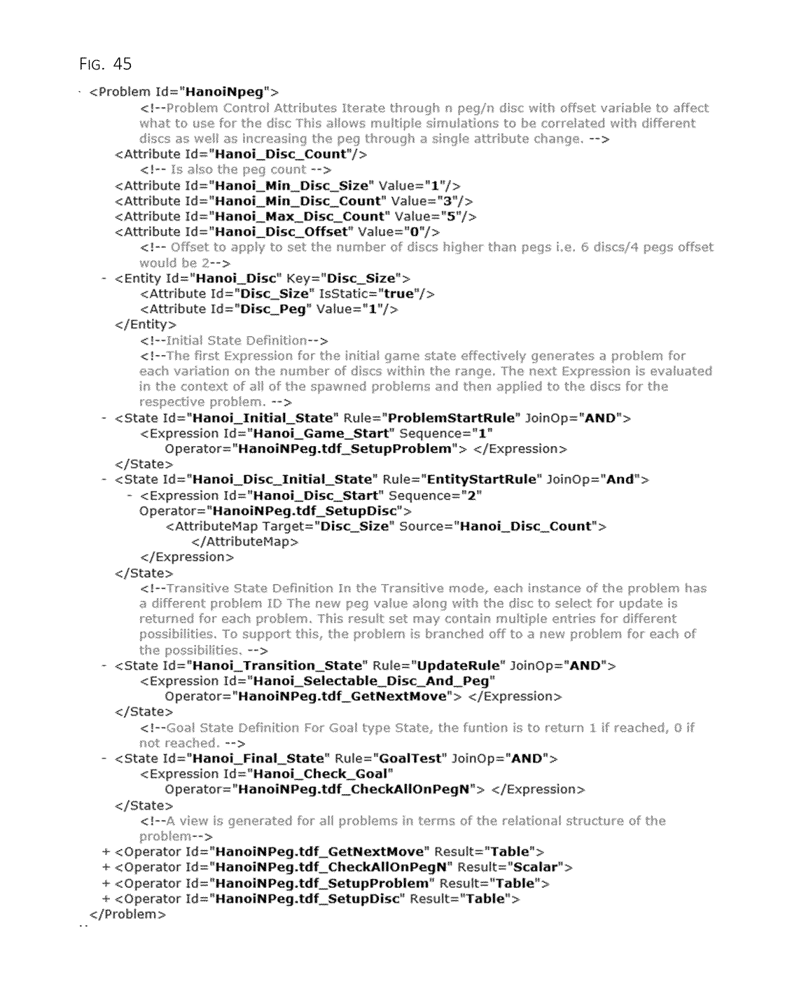

This section provides additional detail for the processing of the Tower of Hanoi example that expands upon the initial description of UPRF associated with FIG. 1. The Tower of Hanoi scenario is used as an example because it manifests attributes commonly associated with a decision-type problem. This is because it includes multiple instances that benefit from the same solution approach, it contains sequences of steps that represent both failure and success, the problem can be quickly solved when solving heuristics are applied, and it lends itself to simulation to discover patterns. These attributes do not need to be present for UPRF to function as any problem that can be represented by an initial state 202, goal state 206 and transition states 204 can be solved by the framework. However utilizing a problem with such attributes highlights the major functional aspects of UPRF. There are additional capabilities of UPRF including multi-agent problems and non-deterministic not demonstrated in the Tower of Hanoi example which are described in more detail in the discussion of FIGS. 45-62.

FIG. 17 discussed earlier represents the Tower of Hanoi problem using attributes to define the initial peg, goal peg, minimum number of discs for a simulation, maximum number of discs for a simulation. An entity 402 (DataEntity in the XML example) represents the disc identified by the size. The DeriveFrom method uniquely identifies each problem instance in terms of the number of discs for the instance. Each disc then has a peg attribute associated with it that varies from one to three (derived from the Peg-List ValueList definition). Although the Tower of Hanoi only requires a single entity and single attribute, a problem definition could have any number of entities with any number of attributes so long as each entity derives from a unique key.

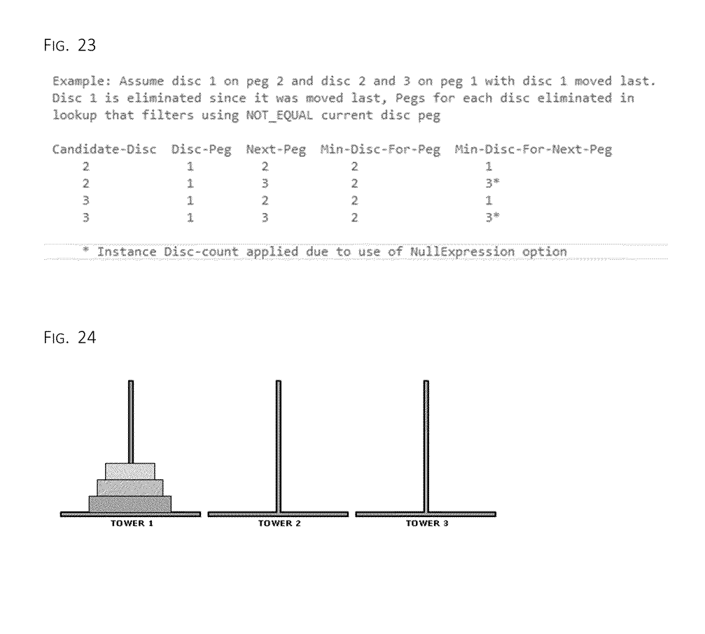

FIG. 18 shows the remainder of the problem definition based on an expression 304 that generates the size range from which the disc entity derives. The query “Play-Game” contains the extracts and filters needed to generate a result set for any particular configuration of a simulation. The query 900 filters the data as follows:
1. Query Extractions that include Extract next disc (Next-Disc) using the Candidate-Disc expression (defined in FIG. 18). The Candidate-Disc expression uses the function “SELECT_NONUSED” which selects any entity not selected on the prior state change. This adheres to the Hanoi rule not to move the same disc twice in a row. The selected disc is stored in the output attribute “Disc.”
2. Additional Query Extractions that include: Extract next peg (Next-Peg) using the expression “Peg-List” (defined in FIG. 17). Peg-List returns a list from one to three. This value is stored in the output attribute “Peg.”
3. Identify candidate pegs for a disc by filtering out the peg it is currently on in the “Next-Peg” extract. This extract based on a Query Extraction 902 utilizes the “Peg-List” expression based on an Expression object 304 and filters using a filter object 1004 with a comparison based on a Comparison Operator 904 of “NOT_EQUAL” to eliminate the current peg.
4. Additional Query Extractions that include: Extract the minimum disc for the peg (“Min-Disc-For-Disc-Peg”). This utilizes the expression “Min-Disc-For-Peg” which finds the smallest disc on a peg. A comparison operator 904 of “EQUAL” provides the filter 1004 for output from “Peg-List” results. This generates a result set identifying the minimum sized disc on each peg into a matrix. As each extract adds values to the query, intersection of prior values occurs based on the comparison operator 904 and join (junction) operator 1010. (The default join operator is an intersection or inner join, but supports all standard join types—see #10 under the Postulates.) FIG. 23 shows a sample result matrix.
5. Additional Query Extractions that include: Extract the minimum disc for the peg a second time, but this time utilize the “Next-Peg” as the criteria for filtering. This determines the minimum-sized disc on only the candidate pegs (not the current peg of the disc) which ultimately determines if it possible for the disc to be moved to the peg by the filter. Note that the Min-Disc-For-Peg includes a NullExpression construct that forces the value to the max-sized disc (Disc-Count) if no discs are on the peg.
6. As shown in the matrix in FIG. 23, this query provides a matrix with rows and columns, which allows further filtering.
7. The query expression extracts have at this point reduced the results to eliminate the following:

a. Exclude the peg that the disc is currently on in the Next-Peg column.

b. Exclude any disc that moved on the last move.
8. The result set still contains invalid moves without an additional filter to ensure that no larger disc moves on top of a smaller disc. The filter “Filter-Disc-Too-Large-For-Peg” eliminates any disc that is not less than the smallest disc on the candidate next peg with the empty peg condition. This ensures that the result for an empty peg returns a disc number higher than the highest due to the NullExpression construct thus permitting the peg to receive any disc.
9. Given the above, the Play-Query query based on the semantics of 900 provides only valid next moves for the simulator.
10. The final step is to define the queries that define if the simulation is in a lost or won state so that the simulation instance does not go on forever and to provide a goal for the simulator to pursue in the solution. This constitutes resolution of the example via a goal state 206 or failure state 208. The fail query (“Check-If-Lost”) verifies that the maximum number of state changes (moves) has been exceeded which is defined by the Max-Move-Count expression as the number two raised to the number of discs. For example in a three-disc scenario, the solution is achievable within seven moves, for a four-disc scenario, fifteen moves, etc. The goal stepis defined as “Check-If-Won”. Check-If-Won utilizes the expression ‘Disc-Count-On-Peg” to compare if the number of discs on a peg is equal to the Disc-Count associated to the problem for the peg equal to the value “Final-Peg” which has a value of three. In other words, the simulation is successful if the number of discs on peg three is equal to the total number of discs. The return value of “1” indicates to the simulator that the simulation can be marked as successful for the problem instance. At this point, there is no need for further simulation activity for the problem instance. Additional return values provide support for other problems that may have multiple solutions by allowing “2” as a return attribute. Return attribute “2” directs the simulator to mark a simulation instance as complete but to continue searching for additional solutions. For the Tower of Hanoi, there is only one optimal solution path for any configuration of discs, so the simulation stops for each instance as soon as it finds the solution.

### Methodology

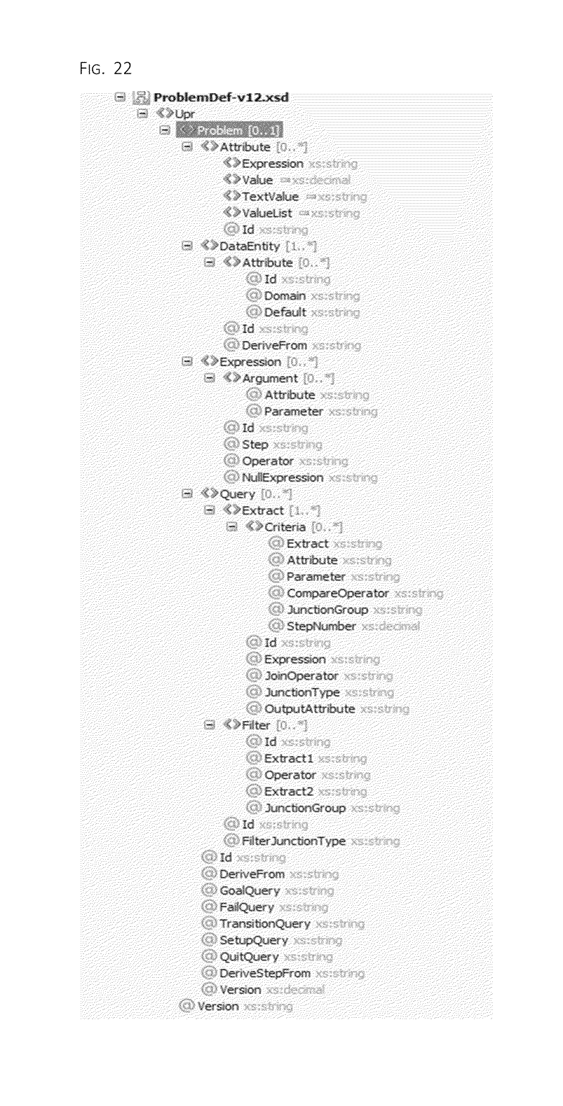

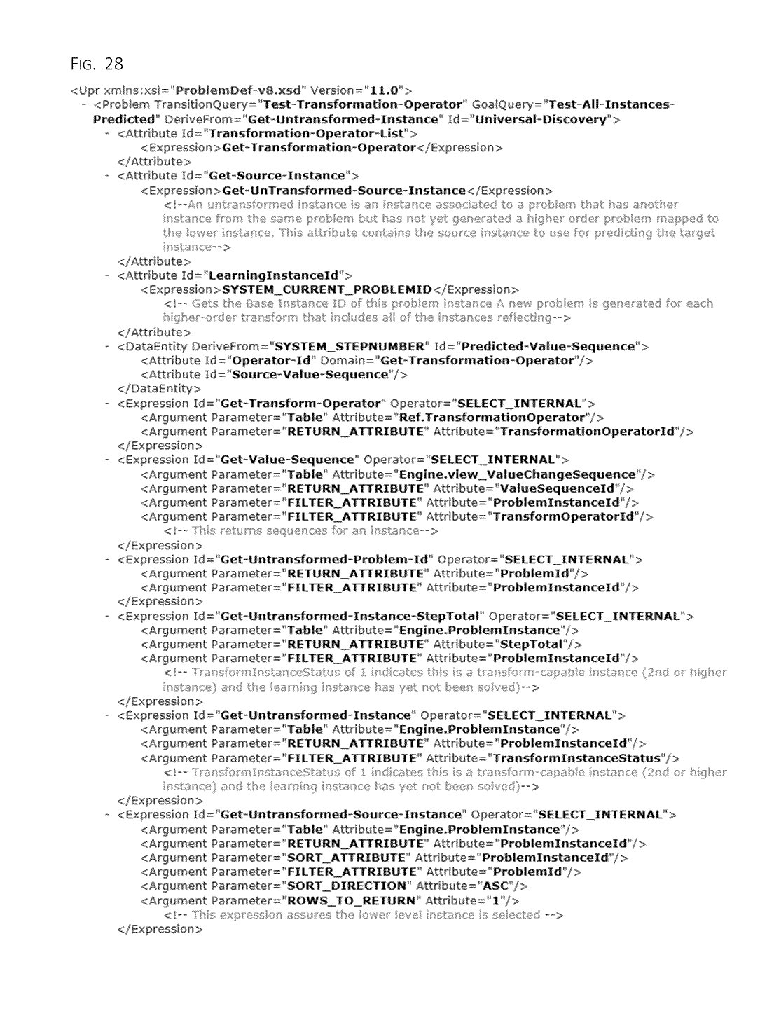

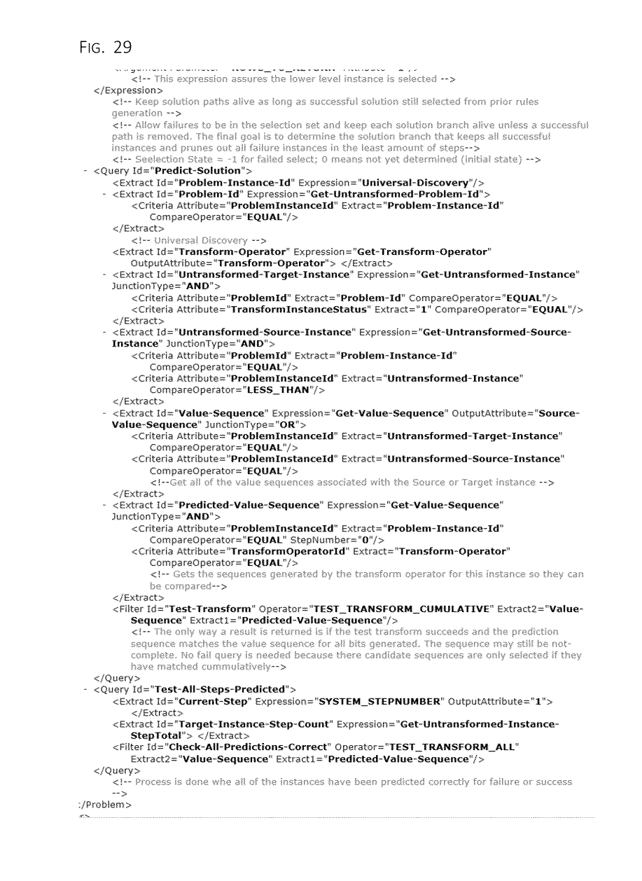

The example methodology is as follows:
1. Define the Tower of Hanoi problem as illustrated in FIG. 24 specifying the definition from a general problem-solving schema (FIG. 22).
2. Generate instantiations based on the setup query for the range of discs defined for simulation.
3. Utilize simulation to process the outputs of the transition query until achieving success for four instances 2000, 2002, 2004, 2006 of Hanoi (two to five discs). The table on FIG. 25 illustrates results of the entity-attribute value sequences that reflect the value activations at each step associated with an object of type 702.
4. Using the higher order problem (FIGS. 28-29), apply transformation operators that evaluate the solution sequences, generate additions to the lower level problem queries, execute the queries, and measure the success. This process runs as a simulation and results in identifying the sequence of transformation operators necessary to solve each larger instance from the smaller instances.
5. FIG. 20 illustrates increasing problem transformation depth as the framework solves more simulation instances for the Tower of Hanoi. The first-order problem is to determine the transformation operators that vary the sequences of a source instance so that they match a prediction instance (target). Once there are two solved transformation solutions 2012, 2014, a sequencing problem arises that determines the sequencing operators to act upon one transformation instance to create the transformation operations in a prediction instance. Once there are two solved sequencing solutions 2022, 2024, a higher-order sequence resolution problem instance 2030 learns the operators needed to generate the sequencing operations in a target instance from a source instance.
6. At this point in the Tower of Hanoi, a repeating sequence becomes evident and the sequence generation operators are able to generate the solution to a higher instance. The framework accomplishes this using the lower solved instance without requiring the use of simulation to increase the breadth or depth of the established solution space. Rather than relying on simulation, the tree can be co-recursively visited, creating a new transformation sequence problem instance to leverage the last transformation solution as input to generate a transformation instance, which then generates the simulation output result without re-simulating. This process repeats using the output simulation of each instance with higher disc-counts until solving the desired disc-count. FIG. 21 illustrates the solution generation process wherein the sequence generation solution SG1 2030 is able to generate the next transform sequence solution for problem instance 2026. This in turns generates the next transform solution for problem instance 2018, which then generates the output that would have come from simulation to solve a larger problem instance 2010. To verify that the generated solution is correct, the framework can execute further simulations. Each simulation adds further depth of learning such that the generational sequence solution evolves into higher-level generational sequence solutions. As the learning depth increases, it becomes more and more likely that a general case solution will evolve for a deterministic scenario. For the Tower of Hanoi, four simulations that spawn three levels of solution generation are adequate for the transform operators to identify a pattern that works for all instances of disc counts.
   Step-by-Step Simulation (Solution Exploration) with Transformation Problem Instantiation Simulation State Sequences

FIG. 25 shows each disc with the peg affected on a particular move. The result of simply un-pivoting all entity and attribute name/value pairs and aggregating all the states across the sequence for each distinct value for the entity (disc) and for the attribute (peg) without regard to the intersection of the entity and attribute provides reconstitution of the solving steps that does not require knowledge of specific columns. This provides a generic view of any problem in terms of the occurrence sequence for a value linked to an entity name/key or an attribute name/value is realized depicted in FIGS. 26 and 27 showing discs and peg state sequences respectively associated to different instances based on the number of discs. FIG. 26 illustrates the use of expressions instead of absolute numbers to define the entity keys for the discs represented by objects in terms of the minimum disc. As UPRF works through simulation, it attempts to substitute values with expressions as each level of abstraction improves the changes to arrive for realizing generalized transformation sequences that ultimately solve new problem instances without the need for simulation.

First Simulation Pair with First-Order Transform

FIG. 30 illustrates the relational state sequences from two instances of a Hanoi solution capturing the entities (discs) and attributes correlated to the activation of particular values in a solution sequence. For example, in the two-disc simulation 2000, the disc with the smallest size 2600 activates on the first and third move of the solution while activating the larger disc 2602 on the second move. Likewise, each peg correlated to a value is activated at zero or more points, with peg two 2702 activated on the first move (disc one moves to peg two), peg three 2704 activated for the remaining two moves, but peg one 2700 not requiring activation. Within UPRF, relational state sequences are fully reversible; the combination of all captured states for any instance of a problem are reversible to replay all of the actions involved in a simulation.

The second simulation 2002 in FIG. 30 shows the relationship between the state sequences associated with an additional target disc 2608 as well as the smaller discs 2604-2606. This illustrates how the sequences for the second simulation 2002 can be constructed from sequences for the first simulation 2000. For example, the smallest disc 2604 inherits the pattern of moving every other move from 2600; the next largest disc 2606 repeats the moves from 2602 with an intervening zero bit (shown as a dash) and the new disc 2608 takes on the same pattern as the largest disc 2602 in the first simulation through symmetrical expansion.

The peg sequences also show a relationship that rotates sequences from multiple pegs to generate new sequences. For example, the peg one sequence 2706 of the second instance derives from the sequence for peg one 2700 from the first simulation instance 2000 followed by a zero bit and appended with the sequence for peg two 2702 from the first instance. This pattern continues for the other pegs serially with each peg instance such that the second peg 2708 of instance two derives from the instance 2000 peg-three sequence 2704 plus a zero bit and then rotating back to append the instance 2000 peg one 2700 sequence. 2710 continues a similar pattern rotating the source sequences form the other instance appending 2702 with a 1 bit and then 2704.

Upon simulation of the two instances, the framework is able to instantiate the transformation problem T1 2012 that solves the problem for how to derive the sequences associated with the 3 disc 2002 instance from the 2 disc instance 2000 by searching for transformation operators from the extensible library of transformation operators.

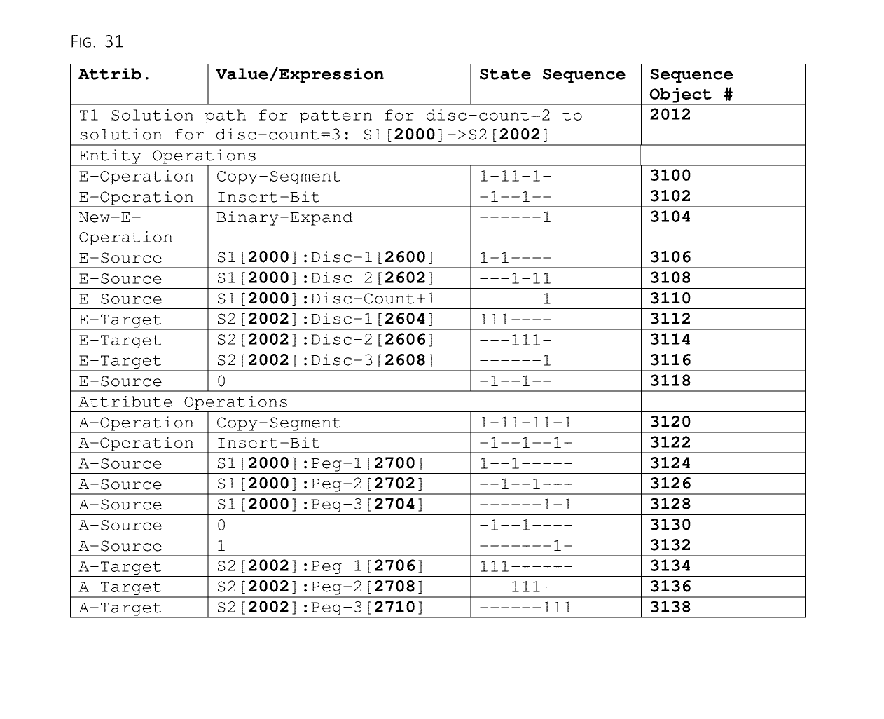

For Hanoi, the sample algorithms in FIG. 31 provide the necessary logic to generate the necessary sequences. For example in step 3106, the sequence for the smallest disc 2600 from the two-disc simulation 2000 is selected as the source object for the step represented by Copy-Segment 3100 to copy sequence 3106 to sequence 3112 for the smallest disc 2604 as the target for the three-disc simulation 2002 as the first solution operation since the 1 in the sequences indicates that these 3 activations occur on the first step. For the second step, the Insert-Bit 3102 operation is activated indicated by the 1 in the second position, while the other transform operators Copy-Segment 3100 and Binary-Expand 3104 are not activated indicated by the dash in the second position of their sequences. Execution of 3102 is performed with source 3118 referencing source and targeting disc 2604 on step 2 indicating a 0 bit is inserted to the three-disc simulation 2002 smallest disc 2604. On the third step, the sequence transformation for the first disc 2704 of the three-disc simulation is completed by re-activating step 3100 Copy-Segment using the smallest source disc 2600 from the two-disc simulation 2000 targeting the disc 2604 in the three-disc instance 2002. A similar pattern generates the correct sequence for the second disc 2606 in the three-disc instance 2002 using the second disc 2602 from the two-disc instance 2000 based on the combined activation sequences 3100, 3102, 3108, and 3114 for steps 4 through 6 in the sequences. The three-disc instance introduces another entity instance 2608 representing a third disc not in the two-disc instance. Entity keys or attribute values may be represented using expressions rather than constants. This is useful for new objects such as the new disc where the disc to be created can be defined through an expression computed from values in an earlier instance, in this case, the source value of 3 for 3110 for the third disc 2608 is defined by adding 1 to the disc count from the instance 2600. The Binary-Expand operator referenced in the sequence 3104 is able to generate the sequence for 2608 using the source disc 2604 to target the new disc 2608 using the activation sequences 3104, 3110, and 3116. The attribute column associated to the objects indicate the types of operations relevant for the Hanoi scenario but are not the only possible operation types. Additional operations such as using an attribute sequence as a source to transform to a target entity sequence or using a source entity sequence to transform to a target attribute sequence may be pursued. The following are relevant for the Hanoi example:
1. E-Operation: Carries out a transformation that uses source entities and affects a target entity.
2. New-E-Operation: Carries out a transformation that uses sources entities and creates a new target entity.
3. A-Operation: Carries out a transformation that relates to source and target attribute values.

At this point, there is now a solved first-order transformation problem instance for generating three-disc solution sequences from a two-disc solution. Upon completion of another first-order transformation problem instance, a second order transformation problem instance can be pursued to achieve a yet higher-level generalization.

Second Simulation Pair with First-Order Transform Resolution

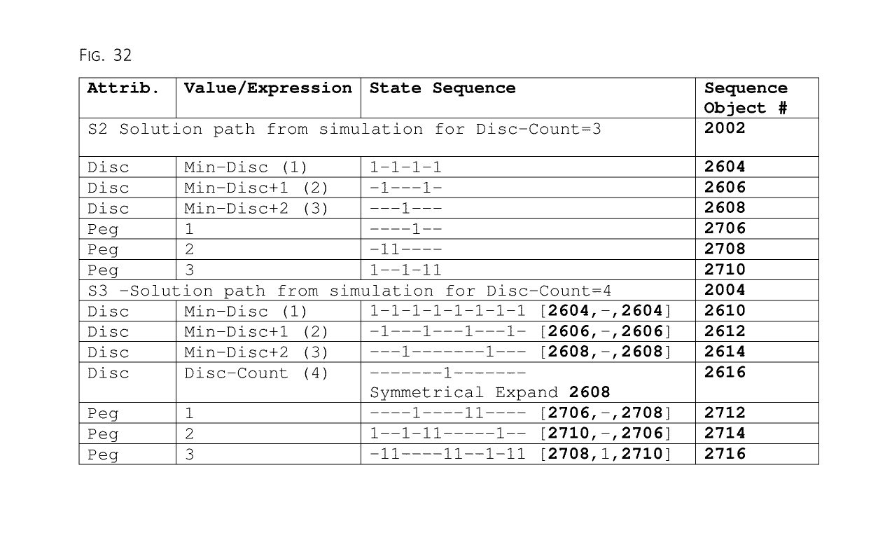

FIG. 32 contrasts the transformation of the sequence associated with the disc and peg states from the three-disc simulation 2002 to the four-disc simulation 2004. The transformation pattern is identical duplicating the disc sequences with the new sequence introduced with a mid-point state set and the copying peg sequences serially to combine pegs one 2706 and two 2708 to form target peg one sequence 2712, pegs three 2710 and one 2706 to form target peg two 2714, and pegs two 2708 and three 2710 to form target peg three 2716 with intervening Os or is as indicated on the figure.

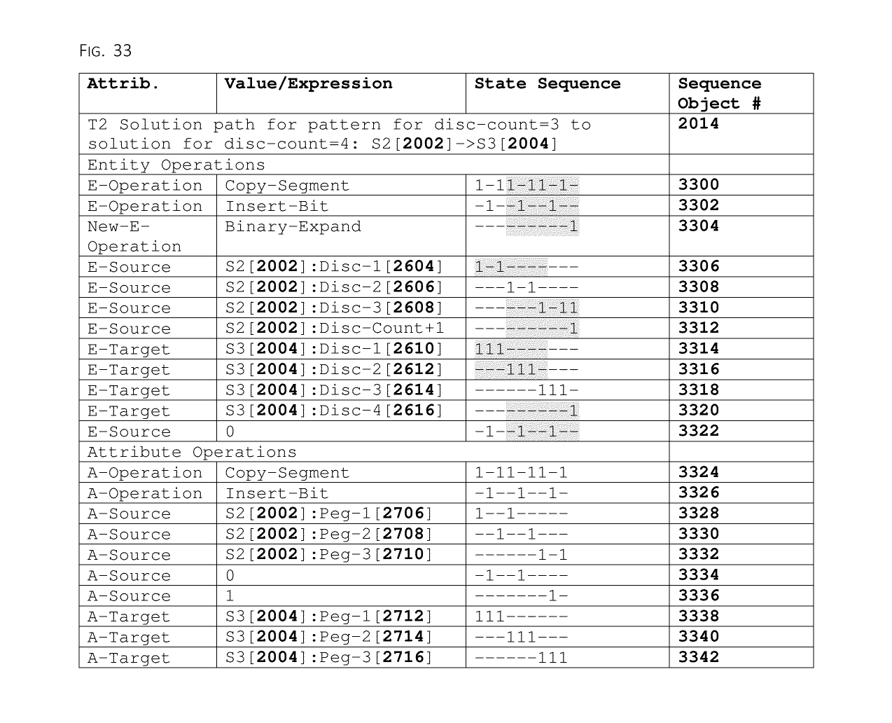

FIG. 33 follows the same pattern as FIG. 31 but continues with sequences from the three disc instance 2002 being transformed to solve the four disc problem instance 2006. The same patterns apply with the exception of additional source 3312, target 3320 entities for the new disc operation and lengthening of corresponding entity sequences (3100-3110: 3300-3310, 3112-3116: 3314-3318, 3118: 3322) due to steps needed for additional entities. The attribute sequences in 3120-3138 duplicate exactly to 3324-3342 in both length and content.

### Second Order Transformation Problem Resolution

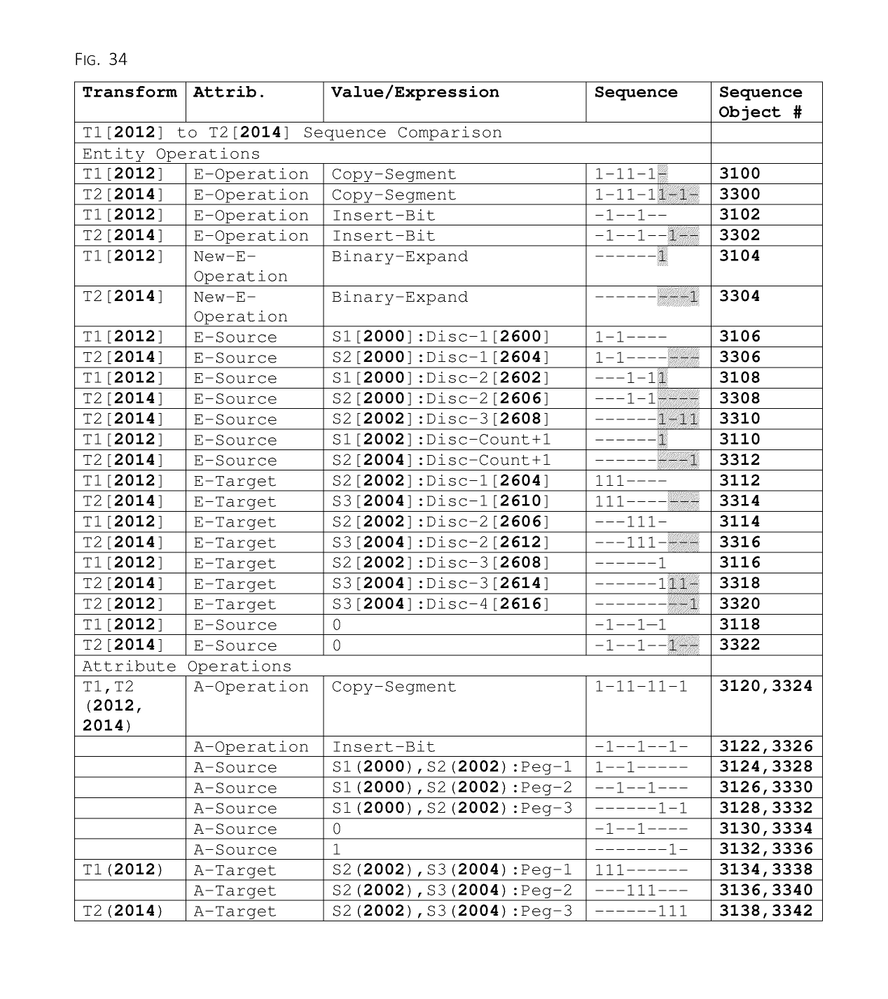

FIG. 34 merges FIGS. 31 and 33 together to compare the resolution of the two first-order transformation problem instances 2012, 2014 generated from the three instance simulations 2000, 2002, and 2004. This enables pursuing a second-order transformation problem instance 2022 to resolve the first-order problem instances such that 2012 can be transformed to 2014. FIG. 34 follows the same format as that for comparing the base simulations as illustrated in FIGS. 30 and 32 and demonstrates how UPRF is able to use the same semantics for transformation problem instances as it does for base simulation instances. This enables the framework to utilize the same methods to seek higher order transformation sequencing solutions as those for base simulations thus establishing the recursivity needed for ongoing self-organization which is a key differentiator of the invention from other problem resolution systems.

In FIG. 34, the source sequences map from the first-order transformation instance T1 2012 to transformation solution instance T2 2014. The sequences are targeting the problem of generating the sequence of operations to solve the Tower of Hanoi, rather than the Tower of Hanoi itself. The transform column identifies the transform instance with the instance qualifier within the transform shown in the expression column of the chart. This is the first higher order problem transformation problem. Since there are no new attributes and the pattern for copying the sequences are the same, the attribute solution path is simply an exact duplication of the prior instance.

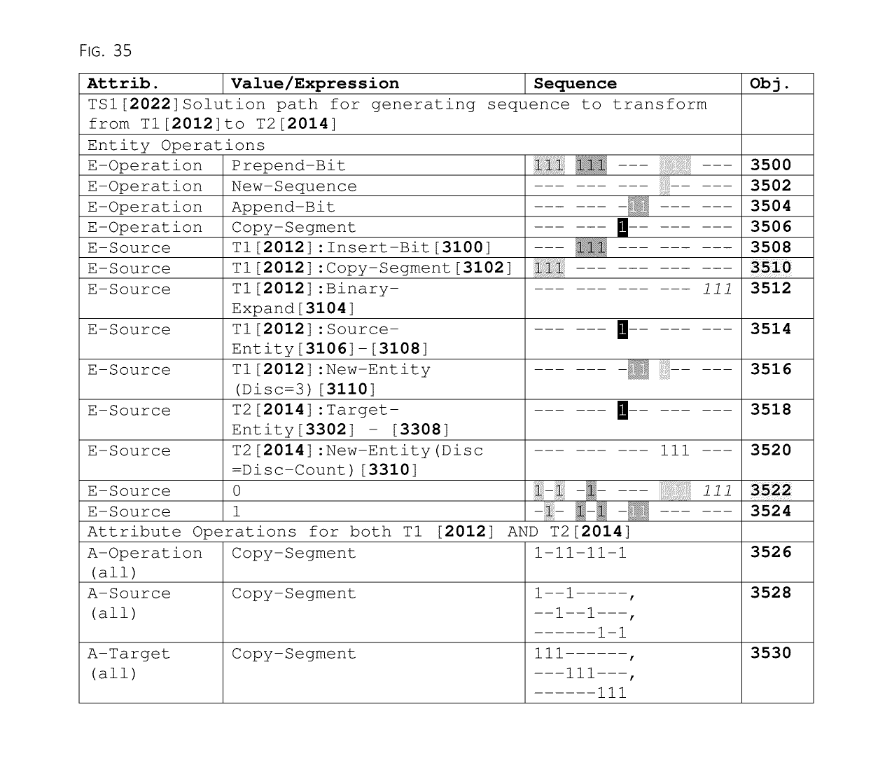

FIG. 35 identifies the transformation sequences to convert the lower level transformation T1 2012 to generate the sequences for T2 2014. New transformation operators Prepend-Bit 3500, New-Sequence 3502, and Append-Bit 3504 are utilized for the higher-order transform operators along with incorporating the Copy-Segment operator 3506 utilized for the first-order transformation problem. TS1 2022 generalizes all the source discs 3514 associated with 2012 into a single operation and creates a new operation linked to the disc-count in 3520. Therefore, the target sequences are the same as the sources for the higher-order instance 2014 and generalized to the target entity 3518. For example in FIG. 34, the Copy-Segment operation sequence for 3300 requires an additional 101 at the start from the T1 Copy-Segment operation sequence 3100. UPRF accomplishes this by referencing the Copy-Segment source 3510 along with a prepend-bit operator referencing 1, 0, 1 of 3522-3524 in steps one through three of the sequence as highlighted in light grey for 3500. The darker highlight for 3508 show the sequences required to generate the T2 Insert-Bit operation sequence from the T1 Insert-Bit sequence operation. The bit operations refer back to the performance of the transformation sequences from the lower level transformation problem to transform the T1 2012 patterns to T2 2014. For example, The Insert-Bit operation in 3008 must be prepended 3 times with a leading 0 followed by 1 to shift the transformation sequence of 3302 using 3102 (“-1- -1- -” becomes “-1- -1- -1- -” by prepending 1- -).

The dark highlight shows Copy-Segment 3506 applied to all the entities of the source 3514 and target 3518. The light highlight shows the portion of the prepend operation sequence in 3500 that transform the sequence for projecting a new entity 3514 in 2012 to create the new disc entity 3520 in 2014. For the T2 2014 instance, the binary expand operation 3512 is executed three steps later such that prepending bit zero 3522 is activated for the italicized l's in 3512. Attribute operations are resolved as simply a duplication of the prior instance of the operation, source, and targets in 3526-3530. The generation of a solution that transforms a transformation sequence set of operations from one instance to another moves up the abstraction level and gets closer to a generic solution for generating T[n+1] from T[n] 2020.

In this example, the disc count problem attribute becomes part of the sequence generation rule such that transformation-sequencing solutions can be generated for yet non-simulated problem instances. This capability allows the problem solver to predict the solution path incrementally for each lower level transformative property in a co-recursive fashion until the instance for the desired number of discs. In the last set of transformation operators, the prediction targets replace the original sources. This allows the solution to be repeatedly instantiated using its own predictions as the input until achieving the desired target instance.

Operations 3502, 3504, 3512, 3520, 3522, 3524 combine to enable the new entity generation referencing the sequence for the prior new entity creation 3516 targeting the new entity 3520 through appending of appropriate bits from 3522 and 3524 to the source new entity sequence as well as the target new entity sequence. In the Tower of Hanoi example, this leads to sequencing of the steps for transforming from the generated source sequence 3516 to the targeted disc sequence 3518.

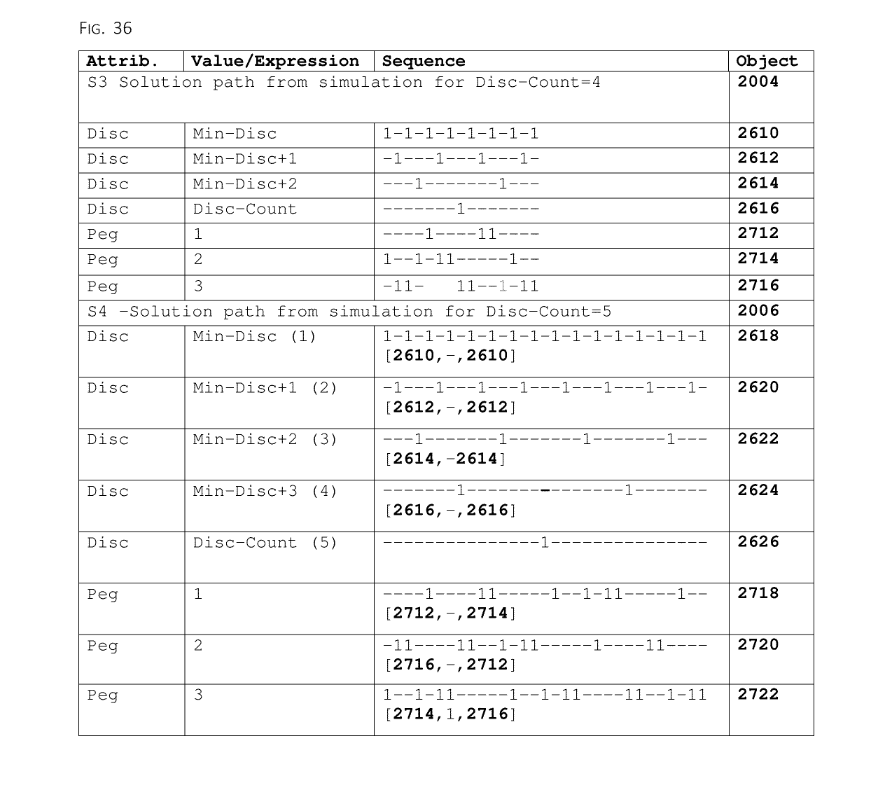

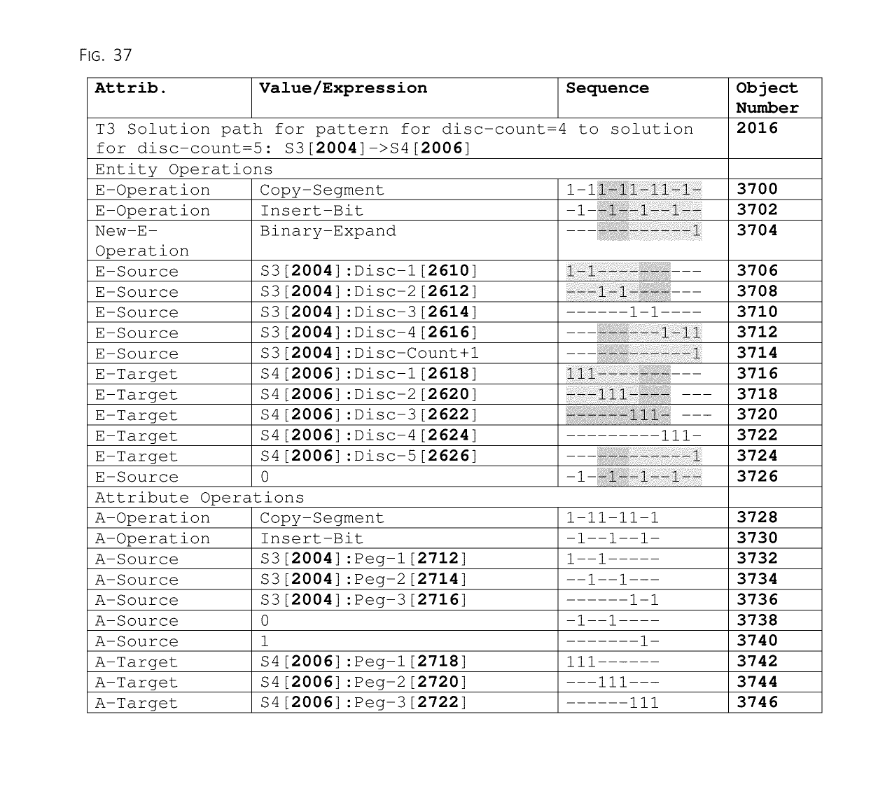

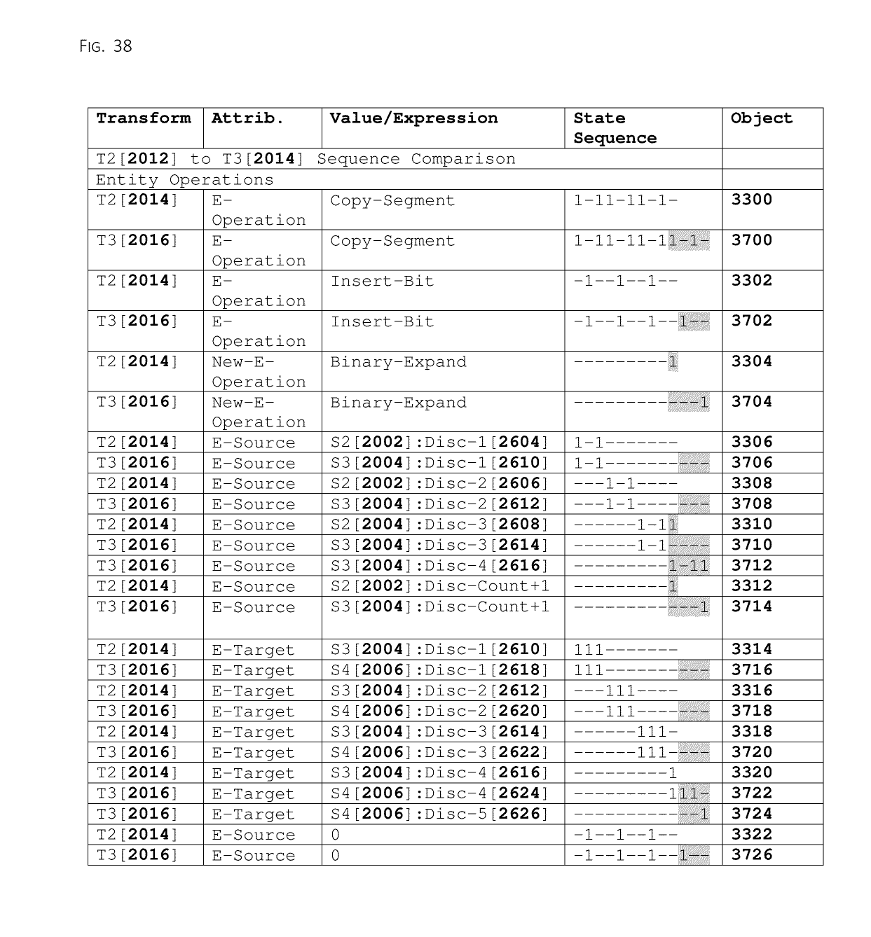

FIG. 36 shows an additional simulation instance going through the same process for the earlier solution instances but highlighting four-disc S3 2004 and five-disc S4 2006 instances. FIG. 37 depicts the first-order transformation problem instance T3 2016 that arises for solving 2006 state sequences using the state sequences from 2004. The solution sequence solving patterns 3700-3746 that emerge from this process very closely mirror those from T1 2012 and T2 2014 first order transformation problems already discussed. With the exception of the lengthening of the sequences and the additional sequences for the added entities from the base instances, the contents are identical as indicated by the shading where the light shading shows the T1 sequences and the dark shading adds the T2 sequencing contained within the T3 sequences. The attribute sequences associated to the pegs are exact duplicates of both T1 and T2 further establishing the assertion that the peg sequences have been generalized for any base simulation instance at this point. FIG. 38 contrasts the T2 2014 and T3 2016 problem instance state sequences similarly to the contrast from T1 2012 and T2 2014 problem instances depicted by FIG. 34 with the additional bits added to the patterns shown in grey shading.

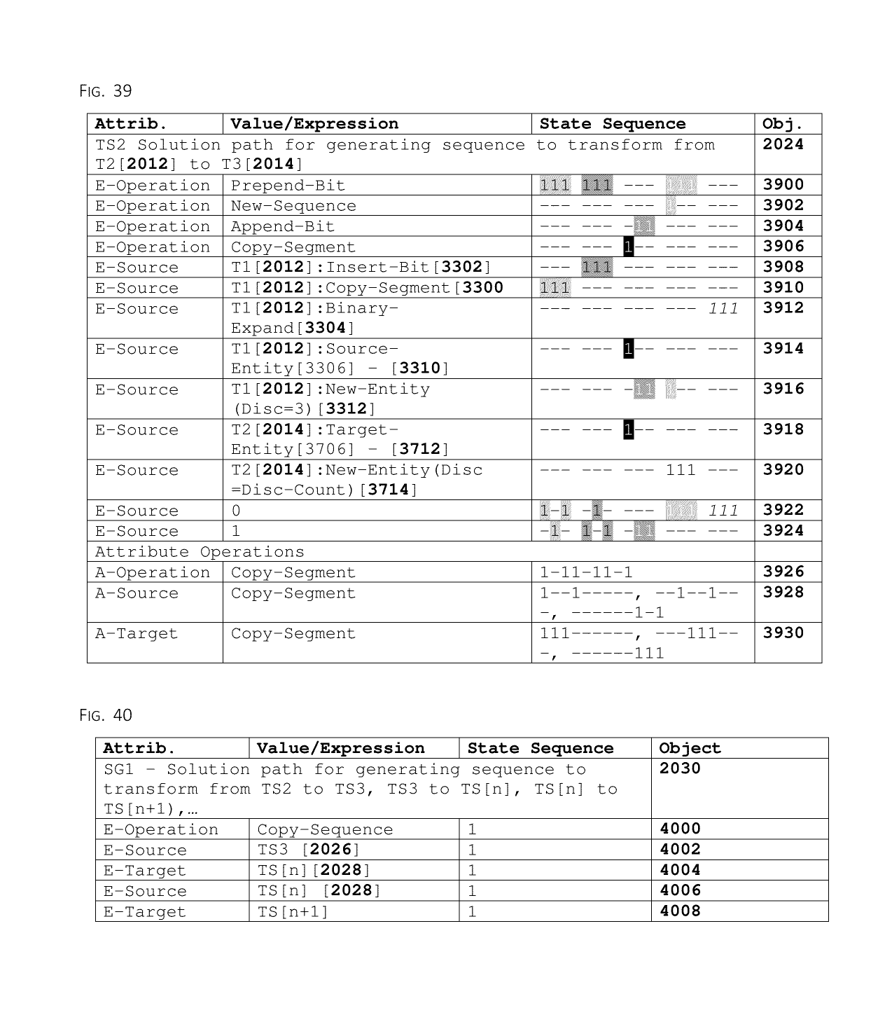

FIG. 39 depicts the second-order transformation problem instance TS2 2024 that generates the transformation sequences for transforming the first-order transformation problem instance T3 2016 state sequences to generate the first-order problem instance T4 2018 problem instance state sequences. This chart duplicates FIG. 35 since the higher-level organization targets all existing and new entities as independent sequences for any new instance. This pivoting of the existing and new entity sequencing eliminates the creation of an additional sequence for instances with lineage to simulations with more discs. The operations at the second-order transform level are targeting how to manipulate the transformation sequences to transform the base problem instances. Thus, the sequences in 3900 through 3930 are an exact duplicate of the sequences in 3500-3530 yielding a generalized solution and reaching an equilibrium point in regard to the Tower of Hanoi example.

The next step is to generate a sequence generation problem that can generate the sequence of instructions to create the transformation required to transform the simulation instances: TS1 2022̂TS2 2024->SG1 2030. The sequence of operations for T3 2016 is identical to T2 2014; therefore, there is now a general solution by simply using the copy segment operation from the prior instance. This is based on the generation of identical sequences to transform the transform sequence for T3 2016 to T4 2018 as that for the generation of T1 2012 to T2 2014 and T2 2014 to T3 2016 evident from a comparison of FIG. 39 to of FIG. 35. The final higher order problem in FIG. 40 targets the transformation-sequencing instance required to generate a set of state sequences to a new second-order transformation problem instance from an existing second-order transformation problem instance solution. Since the sequences are identical for any second-order transform solution for the Tower of Hanoi, the operations to transform is simply a copy of each of the attribute sequences from the second order transform which pertain to the Copy-Sequence operation 4000, the source 4002, and the target 4004 from the TS3 2016 onto a new TS[n] 2028 solution. A further generalization for the source and target for any value of N is indicated by the use of the N and N+1 conventions applied to the source 4006 and target 4008.

This ultimately provides the general solution to generate the solution directly without the need for simulation for further instances of Hanoi. This is because SG1 2030 can generate the TS[n] 2028 Transform generation by copying TS(n−1) sequence. Reversing TS[n] 2028 from state sequences back to entity and attribute values generates Tn+1. Reversing T[n+1] sequences, generates entity and attribute values for simulation Sn+1 2032. When S[n+1] is provided to T[n+1], the framework generates Sn+1. Generation of T[n+1] enables TSn+1 and the process repeats until S[n] meets the criteria for the number of discs. That is, if there is a request for the solution to a disc number of eight and UPRF has solved four instances in order to generate SG1 2030, then simulation instances five through seven generate through the reversal process without any simulation in order to provide the criteria to generate the solution sequence for a simulation with eight discs.

### Summary of the Generalization Approach

FIG. 20 provides a context for the second-order transformation resolution: A new simulation for S4 2006 spawns another Transformation instance T3 2016 so that a second instance of the transform solution TS2 2024 is created that pivots to include the operation type. TS1 2022 and TS2 2024 transform solution paths enable the necessary recursion depth for the Hanoi example to handle transform operation sequences generically shown as SG1 2030. There is no inherent limit in UPRF regarding recursion depth for higher-order problem transformations, constraints regarding this are a consequence of the operational environment with the preferred embodiment the implementation of an equilibrium problem instantiated within the standard framework that monitors costs/benefits to maximize throughput based on resources and prioritization based on continuous feedback from the system's own performance metrics.

The transformation sequence for TS1 2022 and TS2 2024 incorporates the base expressions that reflect data about the instance itself, specifically the disc count in order to calculate the number of offset operations required to achieve the transform from TS[n] 2028 to solve T[n] 2020 based on T4 (2018). Thus, the generic solution is de-coupled from the specific instances and able to operate on any simulation instances in an identical fashion. This allows execution of the higher order transform even where no supporting simulation exists. The capability represents the pivot point in the recursion, such that co-recursion reverses back down the tree and ultimately generates the next simulation solution instance without the need to carry out simulation, but only to implement the transformations. Thus, instead of requiring exponential complexity to explore the solution space, the complexity is linear with respect to finding the solution approach based on the number of discs. This does not mean that the problem itself reduces to linear complexity, as the size complexity still must increase with larger simulations to reflect the need for an exponential increase in moves for each added disc.

FIG. 35 depicts the resolution of the second-order transformation problem instance TS1 2022 also referred to as a transformation sequencing problem in that the objective is sequencing of transformations that solved a lower-level instance. The objective is to determine the sequence that transforms the transform sequence for the first order transformation problem instance T1 2012 to the sequences for another transformation problem instance T2 2014. The sequences are targeting the problem of generating the sequence of operations needed to solve the Tower of Hanoi rather than the problem of the Tower of Hanoi itself. The transform column identifies the transform instance with the instance qualifier within the transform shown in the expression column of the chart. This is the second order problem transformation problem.

New attributes are not created independently of entities as they are static properties of entities in the UPRF schema. This does not in any way limit UPRF since dynamic attributes can be simulated through linkage to dynamic entity instances that may have any number of properties including a labeling property to support dynamicity. Therefore, attribute sequencing solutions can be realized without the higher order pivot transformation to address attribute creation. In the case of the attribute sequence generalizations, these were realized even before resolving the sequence generation problem instance 2030 by nature of the duplicate sequences realized across all of the second-order transformation sequence problem instances 2022,2024, 2026.

### Reversal Processing

The prior section illustrated the process for transforming solution paths into higher order problems. In these higher order problems, the goal transitions to finding the technique for predicting the solution paths for the lower order problem for one instance from another instance—possibly multiple instances. This section demonstrates how the state sequences transform into actual values in the database entities and attributes associated with the instance. This capability is necessary to generate a solution instance for a problem directly without the need for simulation. This elaboration substantiates that state sequences as they are captured by UPRF are adequate to reconstruct problem solving steps for the instances targeted by the state sequences including problem instances not yet resolved through simulation.

In the final transformation for the Hanoi example, the disc count for the new problem instance is the reference variable. The framework simply needs to execute the problem setup, creating the initial instance in order to access this variable. In order to generate the targeted simulation, the framework must perform all of the transformations upon which the targeted simulation depends. This co-recursive process is the unwinding of the recursive problem solving process. As the framework performs each higher order transformation, it generates the lower order solution instance until finally achieving the targeted simulation. This process is best illustrated by flipping the problem transformation process upside down and depicting the leading edge of the transformation generation associated with new instances as shown in FIG. 21. In this process, the only required inputs are the predicted solution paths from the prior transformations. Each predicted sequence becomes a source sequence for the lower-order problem instance ultimately winding down to predict the solution for a base problem instance. In the diagram, the dashed connectors represent the inputs and the solid connectors represent the instances that will generate through the predictive transform operations. Starting at the solution generator node, the process requires moving incrementally through each lower level instance until reaching the target instance for the problem variable. Therefore, even with this requirement to build out the number of instances incrementally, the actual time complexity increase is less than two times the complexity for a direct solution. There is also an overhead for building out the intermediate nodes, but this is a constant factor of three since the framework must perform only the leading edge of the transformations for each additional instance. Therefore, the number of operations is the number of operations in the target solution plus a constant factor for reversing from the solution generator back to the steps. Based on this, the time complexity of generating a solved instance is simply the addition of a linear constant in respect to the actual solution sequence. For example, it takes 31 steps to solve a Tower of Hanoi problem with five discs (25−1) using the most efficient set of moves. The solution generator is able simply to copy the sequences from the prior instance to generate the transformation sequence, which then generates the simulation sequences rather than exhaustively exploring all simulation possibilities.

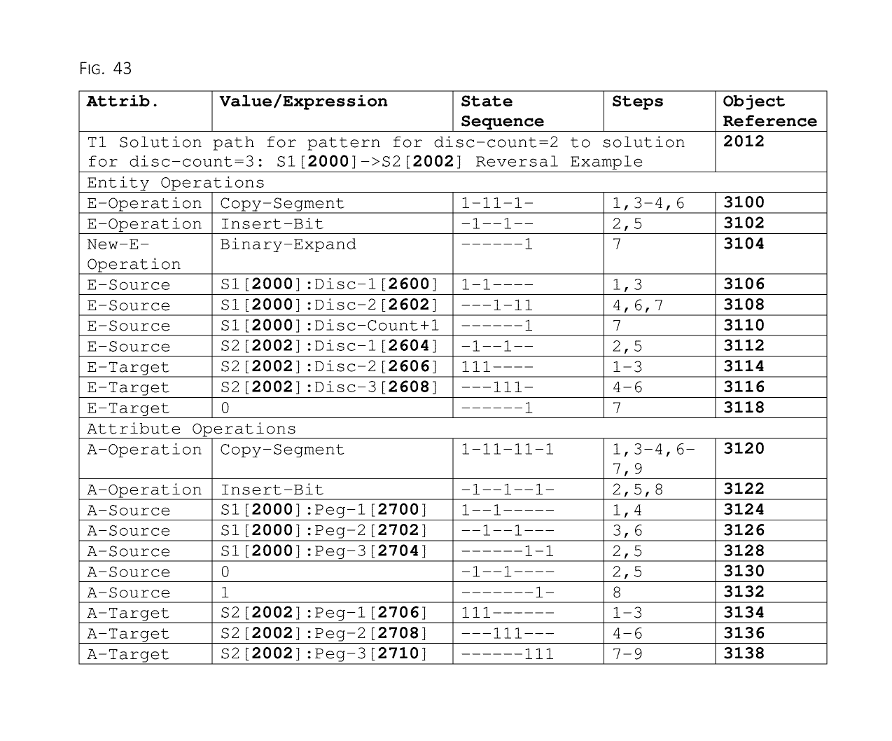

FIG. 21 shows the reversal process which starts at SG1 2030, which utilizes TS3 2026 as the input to generate TS4 2104. TS4 2104 uses the prior predicted instance of T4 2018 as the input in order to generate T5 2106. T5 then uses the last simulation S5 2008 as the input to generate the prediction solution sequence for S6 2108. This process is repeatable for incrementally increasing the number of instances until solving the target instance. FIG. 43 illustrates how the output of the sequence states are transformed into attribute value sequences that represent the specific state changes. State sequences that define the entity and attribute values intersect in order to define the specific values for the entity attribute combinations. The framework must examine the sequence reversal process starting at the highest order working backwards since only the highest order transformation is able to create the dependent instance. This dependent instance is necessary to generate the solution path tree for a new solution instance to the simulation problem. For example, given S5 2008 as the last simulation instance, only T5 2106 can create S6 2108 and only TS4 2104, which does not yet exist, can create T5. However, SG1 2030 can create TS4 2104 by using the output of SG1 2030 as the input for the next instance of SG2 2100 in the final transforms of the SG1 instance. Once the framework creates T5 2104, it can then generate the required instances to predict S6 2108. This process can repeat to solve higher and higher numbers of discs in the Hanoi example embodiment as shown in FIG. 21 by 2102, 2028, 2020, and 2010. Note that although the transformation solution in this embodiment involves operators utilizing instances which are increasingly larger, this approach is not the necessary resolution for other problems, but rather a function of the solution pattern for Hanoi specifically as discovered by UPRF. Transformation sequencing patterns that may utilize smaller or similar sized instances may emerge depending on the nature of the problem undertaken for solution.

Although the reversal process must start at the highest order transformation level, the process is easier to understand at the lower level transformation. FIG. 41 illustrates in the simple 2-disc example how different states activate at different steps from which the operation and the affected entity/attribute can be determined for each step. This same process applies for any set of sequences stored by the framework. FIG. 42 shows how a sequence is implemented into the value sequence data table from the activation sequences in FIG. 41. The value sequence is query-able to define the exact solution steps because it identifies the specific attribute value to assign to an attribute value for a specific entity instance over a sequence range. If the value sequence populates accurately from the state activation sequences, then it is easy to replicate the exact solution to a problem instance.

An intersection of an entity with a specific value, an attribute with a specific value, and a sequence must join in order to define a definitive value to assign to an entity for an attribute at any given point. For example, the entity value Disc=1 is supported by the activation sequence that shows disc one is active at step one and step three, but Peg=1 is not active at either of these steps. Therefore no causative sequence intersection exists to indicate a value for Disc=1 and Peg=1 for any of the steps. However, Peg=2 is activated at step one as well as Disc=1, therefore an intersection exists resulting in a value sequence active at step one. Value sequences retain their values throughout the sequence until a change occurs. Since Disc=1 does not have an activation on step two, its sequence remains intact for the current value. Thus the value sequence for Disc=1, Peg=1 is true from step one to step two. On step three, Disc=1 is once again activated, but the activated attribute is Peg=3. Therefore the value sequence for Disc=1/Peg=2 terminates and a new value sequence starts with Disc=1/Peg=3.

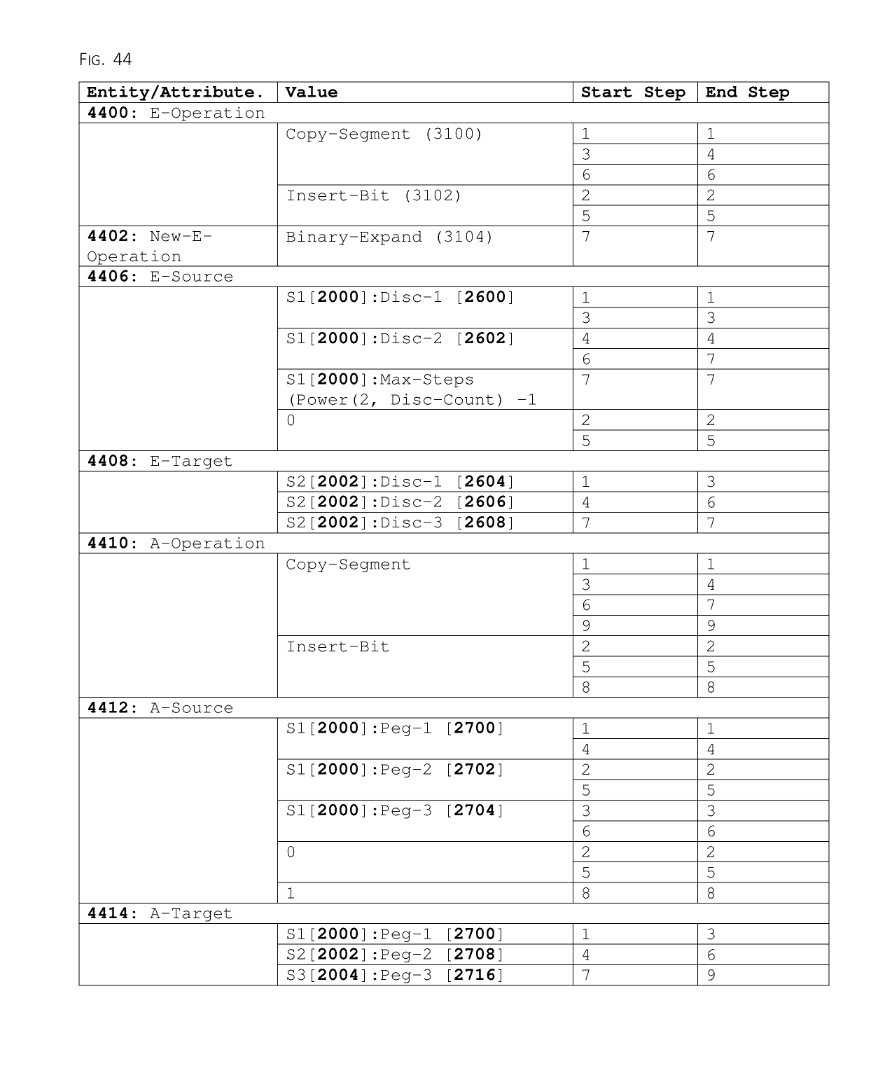

This same process works for the higher order transformation sequence reversals to generate the transformation operations performed on lower-level transformation problems instances and ultimately the base problem instances. FIG. 44 illustrates how the actual transformation operations are carried out based on the states sequences associated to their activation points using the exact same method as for the lower level reversal. The example shows how each operation and their intersecting value are identified by the state sequence intersections using the same concept as that shown in FIG. 42. For example, the entity operation 4400 generates a Copy-Segment operation at steps 1, 3, 4, and 6 based on the sequence pattern from the second-order transformation problem instance for problem instance T1 shown in FIG. 31. In addition, an Insert-Bit operation is performed at steps 2 and 5 based on the state sequence identified in the earlier resolution. The new entity operation 4402 is performed at step 7 utilizing the binary expand transform operator to generate a new disc entity. The process applies to how the source entities 4406 are selected to identify and populate the target entities 4408 as well as for the source attribute values 4412 and target attribute values 4414 to populate. Attribute operations 4410 are executed against the attribute sources and target in the same fashion as for the entities.

In summary, as a problem progresses to higher order transformations, the source values point to the underlying sequences for the transformation problems themselves. States sequences are reversible to activate the value sequences that reflect the required transformations based on their bit being turned on at a particular point in the sequence. The framework understands this process in terms of TS1 2022, which predicts T2 2014. The value sequences from the TS1 2022 instance map to the attributes for the higher order problem, which follow the same pattern as T1 2012. Since TS1 2022 can generate T2 2014 successfully in the same format at T1 2012 and T1 2012 generates S2 2002 successfully, then T2 2014 will generate S3 2004 successfully. It now only remains for SG1 2030 to generate TS2 2024 successfully. Since SG1 can generate TS2 2024 value sequences that implement the T3 2016 transform successfully, SG1 2030 is correct for generating a new instance of TS[n] 2028. This new instance cascades down to new solved instances of S[n] 2010 because T1 2012 was reversible and all higher order transformations follow the same model of referencing the lower level transformation sequences. Therefore, the following recursive/co-recursive sequence exists:

### Recursive Discovery

### S1 2000, S2 2002, S1 2000̂S2 2002->T1 2012

### S3 2004, S2 2002̂S3 2004->T2 2014

### T1 2012̂T2 2014->TS1 2000

### S4 2006, S3 2004̂S4 2006->T3 2016

### T2 2014̂T3 2016->TS2 2002

### TS1 2000̂TS2 2002->SG1

### Recursivity Pivot Point

### TS2 2002̂SG->TS3 2004

### Co-Recursive Cascade

### T3 2016̂TS3 2004->T4

### S4 2006̂T4 2018->S5 2008

### TS3 2004̂SG1 2030->TS4 2006

### T4̂TS4 2006->T5 2106

### S5 2008̂T5 2106->S6 2108

### Co-Recursive Relation

### TS[n]̂SG1 2030->TS(n+1)

### T[n] 2020 ̂TS[n+1]->T[n+1]

### S[n] 2010̂T[n+1]->S[n+1]

### Scaling UPRF to Other Types of Problems Beyond Tower of Hanoi

To this point, the Tower of Hanoi along with the general sequence transformation problem has provided the primary example for operation. The transformation problem for seeking a sequence of operators to transform relational state sequences to predict other sequences did provide examples of multiple entity and attribute types not present in Hanoi. A review of the attributes of the problem indicate that the same process will work for any other type of problem that can be represented in terms of relational data sets identifying initial states, allowed transition states, and goal states. This includes more complex examples including multiple-agents such as in multi-player game scenarios that may be competitive or collaborative or some combination, and non-deterministic including probabilistic scenarios such as seeking the best solution based on targeting an aggregate function (i.e. minimum number of steps, maximum return on value, etc.). This section models the following scenarios:
Instance variation by variation of more than one attribute starting value rather than a single variable only (K-Peg Tower of Hanoi with both discs and pegs varied for each instance)
Multiple-agent scenario for Tic-Tac-Toe to show how competing goals coexist
Zero subset to illustrate targeting a goal such as minimum number of steps rather than an exact solution

These are only examples and not intended to be comprehensive of the scenarios for this invention. As already outlined, any set of functions that expose data sets that reflect initial states, candidate states, and goal states for a problem is the only criteria for the invention to undertake for solution. The goal of the examples is to clarify the extensibility of the invention for any type of problem meeting this criteria.

### Increasing Complexity—K-Peg Tower of Hanoi

In the k-peg Tower of Hanoi, the number of pegs themselves become a variable rather than fixed at three pegs only. This provides an example whereby the problem instance itself may be derived by the combination of more than one variable. UPRF does not need to know the optimal number in order to pursue a simulative solution, as it is able to exhaust all possible paths until finding the minimum. Providing the number of steps is an optimization to reduce the amount of simulation work.

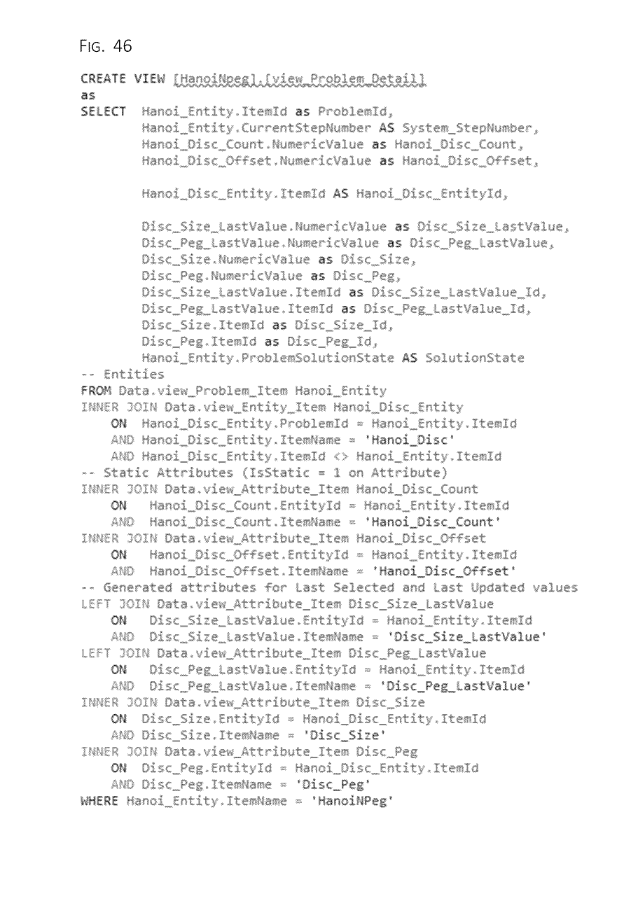

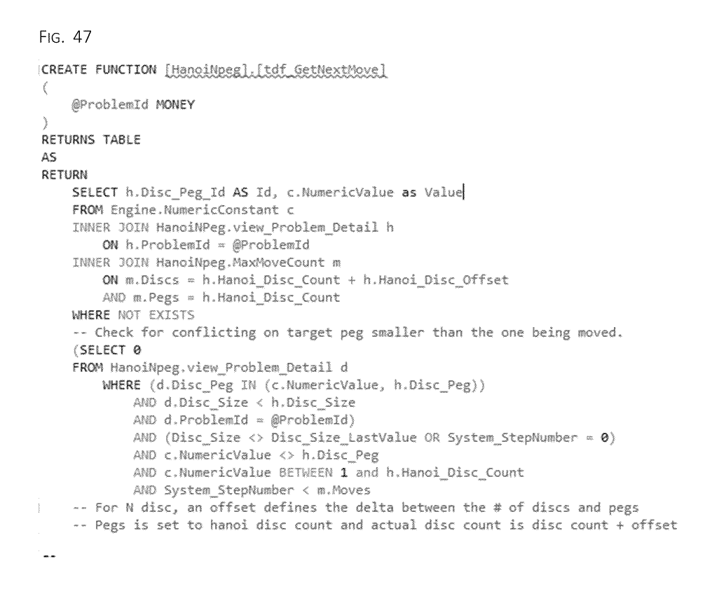

Using the same approach as with the standard Tower of Hanoi, UPRF is able to model the problem very simply for presentation to the simulator (FIG. 45). This example illustrates an alternative definition method using standard Structured Query Language (SQL) to define views and functions based on views from the generic UPRF schema as a sample embodiment for modelling a problem to the invention. FIGS. 46 and 47 depict the SQL code for modelling the detailed K-peg tower problem and then returning the rows associated with the next possible moves at any point in the simulation process.

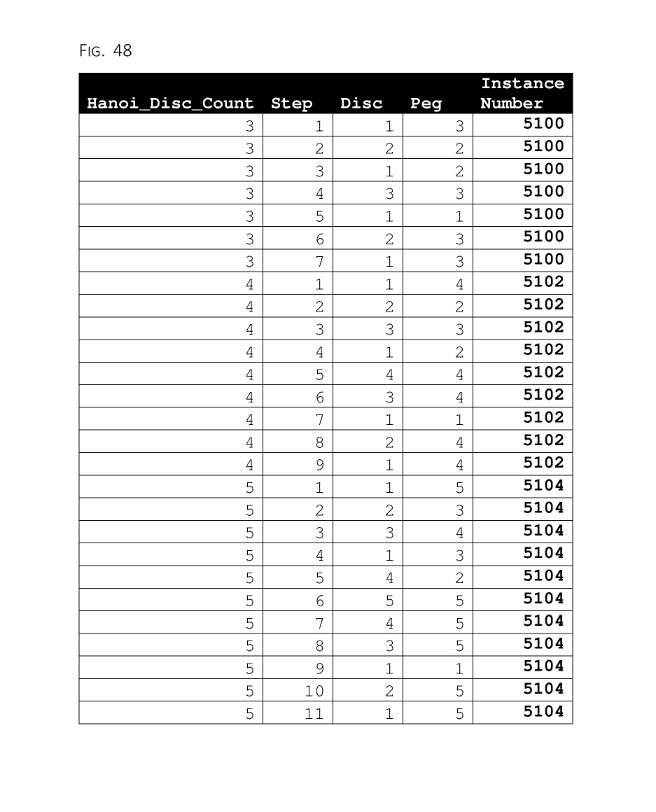

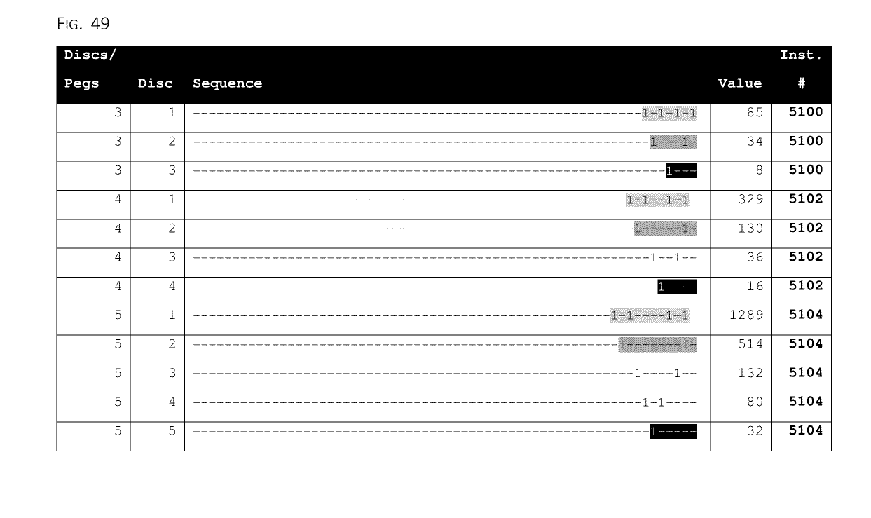

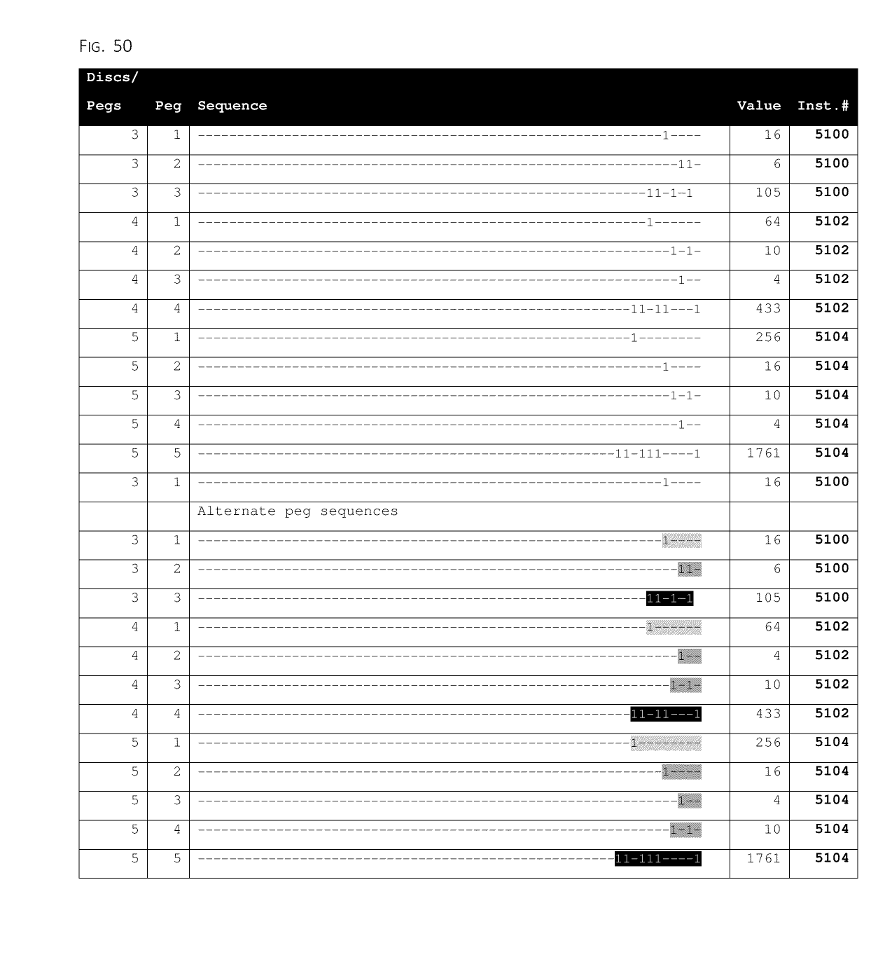

As the simulation finds solution paths, the framework captures the sequences associated to the solution (FIGS. 49 and 50). FIG. 48 provides sample move sequences. A unique feature of adding more pegs is that multiple optimal solutions arise in FIG. 50 under the section “Alternate peg sequences”, which is not the case for the 3-peg version.

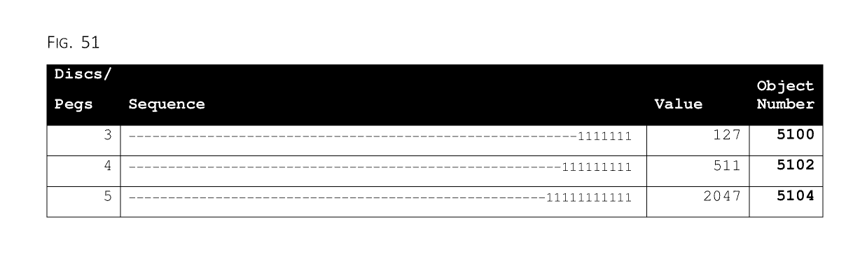

The k-peg scenario tables include the binary values from the sequences. FIG. 51 illustrates that the total number of state changes add up to the total number of state changes mandated by the goal. A learning operator could deduce the sequence of operations for a missing peg or missing disc once the other peg or disc sequences were determined by subtracting the values of the determined sequences from the value of the total sequences. For example, FIG. 51 shows that the total values of all sequences for disc/peg combinations 3, 4, and 5 indicated by 5100, 5102, and 5104 respectively. For example, the 4-peg scenario totals to 29−1 (511). If the sequence values for pegs 1, 2, and 4 were determined for the first sequence example 64, 10, 433, then one can derive the third sequence by subtracting (501 (64+10+433) from the total required for the overall sequence 511 and arrive to 10 as the sequence value for Peg 3.

Basic inspection thus shows that there is a definitive pattern for instances of the 4-peg and 5-peg back to the 3-peg. This shows the potential for solving via transformation sequences that detect such patterns as was the case in the 3-peg Hanoi example. FIG. 50 highlights the similarities. This provides data needed to generate the sequence transformation involved in generating the 4-peg prediction from the 3-peg prediction. The outcome should be a successful prediction of a 7-peg solution sequence. With sufficient transformation learning, a general solution should arise just as with the 3-peg scenario.

### Multiple Agent Example—Tic-Tac-Toe

UPRF finds the base solution paths through simulation to reach a goal. In Hanoi, the goal was deterministic and absolute in terms of either failure or success. However, there is nothing in the framework that prevents seeking best-case solutions and transforming such solutions into higher order problems in the same way as pursuing the Hanoi transformational sequence. This section models Tic-Tac-Toe as an example of a multi-agent scenario.

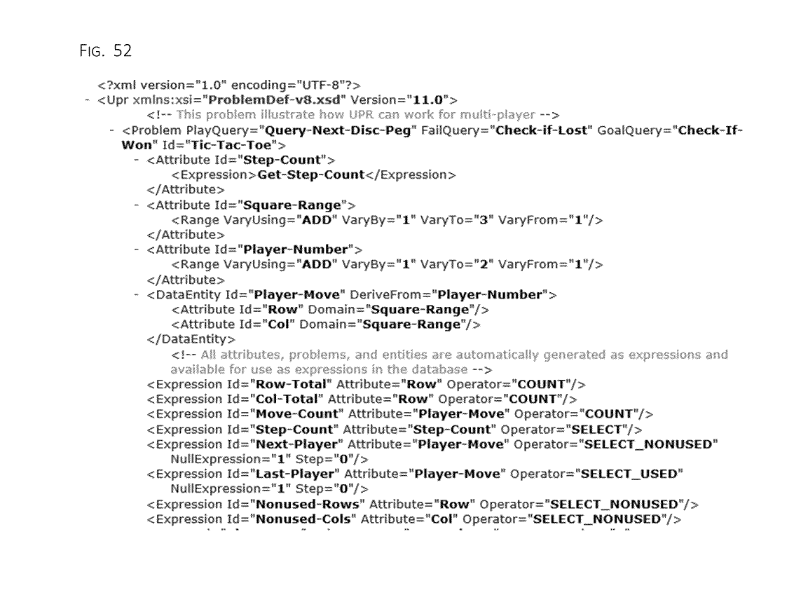

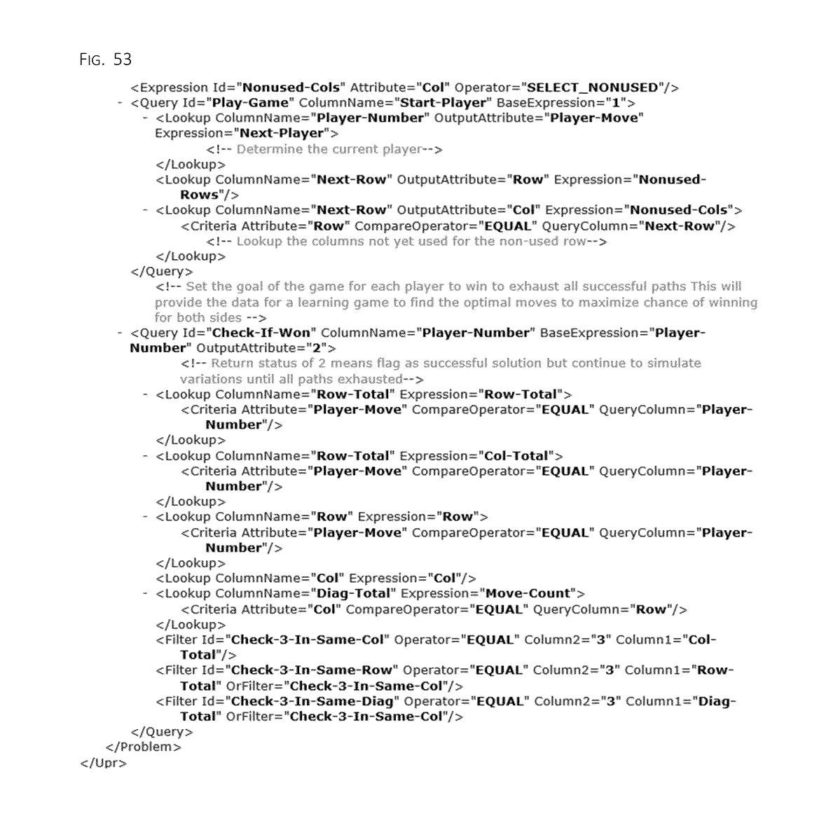

For the purposes of the invention, multi-agent scenario refers to a problem that is collaborative, competitive, or a combination of the two. A collaborative scenario involves multiple agents working toward a single goal. A competitive scenario involves one or more agents competing against each other to reach a goal and includes the scenario of multiple agents working together against another team of multiple agents. Since the invention supports multiple attribute value changes in the same sequence, it supports scenarios that involve discrete steps for different agents as well as concurrent state changes from underlying agents. FIG. 52 illustrates a sample schema for Tic-Tac-Toe. In the Tic-Tac-Toe scenario, the goal is to find the optimal solution path from both player's perspective. Once the transformational sequence processing done, the goal is for the simulation to perform the optimal moves for each player from learning the brute-force simulations. In Tic-Tac-Toe, the significant patterns are all within only three significant squares for the start—the center square, a corner square, and a mid-point square along a row. Therefore, a simulation process that explores paths for these three different squares should yield the transformation sequence to automatically find the optimal solution path for the other six starting squares and ultimately identify the correct responses to avoid the failure state and maximize achievement of the goal state. The schema in FIG. 52 provides enough information to instantiate all of the possible simulations including redundant ones by varying the row range from one to three as well as the column range. In addition, the concept of a player is added which varies from one to two. This allows the problem to vary by player creating separate simulations from the perspective of the different players with the goal being relative to the player number of the simulation. FIG. 53 identifies the constraints of the move, goal, and failure states so that the simulation can proceed similar to Hanoi.

In the Tower of Hanoi, there was an exhaustive review of multiple simulations including the state sequences. The method utilized to search the solution space was depth-first, but this is not a requirement of the invention and any search method can be utilized. This example illustrates an evolution of the schema as a sample embodiment to support constructs of Tic-Tac-Toe more easily. However, this evolution is not a reflection that the Hanoi schema is lacking, but rather an improvement more relevant to helping for this scenario. The processing performed by the invention is driven by the outputs materialized from the schema regardless of the underlying schema embodiment. This section explores the progression in terms of the following phases from both player perspectives:
1. Instantiation Phase: Generates the initial scenario for placement of the first square for the first player for all the possible first set of moves.
2. Play Phase: Generates the response moves from perspective of both players as separate simulations. Sequences for the relational states are captured in this phase.
3. Transformation Phase: Maps the sequences of operations to the higher order transformation problem.

The instantiation phase creates the following instances by nature of the expressions embedded in the problem definition using the attribute overflow concept explained earlier. The attribute overflow principle means that whenever a query or expression generates more than one row of data, generation of a new simulation instance arises that represents that unique path. Based on this, the output is a combination of the following values:

Players: 1 or 2 (Generated by the Range construct for the Player Number attribute)

Player Move
Player (Derived from Player Number)
Row: 1 through 3 (Derived from Square-Range rule)
Column: 1 through 3 (Derived from Square-Range rule)

### Instantiation Phase

The instantiation phase creates the following instances by nature of the expressions embedded in the problem definition using the attribute overflow concept explained earlier in the dissertation. The attribute overflow principle means that whenever more a query or expression generates more than one row of data, generation of a new simulation instance arises that represents that unique path. Based on this, the output is a combination of the following values:

Players: 1 or 2 (Generated by the Range construct for the Player Number attribute)

Player Move
Player (Derived from Player Number)
Row: 1 through 3 (Derived from Square-Range rule)
Column: 1 through 3 (Derived from Square-Range rule)

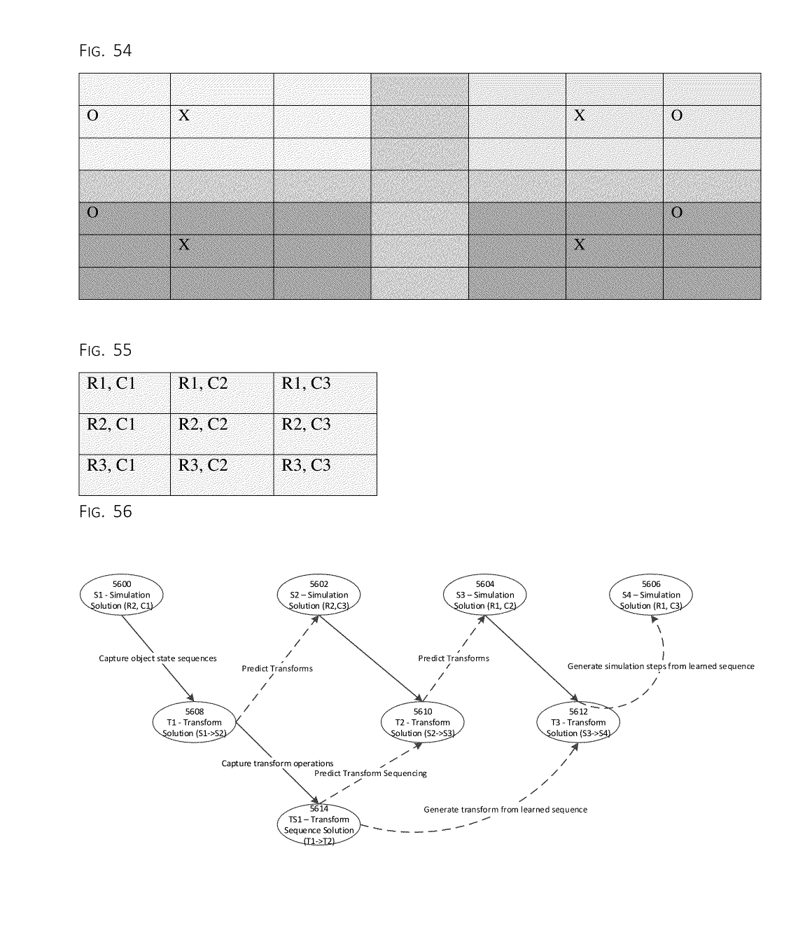

FIG. 54 illustrates some potential instances based on the combination of the first and second player's initial moves. As different combinations arise, these branch off as new instances in the same fashion as depicted using overflow and in the Hanoi example in FIGS. 14 and 19 respectively.

### Play Phase

In the play phase, the simulation applies the goal context based on the player role associated to the simulator against the grid of square representing the plays made including the coordinates as well as the player associated to the move. The Player-Move entity thus includes not only the coordinates but also the player that made the particular move. The rule accomplishes this through the Play-Game query, which looks for a non-used square and non-used column to assign the next move. The outputs of Play-Game are thus:
Player Number making the move based on a lookup that forces the player number to alternate on each move.
Square selected
Column selected

The framework thus generates overflow situation necessary for branching multiple instances for every possible move for each player. This generates the relational state sequences that represent the relationship of each variable values relative to the sequence at which the value changes.

### Transformation Phase

The transformation phase occurs after achieving solutions to two distinct instances. This phase regenerates the problem of deriving an instance solution from another instance solution. The problem is modeled executing transform operators to try to generate a sequence of operators that successfully transform the first instance operations to create the operations used to solve the second instance.

In the case of Hanoi, the solving of the solution path for different instances was simplified since each solution path ultimately derives from the same recursive algorithmic solution with only a slight variation based on whether the count of discs for the instance was even or odd. With Tic-Tac-Toe, some paths are more successful than others are. For example placing a square in the center peg ensures at least a tie-game (“Cat's game”) for the first player and results in several scenarios where the first player is victorious. However, placing a square in a diagonal square, while still effective to ensure at least a tie, does not generate as many victorious paths and the sequence to success is different.

The outcome of multiple-solution path instances is that the transformation operators should eventually find a sequence that converges on common variables in the same way as Hanoi. Ultimately, with Hanoi, the transformations become more and more abstract such that by the third transformation, a very simple set of operators are able to generate the lower level solution to posit the higher order problem—solving it generically.

The same approach works for Tic-Tac-Toe with the caveat that there is “noise” which serves to invalidate some instances as not related to other instances. For example, Player 1 responses to Player 2 placing a mark in a corner square on the first move indicate a different solution path than if Player 2 places a mark in a middle row or column. However, if the response of Player 2 is simply a transformation of another response across a different axis, the solution patterns should be convergent. For example, if Player 2 response to Player 1's first move in the center with an adjacent square rather than a square diagonal, the solution paths are deterministic relevant to symmetry. FIG. 54 illustrates the concept of related instances with solution paths whose variance is purely a function of symmetry as opposed to other instances whose solution path is not attributable to symmetry.

To examine all the potential solution paths exhaustively using combinations of Player 1 and Player 2 would take hundreds of lines of relational state sequence captures. A single base pattern with different symmetries illustrates the relational state sequence chapter and how the transformation problems evolve to converge on a solution transformation sequence that solves multiple instances across symmetries. Based on this, the framework targets four instances initiated by Player 1 moving to the center but with asymmetrical responses from Player 2. This is a subset of the possible paths, but it illustrates the learning transformation process. By the end of the simulation, UPRF is able to generate the solution to the fourth sequence from transformation without the use of simulation. FIG. 55 shows the square labeling convention. These instances are:

P1: R2,C2; P2: R2,C1

P1: R2,C2; P2: R2,C3

P1: R2,C2; P2: R1,C2

P1: R2,C2; P2: R3,C2

FIG. 56 illustrates the transformation process relative to the Player 2 response. This diagram is very similar to the approach from Hanoi. The difference is that only two levels of transformations are necessary to solve the fourth instance given the constraints outlined for a similar solution path with different symmetries.

The generic solution for the symmetrical sequence used to achieve victory in S1 derives from the transformations as follows:

S1 5600, S2 5602->T1 5608

S2 5602, S3 5604->T2 5610

T1 5608, T2 5610->TS1 5614

FIG. 56 illustrates that TS1 5614 will contain the generic operators to generate T2 5610 that transforms S3 5604 to S4 5606 without the need for simulation. The goal is that by solving three instances through simulation, the framework learns the fourth instance transformation generating the solution sequence without simulation. FIG. 56 shows the generation of simulation four from the learned sequence from the third transform generated by the generic transform sequence solution. The model will increase in depth to support more advanced transformations including how to determine the method for determining the correct response to different variations as instances are added with non-symmetric responses. This was examined in detail in Hanoi and follows for Tic-Tac-Toe and all other problem scenarios.

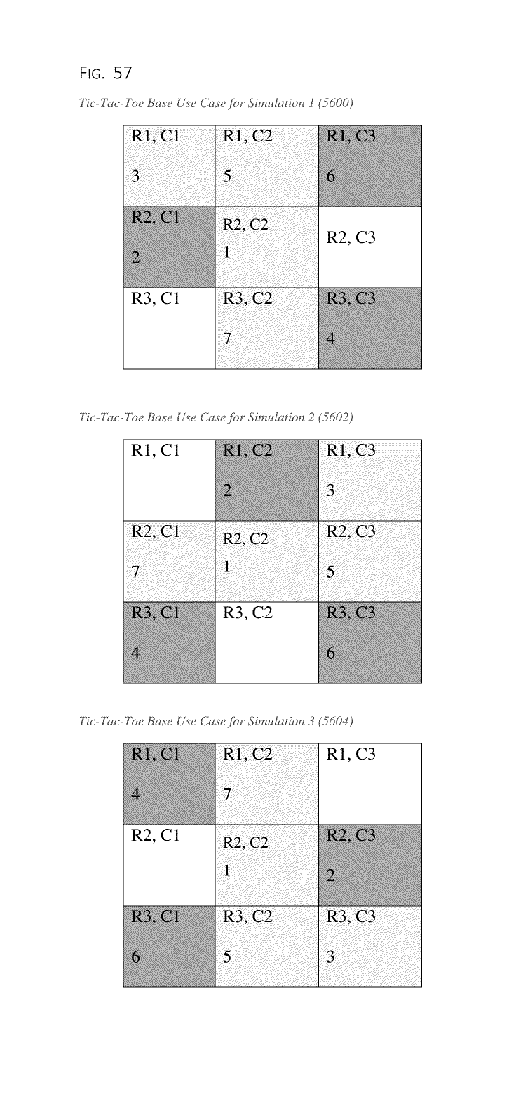

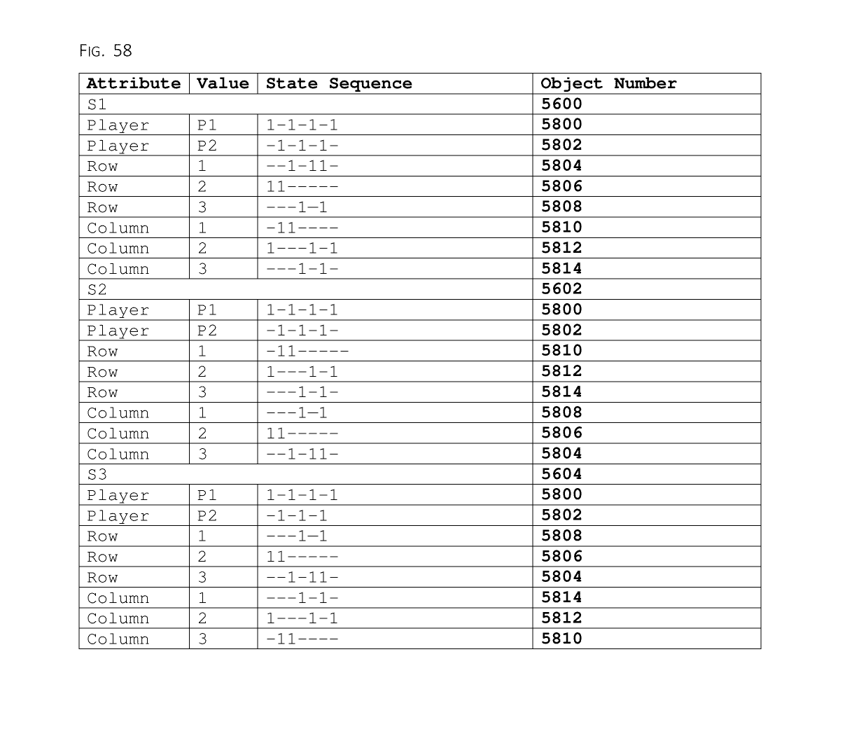

The base scenario is the forced victory that comes from Player 2 moving to an adjacent square rather than the corner. FIG. 58 shows the move sequence pattern for the first three scenarios that provide the information ultimately needed to generate the fourth scenario solution. FIG. 57 depicts the transformations for simulation 2 (5602) and simulation 3 (5605) as simple rotations of the first simulation (5600).

Using the table form FIG. 58 and applying symmetric transformations yields relational state sequences for the first three scenarios that mirror one another. The table shows that each pattern repeats in the other instances by varying the square and column that reuses the sequence. All that is necessary to generate a transform sequence is to identify the variation that drives the transformation. The following transforms occur for S1 5600->S2 5602:

Row 1->Column 3

Row 2->Column 2

Row 3->Column 1

Column 1->Row 1

Column 2->Row 2

Column 3->Row 3

Thus, an operation sequence that transforms Rows to Columns and adjusts the column numbers inverse to the row numbers generates the solution sequence for S2. For S2 5602->S3 5604:

Row 1->Column 3

Row 2->Column 2

Row 3->Column 1

Column 1->Row 1

Column 2->Row 2

Column 3->Row 3

The same approach works for S2 5602 to S3 5604. Therefore, the same sequence of transform operators can predict S4 and the solution is generic for the symmetry. The simulator can then apply this learned knowledge to generate higher order transforms for other symmetries. Ultimately, the symmetries feed up such that the framework generates a solution that defines the operations required for each sequence of moves to transform to the optimal solution.

From the above, S4 with an initial move of R1, C3 by Player 2 follows directly from sequence transformation if the playing pattern is the same in regard to symmetry.

### Zero-Subset Sum Problem

In the zero-subset sum problem, the goal is to find a subset of integers within a set whose sum is zero. In this section, the framework represents the zero-subset problem schematically so that simulation can generate possible instances of the problem within a range and then attempt to determine through simulation the optimal adding sequence to add the numbers for all possible number sets within a test range. The learning transformation problem is the same as in prior scenarios. As the framework solves each subsequent instance, it generates a transformation problem to determine the transform operators that can generate the sequence of solving steps from one instance using another instance. The framework transforms each successful transformation solution into a higher order transformation problem to generate the transformation sequence for one instance from another instance.

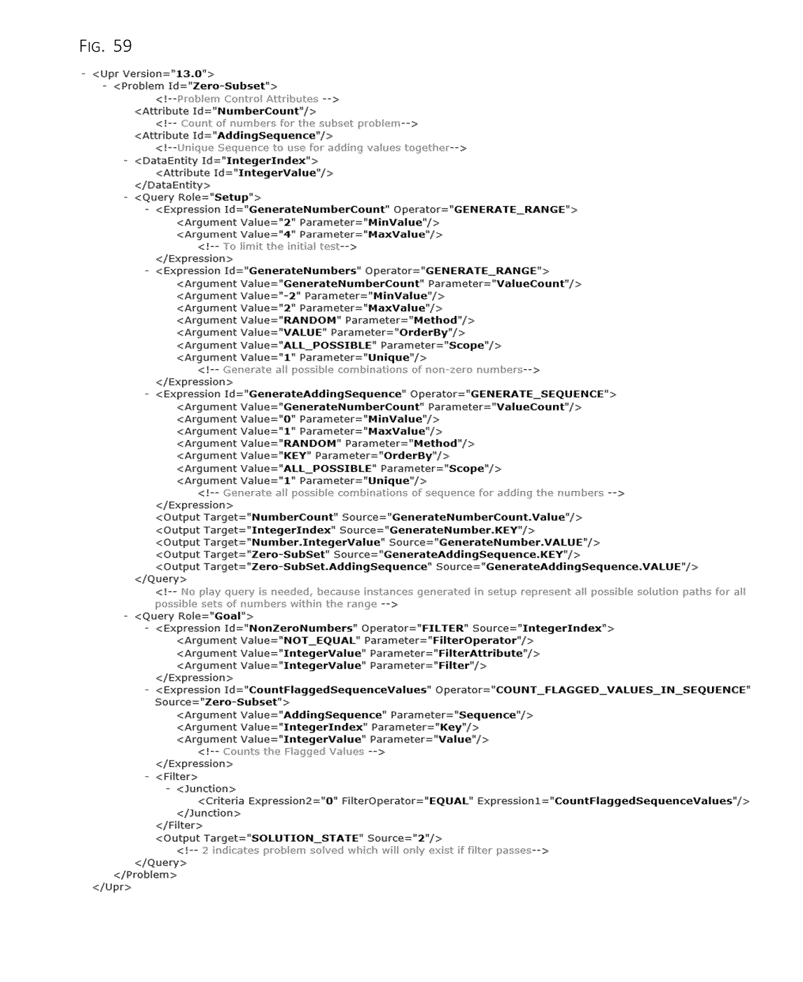

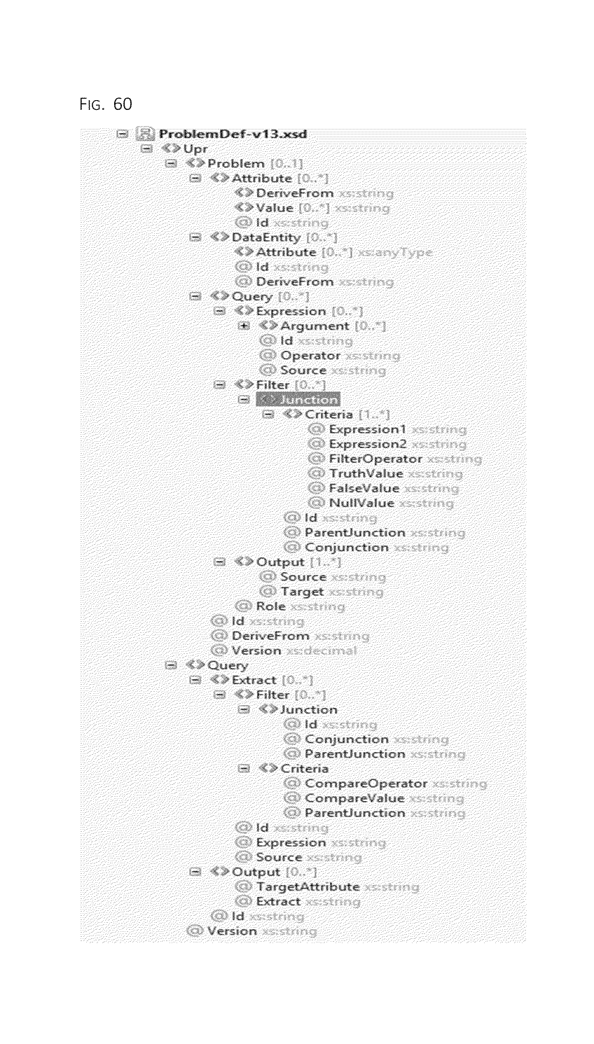

As in prior scenarios, the first step is to schematize the problem. FIG. 59 illustrates the schematization using a version of the problem schema that works well with modelling this problem but still maps to the generic database structure proposed earlier. FIG. 60 depicts an underlying problem schema specification useful for modelling this problem.

Applying the concepts from the prior solving exercise shows that UPRF will converge to the optimal transformational sequence as it learns from more instances rather than requiring brute force simulation. The progression for achieving this is:
1. Solution instances will all have at least one negative number and one positive number in order to generate the zero subset. The framework identifies this by correlation of the engine to the factors relevant to the solution instances. This is a feature not exposed by prior exercise, but is clearly easy to implement into the framework by modelling a problem whose goal is to eliminate sequences that do not generate a solution and correlate the data values to the failed instances. The framework can then assert this optimization back into the original problem as a failure query to speed up the simulation process.
2. Positing a higher order problem against the base problem applies operators to transform successful instances to one another. A set of transform operators provides the domain for which to register selection of an algorithm given the inputs. There are definitive correlations associated with optimizations involving the order of numbers tested within a range.
3. The higher order problem identifies a pattern for testing the sequences from the sequence of numbers flagged for inclusion in the subset problem that correlates across instances. This becomes a third order higher problem and once this is resolved, the framework will establish the optimal way to sequence the testing of the numbers for inclusion in the subset calculation. Utilizing different functions for selecting the sequence provide the candidate transformational operators.

UPRF can utilize a transformation problem that correlates solved instances incrementally where different functions define the sequencing of the numbers for testing. UPRF is limited to transform operations that provided to the framework. This is an efficiency issue and not a functionality issue. After enough iterations, the framework will establish a variable relationship that replicates the partitioning function through a sequence of more primitive operations so long as the primitive operations are sufficient to construct the higher-level function. This assertion comes from the postulate that UPRF converges to complete correlation relevant to the transform operators available.

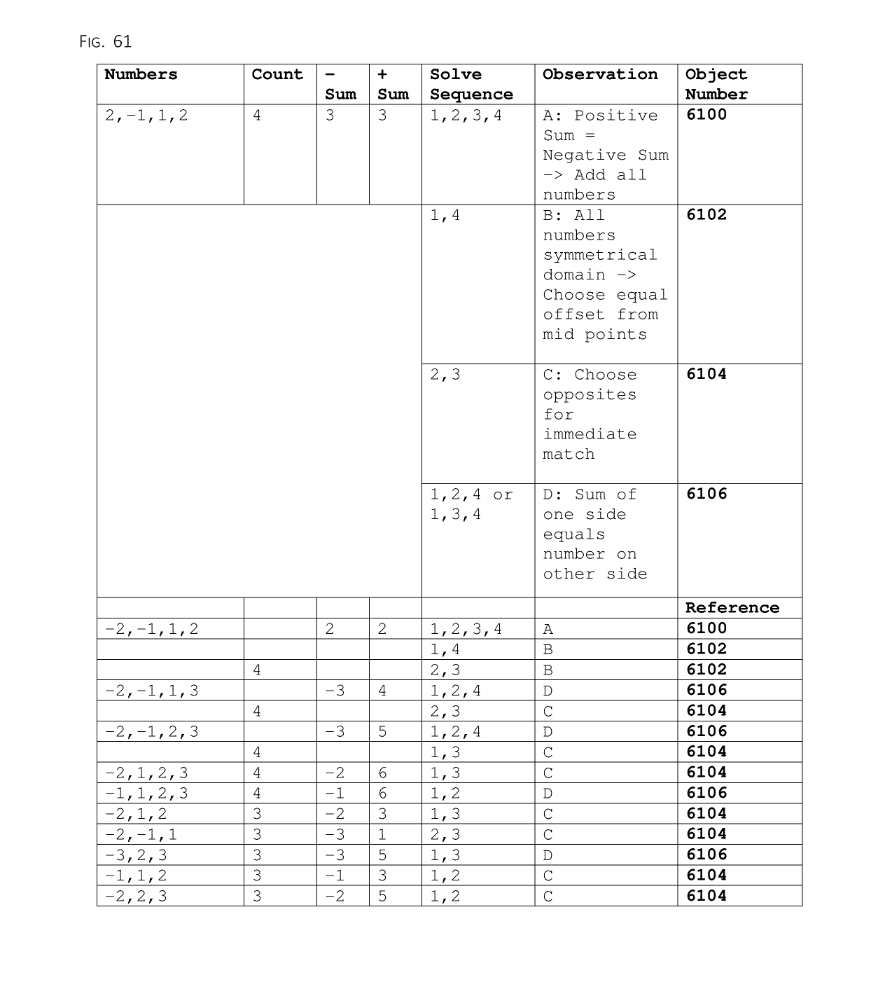

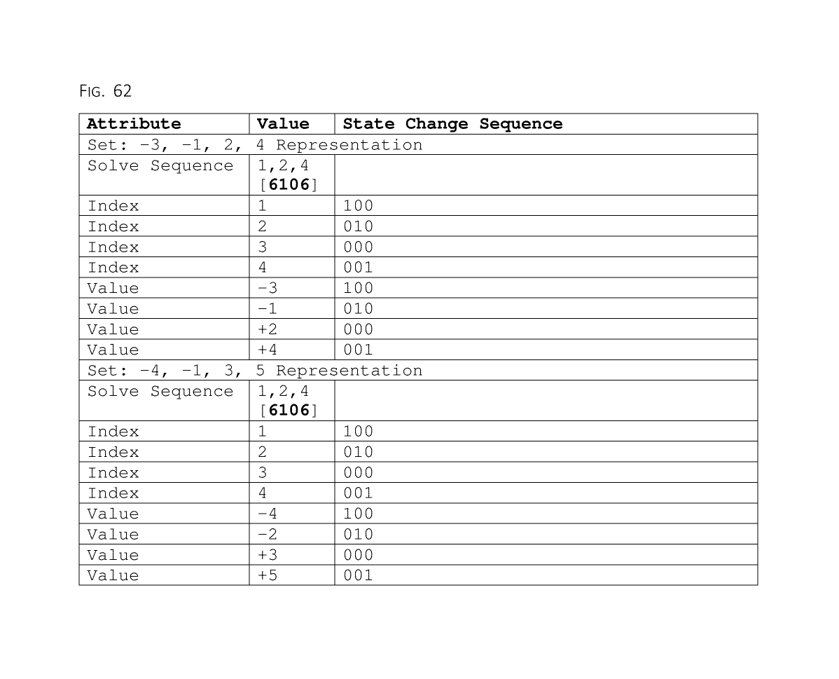

Examination of the outputs of the problem instantiation in the table in FIG. 61 shows the correlation to the sequencing utilized to reach the goal. The combination of the number set and the solution sequence generates a unique sequence. The framework can then use this sequence as a base instance for transform operators to recognize the operators that converts one sequence to another. FIG. 62 shows the state sequences for two different instances. The two instances reveal the same optimal solution sequence for different numbers in the solution. This provides information to the learning algorithm in the transformation problem to identify the correlating factors between the two simulations. In this case, four distinct patterns emerge from the instances provided that apply to multiple instances denoting a one-to-many relationship between solution approaches and combinations of numeric sequences. This implies the ability for UPRF to utilize transform sequences for higher order solving that generalize based on pattern recognition as well as dynamically discover new patterns. This leads to greater and greater optimization to solve problems directly from inspection using the generalized transformation sequences rather than resorting to brute-force simulation, even if a general solution that works for all instances is never realized. The information learned from this allows UPRF to solve a higher and higher percentage of new problem instances for this example instantly.

### Further Applications of UPRF

The examples provide heretofore demonstrate the UPRF approach for an example problem that have properties common to any problem resolvable through simulation. Along with this, additional examples demonstrate other problems that are different from the sample Hanoi problem up to the modelling and state sequencing stages to verify that any problem that can be modelled with initial states, transition states, and goal states for simulative solving generates relational sequences that transform to higher order transformation problem instances of a generic nature regardless of the underlying problem instances. This section revisits the list of sample problems that span an adequately wide variety of sectors and industries with various goal scenarios to indicate the practicality of the approach for problems across virtually all domains. Typical goal scenarios include:
Risk Mitigation: Identify or minimize risks in a system
Cost/Benefits: Determine the maximum benefit to cost ratio
Automation: Promote deep learning to generate automation within a system
Optimization and Throughput: Maximize the efficiency or production of a system relative to the effort required
Strategy: Formulate heuristics that promote the meeting of complex goals to defeat an opposing force or overcome some other enigmatic challenge
Planning: Generate steps that optimally proceed to meet or achieve time-oriented goals
Research: Discover sequences of steps and integrations of items such that a new material or component is produced that targets a set of goals
Prediction: Predict the likelihood of future events or likely outcomes from historical data.
Prediction is an inherent aspect of all simulation problems, but this categorization is useful for problems that do not fall specifically into the prior listed goal scenarios.

Examples for these goal scenarios can be elaborated in terms of initial states, transition states, and goal states lending themselves to modelling to UPRF for resolution to seek general solutions.

### Risk Mitigation Examples

Credit Risk:
   Initial states generated by the attributes associated with a borrower such as age, credit rating, etc.
   Transition states defined by decision history from prior cases analyzed for probability correlation with positive or negative outcomes
   Goal states to seek defining threshold for acceptability/non-acceptability for a risk rating ultimately converging toward rules for how to apply principles for credit decisions based on attributes associated with the initial instances
Cybersecurity:
   Initial states generated by different starting security requirements based on a company's sector/industry and relevant compliance requirements and data risks
   Transition states oriented toward implementation of security controls and their expected impact to reduce risk
   Goal states to measure the likely risk reduction associated with steps taken to secure a network converging toward the selection methods to determine the most appropriate security steps to take based on the initial state configurations; This example could also incorporate cost/benefits goals to help determine which costs are most likely to yield the best benefit in reducing risks.

### Cost/Benefits

Industry Quality Control:
   Initial states based on a particular manufacturing process for which quality control is desired
   Transition states mapping to decisions coupled with historical financial effects for increases or decreases in quality control and likely impacts on customer retention, sales, manufacturing savings
   Goal states to seek for the optimal level of quality control to balance costs and profits towards maximum profitability ultimately converging toward rules associated with attributes from the initial states that govern the factors for deciding on particular quality control thresholds
Market Basket Analysis
   Initial states for different customer profiles based on demographics or other distinguishing factors
   Transition states providing hints or marketing within a user online shopping excursion along with historical results associated with such marketing actions
   Goal states to identify optimal patterns for the prompting items to present to users that meet a maximum profitability goal versus diminishing of customer purchases due to incorrect assertions in their online experience; These converge toward decision rules for how attribute variations from the initial states affect the recommended actions to take to maximize achievement of the goal states.

### Automation

Self-driving cars
   Initial states for different models of cars combined with different type of transit situations including level of traffic, road terrain, attributes of the navigational routes, etc.
   Transition states associated to different systems utilized to make decisions based on inputs and feedback along with tracking of historical results from such systems
   Goal states to seek minimal intervention requirements by a driver, minimization of likelihood of accidents or tradeoffs between these meeting an acceptability requirement that additionally relate to cost/benefits goals
Robotics
   Initial states may be different types of robotic systems based on tasks targeted
   Transition states associated to different innovations or techniques to carry out tasks that record energy and success ratios
   Goal states to seek maximum effectiveness for techniques based on speed or accuracy or a tradeoff (cost/benefits) threshold

### Optimization and Throughput

Freight Delivery (This is based on a similar model as the zero subset problem since it is NP-complete)
   Initial states for complexity of routes such as numbers of destinations (similar to traveling salesman problem)
   Transition states measuring how close the delivery routes can be generated optimally based on known algorithms associated with the travelling salesman problem
   Goal states to seek to find the optimal methods to determine the algorithms to select based on the initial state complexities
Flow Control
   Initial states for flow models based on viscosity of the flow material
   Transition states varying the size of the piping, shaping, or materials used for the piping with historical data for various results from different configurations
   Goal states to identify the combinations of materials, shaping, and piping size that maximize the flow of the substance associated with the initial instances

### Strategy

Games and Puzzles
   Initial states for different starting configurations or combinatorial starting configurations that generate throughout the problem solving instances for multi-player scenarios such as a chess puzzle for determining the optimal moves for a king-rook check mate with variable board sizes or a Rubik cube problem with different starting combinations
   Transition states defining the allowed moves that may be performed
   Goal states that define when the game or puzzle is solved or reaches a failure point
MMO (Massively Multiplayer Online) game
   Initial states for different games with different sets of rules and combinations of collaborative/competing players
   Transition states associated with allowed actions
   Goal states associated with reaching a game objective for individual or teams from the initial states ultimately converging toward generalizations for strategies based on the initial configurations
Disease Control
   Initial states for disease scenarios such as Ebola defined by population sizes, densities, travel attributes, demographics of population, weather, etc.
   Transition states integrating historical data reflecting likely immediate outcomes that attempt to reduce disease in the population or the likelihood of the spread of disease such as treating sick persons, quarantine, travel restrictions, etc.
   Goal states to target reducing the risk of the disease spread factoring in the combined effects of different decision paths through the transition states that ultimately converge to generalization on disease control approaches linked to attributes of the initial states (i.e., disease control for a densely populated area may be different than those for a smaller area and a general formula may emerge to determine the thresholds at which the treatments should be varied).

### Planning

Warfare mission planning
   Initial states for different types of assets utilized in a warfare scenario
   Transition states carrying out maintenance tasks to improve likelihood of effective performance of the assets
   Goal states to target the optimal maintenance windows and procedures for various asset types ultimately converging toward the general rules correlated to the initial assets for predicting the frequency and types of maintenance most likely to maximize the asset usage

### Research

Drug Development
   Initial states for different medical benefits to treat a particular disease/condition or symptoms for a disease/condition
   Transition states prescribing different manufacturing techniques or elements to incorporate into manufacturing to target benefits with historical results associated to prior usages of the techniques or elements
   Goal states to measure the likelihood that a configuration meets the requirements to resolve a disease ultimately converging toward generalizations for the process for guiding how to select the technique/elements based on properties of the initial states
Synthetic Materials
   Initial states for different material properties to target such as weight, strength, flexibility, durability, corrosion resistance, etc.
   Transition states prescribing different manufacturing techniques or elements to incorporate into manufacturing to target desired properties with historical results associated to prior usages of the techniques or elements
   Goal states to measure the likelihood that a configuration meets the requirements to meet material requirements ultimately converging toward generalizations for the process for guiding how to select the technique/elements based on properties of the initial states

### Prediction

Investing Outcomes
   Initial states for different types of assets with different historical periods to evaluate
   Transition states varying buy/sell decisions based on parameters driven by decision models associated with prior asset performance history, related historical performance, macro factors
   Goal states to maximize the likely return of an investment based on historical data using different selection models for historical periods not known for the transition state decisions. This is the concept of blind testing, whereby simulations occur utilizing decision-making metrics from one historical period into a historical period for which data is not available to the decision-making.

For prediction scenarios whereby the goal is to generalize from one period to calculate likelihood for future time periods, the following applies as noted in the details of the investing outcome goal scenario: Simulation approaches that promote decisions using data from one historical period can be blind-tested into periods associated with the goals for which historical data is not provided. This provides a framework for generalizing the decision sequences that correlate attributes which are not purely linked to the immediate historical outcomes and apply more generally.

All of the above goal scenarios lead to higher-order transforms problems whereby decision patterns are pursuable based on results determined as simulations are explored in the basic instances. For example, properties emerge from different types of piping utilized for different liquid flows that ultimately predict the best candidate configurations without the need for simulations as the sequencing operations ultimately identify patterns associated with higher-order properties associated to the instances themselves. Another example of this is the self-driving car scenario whereby properties emerge from initial configurations of car models with transit situations that potentially surface algorithms for determining how to vary the feedback selection based on how the transit situation changes. In the MMO scenario, sequences of actions associated with various player configurations for games with various rule attributes emerge that converge toward generalization sequences for optimal decision-making based on initial configuration variations. For example, a defensive strategy may emerge as more likely to succeed as the number of players increases for a game with certain types of attributes based on how the number of team collaborators and competitors vary.

Although the present invention has been described in considerable detail with reference to certain preferred versions thereof, as well as certain exemplar problems solved by the present invention, other versions are possible and as explained, a very wide variety of computing problems can be addressed with the present invention. Therefore, the spirit and scope of the appended claims should not be limited to the description of the preferred versions or exemplar problems contained herein.

I claim:

1. A method for solving problems with a computer processor by using the computer processor to execute steps comprising:
(a) defining an input problem that can be modelled using an initial state, a transition state, and a problem goal state;
(b) simulating the input problem to identify a sequence of states to solve at least one instance of the input problem;
(c) storing the sequence of states to solve at least one instance of the input problem in a database that can be queried;
(d) recursively generating a higher-level transform problem wherein an input to the higher-level transform problem is the sequences of states stored during step (c), and the higher-level transform problem goal state is to identify an appropriate sequence of states for solving a selected instance of the input problem;
(e) simulating the higher-level transform problem to identify a transformation sequence that represents the state sequences to solve a selected instance of the input problem;
(f) storing the sequence of states to solve the higher-level transform problem in a database that can be queried;
(g) recursively repeating steps (g)-(f) until determining that the recursive process has reached a point of diminishing returns such that the sequence of states for most appropriately solving the input problem has been identified and stored in the database; and
(h) completing each of the recursive processes in steps (d) and (g) and presenting a most appropriate solution to the input problem.

2. The method of claim 1 wherein the input to the higher level transform problem further comprises sequences of states from one or more second input problem instances.

3. The method of claim 1 further comprising:
(d)(1) recursively generating a still higher-level transform problem wherein an input to the still higher-level transform problem is the sequences of states stored during step (f), and the higher-level transform problem goal state is to identify an appropriate sequence of states for solving a selected instance of the higher-level transform problem;
(d)(2) simulating the still higher-level transform problem to identify a still higher transformation sequence of states to the still higher-level transform problem that appropriately solves the higher-level transform problem and by doing so predicts correct sequences to even more appropriately solve the input problem, thereby generating new transformation sequences of states for a selected instance of the higher-level transform problem;
(d)(3) storing the new transformation sequences of states for the higher-level transform problem in a database that can be queried;
(d)(4) storing the still higher transformation sequence of states to solve the still higher-level transform problem in a database that can be queried; and
(d)(5) providing the new transformation sequences of states for the higher-level transform problem to the still-higher level transform problem as additional inputs;

4. The method of claim 1 wherein the problem goal state can be changed dynamically during execution of any of steps (a)-(h).

5. The method of claim 1 wherein the initial state can be changed dynamically during execution of any of steps (a)-(h).

6. The method of claim 1 wherein the transition state can be changed dynamically during execution of any of steps (a)-(h).

7. The method of claim 1 further comprising:
carrying out steps (b)-(h) without obtaining additional user input.

8. The method of claim 1 wherein the database is a relational database.

9. The method of claim 1 further comprising:
(g)(1) determining the point of diminishing returns as an equilibrium problem.

10. The method of claim 9 further comprising:
(g)(2) presenting the equilibrium problem as a second input problem for recursive solution by steps (a)-(h).

11. The method of claim 1 wherein the input problem is defined in terms of a relational schema wherein the initial state and a library of functions, including at least one function, reference items within the schema as parameters.

12. The method of claim 11 wherein the library of functions is extensible to allow a user to add new functions.

13. The method of claim 11 further comprising:
(i) causing the at least one function from the library of functions to generate zero or more candidate states for each of the sequence of states generated during simulation step (b);
(j) determining that a simulated solution path for a particular stored sequence of states ends when zero candidate states exist for that one of the stored sequence of states;
(k) determining that an overflow condition exists when at least one candidate state exists for a particular stored state sequence of the sequences of states; and
(l) upon the existence of an overflow condition, adding at least one additional branched problem instance for each candidate state and independently solving that branched problem instance.

14. The method of claim 1 further comprising:
(b)(1) identifying all sequences of states and operations upon each state necessary to solve the input problem; and
(c)(1) storing all sequences of states and operations upon each state.

15. A method to solve problems with autonomous continuous improvement using a computer processor and a data structure, comprising the following steps:
identify a base problem that has at least one instance;
represent the base problem using relational algebra to define unique entities with attributes that define the problem;
define expressional functions to return expressions comprising possible domains of values including aggregates and queries following a relational model and that joins the expressions and filters the results, to represent the valid states for entities and attributes which creates a plurality of instances of the input problem, and to define valid transitions for the base problem, and defines a goal state for the base problem;
solve the at least one instance of the input problem using a simulator;
generate a relational state sequence corresponding to each attribute within each of the at least one input problem instances, the values necessary to solve the at least one input problem instance, and a sequence for activation of the values;
from the at least one simulation instance, generate a plurality of instances of a first-order transform problem and execute simulation to solve at least two of the plurality of instances of the first-order transform problem;
wherein the first-order transform problem references as entities, the state sequences from within the simulation instances and transform operators for application of each state sequence, to predict future values of the state sequence;
enable transform operators to generate at least portions of the state sequences for the base problem;
set a goal for each of the instances of the first-order transform problem to generate a solution instance for the base problem in the fewest number of steps;
once there are at least two solved instances of the first-order transform problem, generate a relational state sequence corresponding to each attribute within each of the first-order transform problem instances and generate an instance of a second-order transform problem wherein the second-order transform problem references the state sequences of the first-order transform problem as entities;
continue to generate higher-order transform problem instances and relational state sequences of these higher-order transform problem instances in a recursive process wherein, as each next-order problem instance is solved, solutions from the solved higher-order transform problem instance are returned to create new solutions, while expanding the scope of the higher level transform problem to include instances from the lower level problem in order to improve the higher order solution selection process; and
determine when the recursive process has reached a point of diminishing returns and unwind the recursion to achieve a best predicted state sequence for solution of the base problem.

16. The method of claim 15 wherein the goal state for the base problem can be changed dynamically.

17. The method of claim 15 wherein the expressional functions can be changed dynamically.

18. The method of claim 15 wherein, after the steps of identifying, representing and defining the base problem, are complete, the remaining steps are completed by the processor without obtaining additional user input.

19. A computer system programmed to carry out a method to output a sequence of transformation operators with associated distinct values and variables of a problem instance that yield to a desired final state associated with an input problem, comprising:
providing an input problem comprising a data structure containing variables with initial values, and a first set of functions for instantiating the input problem into one or more problem instances, wherein each of the one or more problem instances is identified by at least one value for at least one variable in the data structure;
supplying transition rules to define a second set of functions to operate against the data structure to generate one or more candidate states for a simulation process to process each problem instance until the simulation process has, for each problem instance, reached a desired final state or a failed state, said simulation process comprising, for each problem instance:
comparing the state of the problem instance to a desired final goal state derived from the second set of functions operating upon the problem instance to determine if the state of the problem instance matches the final goal state;
comparing the state of the problem instance to a set of conditions determining whether the state of the problem is equivalent to the failure state, and if so, indicating no further transformations will be applied to the problem instance; and
if the state of the problem instance is neither the final goal state nor the failure state, executing further transformations by the second set of functions;
saving, in the data structure, an output sequence constituting the output for at least one of each of the problem instances that has reached either the final goal state or the failure state;
defining a data input, comprising one or more of the output sequences from the one or more problem instances, to create an instance of a higher level problem wherein the higher level problem comprises assessing the solution sequences of the problem instances of the input problem;
solving the higher level problem to yield solution state sequences of the problem instances of the input problem wherein the solution of the higher level problem comprises reversible sequences of transformation operator sequences using simulation;
generating a second-order higher level transformation problem to determine one or more preferred solution sequences for the input problem from among the plurality of state sequences;
solving the second-order higher level transformation problem to learn a sequential set of operations to transform solution sequences from a set of problem instances to generate the solution sequence for a different instance of the input problem;
seeking a desired final state for each higher level problem as the sequence of operators to transform one solution instance of a problem from one or more instances of the input problem; and
continuing such process to generate higher and higher order transformation problem instances with the ability to co-recursively determine a solution of a lower-level problem instance through reversal of the existing solution sequences rather than through simulation; thereby achieving continuous improvement by optimizing the lower-level problem solutions by reversing learned sequences that were learned from the higher-level problem instances.

20. The system of claim 19, wherein the data input further comprises one or more output sequences from one or more second problem instances.

21. The system of claim 20 wherein functions are defined to allow for extensibility to add new transition rules and functions to the simulation process.

22. The system of claim 19 wherein an equilibrium problem governs the system such that the system resources devoted to solving the instances of input problems and higher order transformation problems are controlled based on the law of diminishing returns.
